(19) United States
(12) Patent Application Publication
(10) Pub. No.: US 2026/0072582 A1
(43) Pub. Date: Mar. 12, 2026

(54) DEVICE CONTROL METHOD AND ELECTRONIC DEVICE

(71) Applicant: LUMI UNITED TECHNOLOGY CO., LTD., Shenzhen (CN)

(72) Inventors: Zhaoze ZENG, Shenzhen (CN); Binbin HUANG, Shenzhen (CN); Qianxu WU, Shenzhen (CN)

(73) Assignee: Lumi United Technology Co., Ltd., Shenzhen (CN)

(21) Appl. No.: 19/324,216

(22) Filed: Sep. 10, 2025

Related U.S. Application Data
(63) Continuation-in-part of application No. PCT/CN2024/080833, filed on Mar. 8, 2024.
(63) Continuation-in-part of application No. PCT/CN2024/082072, filed on Mar. 16, 2024.
(63) Continuation-in-part of application No. PCT/CN2024/082807, filed on Mar. 20, 2024.
(63) Continuation-in-part of application No. PCT/CN2024/087852, filed on Apr. 15, 2024.

(30) Foreign Application Priority Data
Mar. 10, 2023 (CN) 202310229904.0
Mar. 16, 2023 (CN) 202310256381.9
Mar. 20, 2023 (CN) 202310270674.2
Apr. 21, 2023 (CN) 202310458459.5

(51) Int. Cl. G06F 3/04847; G06F 3/04842; G06F 3/0488

(52) U.S. Cl. CPC G06F 3/04847; G06F 3/04842; G06F 3/0488

(57) ABSTRACT

The present disclosure relates to a device control method, apparatus, electronic device, and storage medium. The method includes: Displaying a region management page; The region management page shows the current position of the target, and the region management page is configured to configure at least one monitoring region within the target space of the sensing device based on the current position of the target; In response to detecting a region editing operation triggered in the region management page for configuring the monitoring region is detected, a custom monitoring region is generated; Displaying an automation configuration page for the monitoring region; In response to an automation configuration operation on the monitoring region in the automation configuration page, generating automation configuration schemes corresponding to the monitoring region; the automation configuration schemes are configured to achieve automatic control of the controlled device by monitoring the region status of the monitoring region.

The present is a partly continued application of the international (PCT) patent application PCT/CN2024/082807 filed on Mar. 20, 2024, the international (PCT) patent application PCT/CN2024/080833 filed on Mar. 8, 2024, the international (PCT) patent application PCT/CN2024/082072 filed on Mar. 16, 2024, and the international (PCT) patent application PCT/CN2024/087852 filed on Apr. 15, 2024, which claim priority to the Chinese patent application CN202310270674.2 filed on Mar. 20, 2023, the Chinese patent application CN202310229904.0 filed on Mar. 10, 2023, the Chinese patent application CN202310256381.9 filed on Mar. 16, 2023, and the Chinese patent application CN202310458459.5 filed on Apr. 21, 2023, respectively. The entire contents of which is incorporated herein by reference.

### TECHNICAL FIELD

The present disclosure relates to the technical field of Internet of Things (IoT) technology, and in particular, the present disclosure relates to a device control method and an electronic device.

### BACKGROUND

With the development of Internet of Things (IoT) technology, various smart devices are increasingly being deployed in a wide range of scenarios—smart homes, offices, and beyond. These smart devices generally fall into two categories: sensing devices and controlled devices; the former may be any kind of sensor, while the latter may be air-conditioners, refrigerators, televisions, lamps, etc. Take a motion sensor in a smart-home setting as an example: users may install such sensors in different rooms. Once activated, the sensor monitors whether anyone is present in the room and, upon detecting a person, triggers the relevant controlled devices—e.g., turning on the lights. However, because the sensor's detection area is fixed, erroneous control actions often occur. Continuing the example: the user places the sensor on a study desk so that the desk lamp will switch on only when someone approaches the desk. Yet the sensor's field of view is not limited to the desk; it also covers the rest of the study. Consequently, whenever the sensor detects a person anywhere in the study—even far away from the desk—it still turns the desk lamp on. From the above, it is clear that how to improve control precision while relying on a sensor's inherently fixed detection range remains an unresolved issue.

### SUMMARY OF THE DISCLOSURE

The present disclosure relates to a device control method and an electronic device.

According to one aspect of the embodiments of the present disclosure, a device control method includes: displaying a region management page; the region management page shows the current position of the target, and the region management page is configured to configure at least one monitoring region within the target space of the sensing device based on the current position of the target; in response to detecting a region editing operation triggered in the region management page for configuring the monitoring region is detected, a custom monitoring region is generated; displaying an automation configuration page for the monitoring region; in response to an automation configuration operation on the monitoring region in the automation configuration page, generating automation configuration schemes corresponding to the monitoring region; the automation configuration schemes are configured to achieve automatic control of the controlled device by monitoring the region status of the monitoring region.

According to one aspect of the embodiments of the present disclosure, a device control method executed by an electronic device includes: acquiring the position of the target in each monitoring region, the monitoring region being generated based on an editing operation triggered in the region editing page; the region editing page is configured to configure at least one monitoring region within the target space of the sensing device based on the current position of the target; determining the status of each monitoring region based on the position of the target in each monitoring region; in response to detecting the status of the monitoring region satisfies the trigger condition in the corresponding automation configuration schemes, controlling the controlled device to perform a corresponding action based on the device control data associated with the trigger condition in the automation configuration.

According to one aspect of the embodiments of the present disclosure, an electronic device includes at least one processor and at least one memory, wherein the memory stores computer-readable instructions; when the computer-readable instructions are executed by one or more of the processors, the device control method as described above is implemented.

Other features and advantages of the embodiments of the present disclosure will be described in the following description, and, in part, will become apparent from the description, or will be understood by implementing the embodiments of the present disclosure. The purposes and other advantages of the embodiments of the present disclosure may be achieved and obtained through the structures specifically pointed out in the written description, the claims, and the drawings.

### BRIEF DESCRIPTION OF THE DRAWINGS

To more clearly illustrate the technical solutions in the embodiments of the present disclosure, a brief introduction to the drawings required in the following description of the embodiments will be provided. It is evident that the drawings described below are merely some embodiments of the present disclosure, and for those skilled in the art, other drawings may be obtained based on these drawings without the need for creative labor.

FIG. 1 illustrates a schematic diagram of the implementation environment involved in the embodiments of the present disclosure.

FIG. 2 illustrates a flowchart of a device control method according to an exemplary embodiment.

FIG. 3 illustrates a schematic diagram of a region editing page of a device control method according to an exemplary embodiment.

FIG. 4A illustrates a schematic diagram of a device page of a device control method according to an exemplary embodiment.

FIG. 4B illustrates a schematic diagram of a monitoring page of a device control method according to an exemplary embodiment.

FIG. 4C illustrates a schematic diagram of the monitoring attributes of each monitoring region of a device control method according to an exemplary embodiment.

FIG. 5A illustrates a schematic diagram of a region editing page of a device control method according to an exemplary embodiment.

FIG. 5B illustrates a schematic diagram of a region editing page of a device control method according to an exemplary embodiment.

FIG. 6A illustrates a schematic diagram of an automation configuration page of a device control method according to an exemplary embodiment.

FIG. 6B to 6C are schematic diagrams of the generation of an automation scheme of a device control method according to an exemplary embodiment.

FIG. 7 illustrates a flowchart of a region setting method according to an exemplary embodiment.

FIG. 8 illustrates a flowchart of a region setting method in an embodiment.

FIG. 8A illustrates a schematic diagram of a device page in an embodiment.

FIG. 8B illustrates a schematic diagram of a region management page in an embodiment.

FIG. 8C illustrates a schematic diagram of editing a functional area in an embodiment

FIG. 9A illustrates a flowchart of editing a functional area in an embodiment.

FIG. 9B illustrates a schematic diagram of editing region attributes in an embodiment.

FIG. 9C illustrates a schematic diagram of editing region types in an embodiment.

FIG. 9D illustrates a schematic diagram of editing monitoring sensitivity in an embodiment.

FIG. 9E illustrates a schematic diagram of editing color in an embodiment.

FIG. 9F illustrates a schematic diagram of editing name in an embodiment.

FIG. 10 illustrates a flowchart of a region setting method in another embodiment.

FIG. 10A to 10G are schematic diagrams of gesture operations in an embodiment.

FIG. 11 illustrates a flowchart of a region setting method in yet another embodiment.

FIG. 12 illustrates a flowchart of a region setting method in an embodiment.

FIG. 12A to 12B are schematic diagrams of gesture operations in an embodiment.

FIG. 13 illustrates a schematic diagram of a gesture operation in an embodiment.

FIG. 13A illustrates a schematic diagram of moving an edited area in a region management page in an embodiment.

FIG. 13B illustrates a schematic diagram of the movement of the editable area in the region management page.

FIG. 14 to 14A are specific implementation schematic diagrams of a region setting method in an application scenario embodiment.

FIG. 15 illustrates a flowchart of a region setting method according to an exemplary embodiment.

FIG. 15A illustrates a schematic diagram of a region management page in an embodiment.

FIG. 16A illustrates a schematic diagram of a monitoring page according to an exemplary embodiment.

FIG. 17A illustrates a schematic diagram of a region management page according to an exemplary embodiment.

FIG. 17B illustrates a schematic diagram of a region management page according to an exemplary embodiment.

FIG. 18 illustrates a flowchart of another region setting method according to an exemplary embodiment.

FIG. 18A illustrates a schematic diagram of a region setting page according to an exemplary embodiment.

FIG. 18B-18C illustrates a schematic diagram of a region setting page according to an exemplary embodiment.

FIG. 19 illustrates a schematic diagram of another region setting method according to an exemplary embodiment.

FIG. 20 illustrates a flowchart of another region setting method according to an exemplary embodiment.

FIG. 20A illustrates a schematic diagram of another region setting method according to an exemplary embodiment.

FIG. 21 illustrates a flowchart of another region setting method according to an exemplary embodiment.

FIG. 21A illustrates a schematic diagram of another region setting method according to an exemplary embodiment.

FIG. 22 illustrates a flowchart of another device control method according to an exemplary embodiment.

FIG. 22A illustrates a schematic diagram of a region editing page according to an exemplary embodiment.

FIG. 22B illustrates a schematic diagram of a region editing page according to an exemplary embodiment.

FIG. 23 illustrates a flowchart of another device control method according to an exemplary embodiment.

FIG. 24 illustrates a schematic diagram of different regions within the monitoring range of a device control method according to an exemplary embodiment.

FIG. 25A illustrates a flowchart of a monitoring process of a device control method according to an exemplary embodiment.

FIG. 25B illustrates a flowchart of a monitoring process of a device control method according to an exemplary embodiment.

FIG. 25C illustrates a flowchart of a monitoring process of a device control method according to an exemplary embodiment.

FIG. 26 illustrates a flowchart of an object determination method provided by the embodiments of the present disclosure.

FIG. 27 illustrates an interface diagram of a configuration interface provided by the embodiments of the present disclosure.

FIG. 28 illustrates another interface diagram of a configuration interface provided by the embodiments of the present disclosure.

FIG. 29 illustrates a schematic diagram of a region relationship provided by the embodiments of the present disclosure.

FIG. 30 illustrates a schematic diagram of an information confirmation interface provided by the embodiments of the present disclosure.

FIG. 31 illustrates a schematic diagram of editing an interference area provided by the embodiments of the present disclosure.

FIG. 32 illustrates an example of the editing process of an interference area provided by the embodiments of the present disclosure.

FIG. 33 illustrates a flowchart of another object determination method provided by the embodiments of the present disclosure.

FIG. 34 illustrates a flowchart of the determination process of an interference source object provided by the embodiments of the present disclosure.

FIG. 35 illustrates a timing diagram of an object determination method provided by the embodiments of the present disclosure.

FIG. 36 illustrates a schematic diagram of an application scenario provided by the embodiments of the present disclosure.

FIG. 37 illustrates a layout editing interface provided by the embodiments of the present disclosure.

FIG. 38 illustrates a sub-interface for attribute selection provided by the embodiments of the present disclosure.

FIG. 39 illustrates a configuration interface for interference source attributes provided by the embodiments of the present disclosure.

FIG. 40 illustrates a color editing interface provided by the embodiments of the present disclosure.

FIG. 41 illustrates an information prompt interface provided by the embodiments of the present disclosure.

FIG. 42 illustrates a schematic diagram of a region display window provided by the embodiments of the present disclosure.

FIG. 43 illustrates a flowchart of determining a target position provided by the embodiments of the present disclosure.

FIG. 44 illustrates a schematic diagram of the interface transformation of a sensing interface provided by the embodiments of the present disclosure.

FIG. 45 is a hardware structure diagram of a terminal according to an exemplary embodiment.

FIG. 46 is a structural block diagram of an electronic device according to an exemplary embodiment.

### DETAILED DESCRIPTION

The following is a detailed description of the embodiments of the present disclosure, examples of which are shown in the accompanying drawings, in which the same or similar reference numbers throughout the drawings indicate the same or similar components or components having the same or similar functions. The embodiments described below with reference to the accompanying drawings are exemplary and are intended to explain the present disclosure and should not be construed as limiting the present disclosure.

To make the purposes, technical solutions, and advantages of the present disclosure clearer, the embodiments of the present disclosure will be further described in detail below in combination with the accompanying drawings.

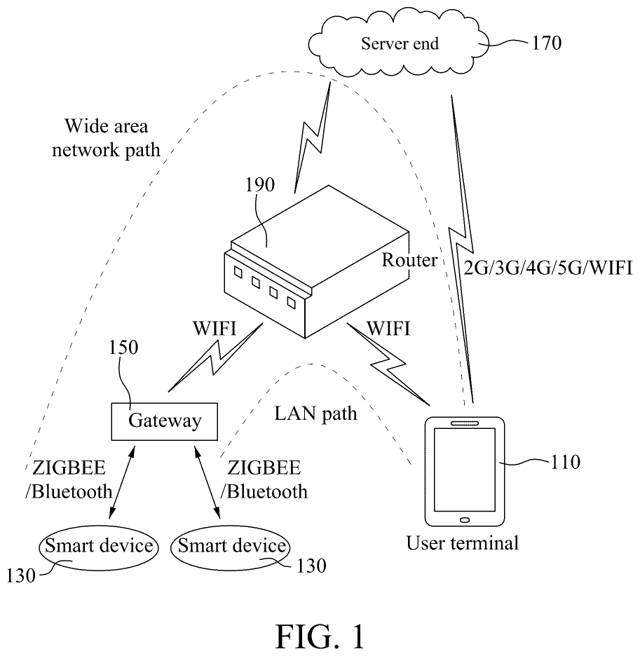

FIG. 1 is a schematic diagram of an implementation environment involved in a device control method. The implementation environment includes a user terminal 110, a smart device 130, a gateway 150, a server end 170, and a router 190.

Specifically, the user terminal 110, which may also be considered as a user end or a terminal, may deploy (which may also be understood as install) a client associated with the smart device 130. The user terminal 110 may be electronic devices such as smartphones, tablets, laptops, desktop computers, smart control panels, and other devices with display and control functions, without limitation here.

The client, associated with the smart device 130, is essentially for users to register an account in the client and configure the smart device 130 in the client. For example, the configuration includes adding a device identifier for the smart device 130, etc., so that when the client is running on the user terminal 110, it may provide users with functions such as device display and device control related to the smart device 130. The client may be in the form of an application program or a web page. Correspondingly, the interface of the client for device display may be in the form of a program window or a web page, without limitation here.

The smart device 130 is deployed in the gateway 150 and communicates with the gateway 150 through its own configured communication module, thereby being controlled by the gateway 150. It should be understood that the smart device 130 generally refers to one of multiple smart devices, and this embodiment only takes the smart device 130 as an example. That is, this embodiment does not limit the number and types of smart devices deployed in the gateway 150. In one application scenario, the smart device 130 accesses the gateway 150 through a local area network and is thus deployed in the gateway 150. The process of the smart device 130 accessing the gateway 150 through a local area network includes: the gateway 150 first establishes a local area network, and the smart device 130 joins the local area network established by the gateway 150 by connecting to the gateway 150. This local area network includes but is not limited to ZIGBEE or Bluetooth. The smart device 130 may be a controlled device, such as a smart printer, smart fax machine, smart camera, smart air conditioner, smart door lock, smart light, smart refrigerator, natural gas alarm, smoke alarm, wall switch, wall socket, wireless switch, wireless wall sticker switch, Rubik's Cube controller, curtain motor, and other electronic devices. The smart device 130 may also be a sensing device, such as a radar device, human sensor, door and window sensor, temperature and humidity sensor, water immersion sensor, and other electronic devices equipped with a communication module. It is worth mentioning that for some smart devices 130, they may be both controlled devices and sensing devices. For example, a smart camera is both a controlled device and a sensing device. This is not a specific limitation on the type of smart device 130.

Interaction between the user terminal 110 and the smart device 130 may be realized through a local area network or a wide area network. In one application scenario, the user terminal 110 establishes a wired or wireless communication connection with the gateway 150 through the router 190. For example, the wired or wireless methods include but are not limited to WIFI, so that the user terminal 110 and the gateway 150 are deployed in the same local area network, thereby enabling the user terminal 110 to interact with the smart device 130 through a local area network path. In another application scenario, the user terminal 110 establishes a wired or wireless communication connection with the gateway 150 through the server end 170. For example, the wired or wireless methods include but are not limited to 2G, 3G, 4G, 5G, WIFI, etc., so that the user terminal 110 and the gateway 150 are deployed in the same wide area network, thereby enabling the user terminal 110 to interact with the smart device 130 through a wide area network path.

The server end 170 may also be considered as the cloud, cloud platform, platform end, server end, etc. The server end 170 may be a single server, a server cluster composed of multiple servers, or a cloud computing center composed of multiple servers, so as to better provide background services to a large number of user terminals 110. For example, the background services include device control services.

For the user, after the user terminal 110 displays a region management page showing the current position of the target, the user may trigger an editing operation in the region management page to configure at least one monitoring region within the target space of the sensing device based on the current position of the target.

For the user terminal 110, it may detect the editing operation and generate a custom monitoring region in response to the editing operation. It may then display an automation configuration page for the monitoring region and generate automation configuration schemes corresponding to the monitoring region in response to an automation configuration operation on the monitoring region in the automation configuration page. Based on the automation configuration schemes, it may achieve automatic control of the controlled device in the target space by monitoring the region status of the monitoring region.

For the user, after the user terminal 110 displays the region management page, the user may trigger a first trigger operation in the region management page to set at least one functional area for the target space.

For the user terminal 110, it may detect the first trigger operation and display a region setting page for setting the functional area in response to the first trigger operation. It may then display the set functional area in the region management page. In this way, based on the functional areas displayed in the region management page, the automation configuration schemes may be configured for each functional area on the automation configuration page to achieve automatic control of the smart device 130 in the target space by monitoring the region status of each functional area.

Please refer to FIG. 1 again. In one application scenario, the user performs various gesture operations through the user terminal 110. After the user terminal 110 detects the gesture operations, it sets functional areas and region ranges for the smart device 130 and controls the settings through the functional areas. The functional area here may also be understood as the monitoring region in the above application scenario.

Please refer to FIG. 1 again. In one application scenario, the user terminal 110 may interact with the user to complete the interactive operations for configuring interference objects. In addition, the user terminal 110 may send configuration commands to the smart device 130 through the network, so that the smart device 130 may determine the interference area corresponding to the interference source object in the target space based on the configuration commands and return the region display information of the interference area to the user terminal 110. The smart device 130 may then display the interference area of the interference source object in the target space based on the region display information. The smart device 130 may include a detection module, which may be a LiDAR, for performing point cloud scanning of the target space to obtain point cloud information in the target space, so that the smart device 130 may determine the interference source object in the target space based on the point cloud information. The smart device 130 may also determine the location of the real target object in the target space based on the determined interference source object and send the location of the target object to the user terminal 110 to display the position mark corresponding to the target object and each interference area on the same interface. For example, in FIG. 1, the user terminal 110 and the smart device 130 are two separate devices mainly used for human-computer interaction and object determination, respectively. In other cases, the user terminal 110 and the smart device 130 may also be the same device.

In one application scenario, the sensing device reports the region status of each monitoring region to the gateway 150 through a local area network path, and then the gateway 150 notifies the controlled devices in each monitoring region to perform corresponding actions through a local area network path. In this way, the Internet is not required. As long as the sensing device and the controlled device are connected to the gateway 150, the above device control may be realized. Even in response to detecting the network is disconnected, it will not affect the above device control, thereby fully ensuring the success rate of device control.

In another application scenario, the sensing device reports the status of each monitoring region to the gateway 150 through a local area network path, and then the gateway 150 notifies the controlled devices in each monitoring region to perform corresponding actions through the local area network path. In this way, the Internet is not required. As long as the sensing device and the controlled device are connected to the gateway 150, the above device control may be realized. Even in response to detecting the network is disconnected, it will not affect the above device control, thereby fully ensuring the success rate of device control.

In another application scenario, the sensing device reports the status of each monitoring region to the server end 170 through a wide area network path, and then the server end 170 notifies the controlled devices in each monitoring region to perform corresponding actions through the wide area network path. In this way, the gateway does not need to be deployed, which is conducive to reducing the cost in the device control process.

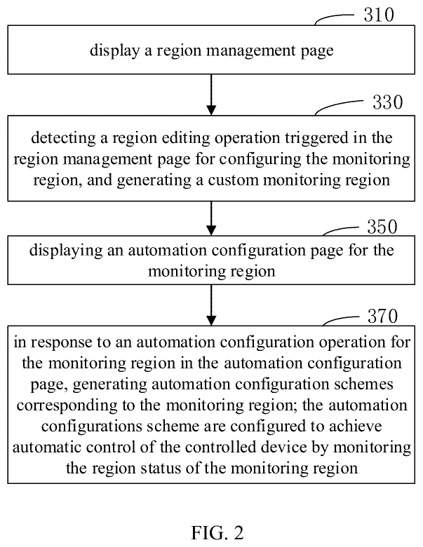

Please refer to FIG. 2. The embodiment of the present disclosure provides a device control method, which is applicable to an electronic device. The electronic device may specifically be the user terminal 110 in the implementation environment shown in FIG. 1.

In the following method embodiments, for the sake of description, the method is described with the electronic device as the subject of each step, but this is not specifically limited. As shown in FIG. 2, the method may include the following steps:

Step 310, display a region management page. It should be noted that the region management page includes a region editing page. The following description takes the region editing page as an example.

Firstly, it should be noted that the region editing page shows the current position of the target. The target refers to an object that may move within the target space of the sensing device. For example, the target may be a person, a robot, a pet, etc. It may be understood that as the target moves within the target space, the position of the target within the target space detected by the sensing device will change accordingly. Correspondingly, the position of the target within the target space displayed on the region editing page of the user terminal will also change accordingly. This facilitates the user to more accurately and promptly adjust the monitoring region within the target space based on the current position of the target in the target space.

The scope of the target space may be considered as the detection range of the sensing device. For example, a human sensor is deployed in the living room, and the detection range of the human sensor may be the area of the living room, that is, the target space is considered to be the living room. It should be understood that due to the sensing performance of the sensing device itself, the detection range of the sensing device is relatively fixed. The fixed detection range may cause incorrect device control. For example, a user places a human sensor on a desk in the study with the purpose of turning on the desk lamp when someone approaches the desk. However, the detection range of the human sensor is not limited to the area near the desk but also covers other areas of the study. This means that the human sensor will turn on the desk lamp when it detects someone in other areas of the study. In other words, the fixed range of the target space may easily lead to inaccurate device control of the smart devices within the target space.

For the detection of the target's position, taking the sensing device as a radar device as an example, first obtain the azimuth angle Ø and elevation angle θ measured by the radar device itself, as well as the distance between the radar device and the target. Then, obtain the elevation angle ø of the radar device during installation through an accelerometer. Finally, calculate the position (x, y, z) of the target using the following formula:

$$x = R * cos ( θ + ∅ ) * sin ( φ ) \\ y = R * cos ( θ + ∅ ) * cos ( φ ) \\ z = R * sin ( θ + ∅ )$$

In this way, by introducing the elevation angle of the radar device during installation through the accelerometer to correct the elevation angle measured by the radar device itself, the position of the target may be more accurately determined.

Secondly, the region editing page is configured to configure at least one monitoring region within the target space of the sensing device based on the current position of the target.

It should be understood that due to the sensing performance of the sensing device itself, the detection range of the sensing device is relatively fixed. The fixed detection range may cause incorrect device control. Therefore, in this embodiment, a region editing page is provided for configuring finer-grained monitoring regions within the target space of the sensing device. That is to say, the target space of the sensing device may be divided into multiple monitoring regions through the region editing page, so as to achieve more refined device control.

It should be understood that, due to the sensing performance of the sensing device itself, the detection range of the sensing device is relatively fixed. The fixed detection range may cause incorrect device control. Therefore, in this embodiment, a region editing page is provided for configuring finer-grained monitoring regions within the target space of the sensing device. That is to say, the target space of the sensing device may be divided into multiple monitoring regions through the region editing page, so as to achieve more refined device control.

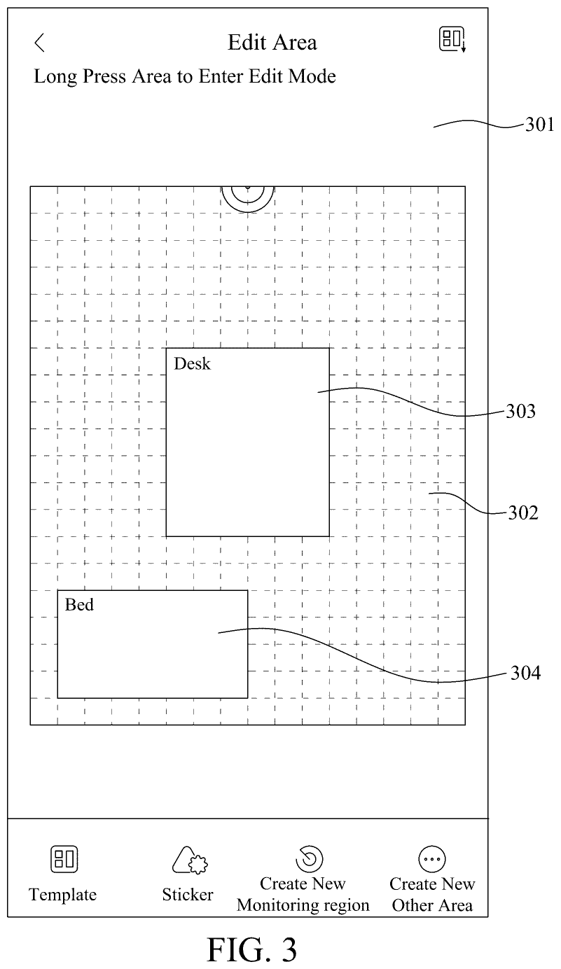

FIG. 3 illustrates a schematic diagram of the region editing page. As shown in FIG. 3, in the region editing page 301, area 302 may represent the detection range of the sensing device or the monitoring region corresponding to the target space. Area 303 represents the desk monitoring region, and area 304 represents the bed monitoring region. Based on this, taking the sensing device as a human sensor as an example, when the desk monitoring region detects a person, the desk lamp may be turned on; when the bed monitoring region detects a person, the reading lamp by the bed may be turned on. Conversely, whether it is the desk monitoring region or the bed monitoring region that detects a person, it is considered that a person is detected within the detection range of the sensing device. However, when a person is detected in the desk monitoring region, the reading lamp by the bed will not be turned on simply because a person is detected within the detection range. Similarly, when a person is detected in the bed monitoring region, the desk lamp will not be turned on simply because a person is detected within the detection range. In this way, refined control of controlled devices in different monitoring regions is achieved.

It should be noted that the monitoring regions within the target space of the sensing device are represented by graphic markers in the region editing page. For example, in FIG. 3, the graphic marker is a rectangle. Of course, in other embodiments, the graphic marker may also be any other regular shape. This embodiment does not specifically limit this. In other words, the monitoring regions displayed in the region editing page are essentially graphic markers that have a mapping relationship with the monitoring regions within the detection range of the sensing device.

In one possible implementation, step 310 may include the following steps:

Step 311, display at least one device identifier in the device page.

Each device identifier is configured to represent a bound sensing device. Here, “bound” means that the sensing device has been connected to the server end, thereby enabling interaction between the sensing device and the server end. The server end may refer to the gateway 150 shown in FIG. 1, with which the sensing device interacts through a local area network path; the server end may also refer to the server end 170 shown in FIG. 1, with which the sensing device interacts through a wide area network path. With the binding of the sensing device, the corresponding device identifier of the sensing device may be added to the device page, thereby displaying the sensing device on the device page through the device identifier.

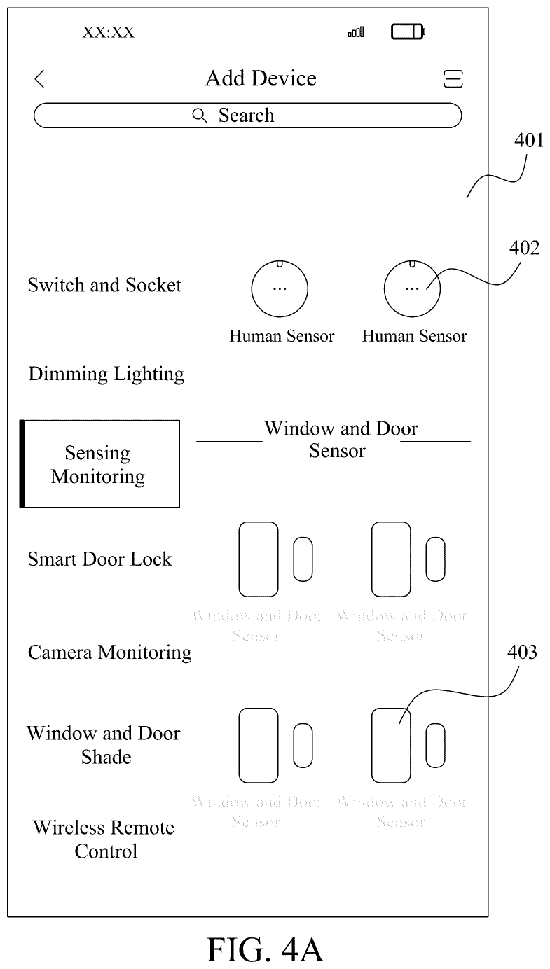

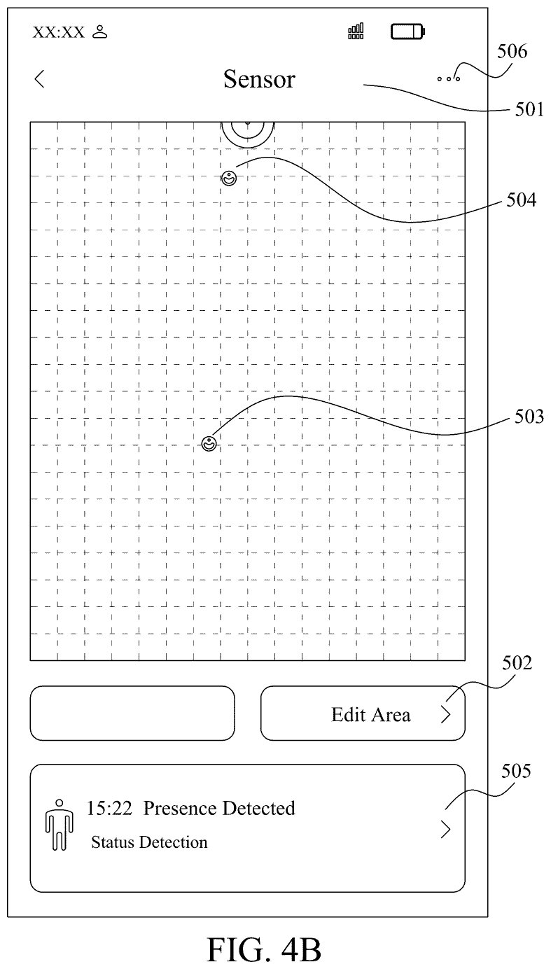

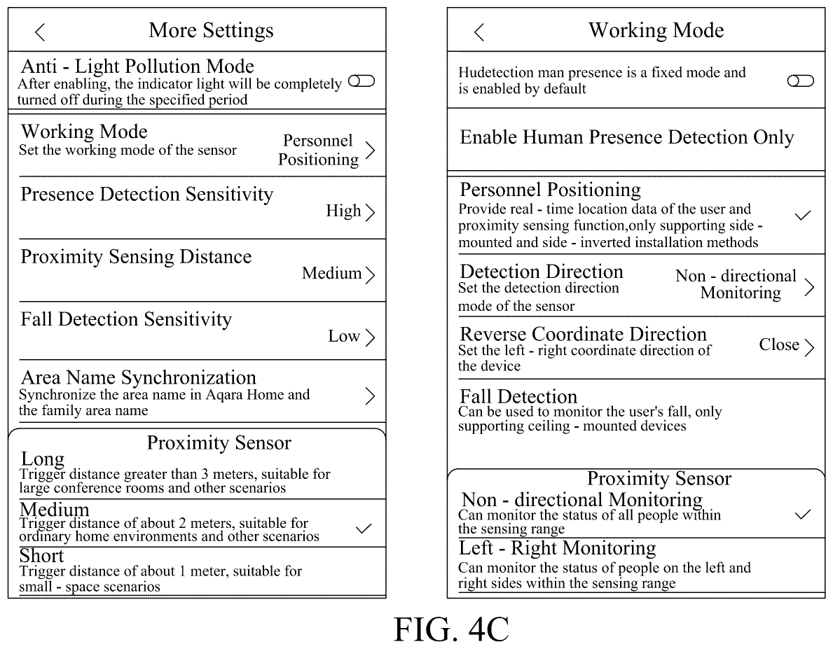

FIG. 4A illustrates a schematic diagram of the device page. As shown in FIG. 4A, in the device page 401, the user terminal displays various bound sensing devices corresponding to different device identifiers. For example, the sensing devices may include sensing monitoring devices. Specifically, a human sensor is represented by device identifier 402; the sensing devices may also include door and window sensors, represented by device identifier 403. Of course, in other embodiments, the device identifier is not limited to a combination of graphic markers and text markers. It may also be represented in any other form, such as the name of the sensing device entered by the user through the user terminal. This is not specifically limited here.

Step 313, in response to detecting a selection operation on each device identifier is detected, transition from the device page to the monitoring page corresponding to the sensing device.

The sensing device corresponds to the selected device identifier.

Continuing to refer to FIG. 4A, assuming that the user wishes to enter the monitoring page corresponding to the human sensor represented by device identifier 402, the user will click on device identifier 402. For the electronic device, it may detect this click operation and then display the monitoring page corresponding to the human sensor, as shown in FIG. 4B. Here, the click operation is considered a selection operation on device identifier 402.

It is worth mentioning that transitioning from the device page to the monitoring page corresponding to the sensing device may refer to the user terminal jumping from the device page to the monitoring page corresponding to the sensing device, or it may refer to the user terminal overlaying the monitoring page corresponding to the sensing device over the device page. This is not specifically limited here.

Step 315, display the monitoring page corresponding to the sensing device, which includes a region editing entry.

The region editing entry is configured to configure at least one monitoring region within the detection range of the sensing device.

Step 317, in response to a trigger operation on the region editing entry, transition from the monitoring page to the region editing page.

FIG. 4B illustrates a schematic diagram of the monitoring page corresponding to the sensing device. As shown in FIG. 4B, the user terminal displays a region editing entry 502 in the monitoring page 501. Assuming that the user wishes to enter the region editing page from the monitoring page 501, the user will click on the region editing entry 502. For the user terminal, it may detect this click operation and then display the region editing page. Here, the click operation is considered a trigger operation on the region editing entry 502.

In one possible implementation, the monitoring page is also used to display the status of each monitoring region. The status of each monitoring region reflects the positional relationship between each monitoring region/sensing device/detection range and the target. For example, the positional relationship may be that there is a target in each monitoring region, or it may be that the target is away from each monitoring region. This is not specifically limited here, which is conducive to achieving refined device control based on the status of each monitoring region.

The status of each monitoring region and the position of the target within each monitoring region are monitored and reported by the sensing device to the server end to which the sensing device is connected, and then pushed by the server end to the user terminal for display.

In one possible implementation, the monitoring page also displays a device editing entry.

Continuing to refer to FIG. 4B, in the monitoring page 501, the user terminal also displays the positions 503 and 504 of the targets within each monitoring region, the status 505 of each monitoring region, and the device editing entry 506. It should be noted that FIG. 4B exemplarily shows the positions of two targets within one monitoring region and the status of one monitoring region on the monitoring page 501. This embodiment does not limit the number of targets or monitoring regions that may be displayed on the monitoring page.

Assuming that the user clicks on the device editing entry 506 through the user terminal, the user terminal may detect this click operation. Then, in response to the trigger operation on the device editing entry 506 (i.e., the click operation), the user terminal transitions from the monitoring page 501 to the device editing page, which facilitates the editing of the sensing device's monitoring attributes for each monitoring region using the device editing page.

FIG. 4C illustrates a schematic diagram of the monitoring attributes of the sensing device for the monitoring region displayed on the device editing page. It should be noted that the device editing page may correspond to a single monitoring region or multiple monitoring regions simultaneously, without specific limitation. As shown in FIG. 4C, the monitoring attributes include, but are not limited to: proximity sensing distance, working mode, sensing sensitivity, and detection direction. The proximity sensing distance may be further divided into a “long” distance suitable for large space scenarios, a “short” distance suitable for small space scenarios, and a “medium” distance suitable for other space scenarios (such as smart home scenarios). It may also be considered that the sensing distance essentially reflects the sensing sensitivity of the sensing device. For example, a long distance indicates the lowest sensing sensitivity of the sensing device, while a short distance indicates the highest sensing sensitivity. For a human sensor, the working mode may be further divided into a personnel presence mode and a personnel positioning mode. The sensing sensitivity may be further divided into presence detection sensitivity and fall detection sensitivity. The detection direction may be further divided into directional monitoring from at least one direction of the monitoring region's up, down, left, and right. It may also include omnidirectional monitoring of all targets within the detectable area, that is, enabling “omnidirectional monitoring” for omnidirectional monitoring of targets. in response to detecting “omnidirectional monitoring” is disabled, directional monitoring of targets is performed.

It should be noted that, depending on the input components configured in the electronic device (such as a mouse, keyboard, display screen), the specific form of the above operations will vary. For example, in response to detecting the electronic device is a smartphone, based on the display screen configured in the smartphone, the above operations may be gesture operations such as clicking and sliding. In response to detecting the electronic device is a desktop computer, based on the mouse configured in the desktop computer, the above operations may be mechanical operations such as single-clicking, double-clicking, and dragging, without specific limitation.

With the display of the region editing page showing the current position of the target on the electronic device, the user may configure at least one monitoring region within the detection range of the sensing device based on the current position of the target based on the region editing page, which facilitates the refined control of devices.

Step 330, in response to detecting a region editing operation triggered in the region management page for configuring the monitoring region, and generating a custom monitoring region.

Still taking the region editing page included in the region management page as an example, in one possible implementation, the editing operation for configuring the monitoring region in the region editing page may include at least one of the following: an operation for editing the display range of the monitoring region when displayed on the region editing page, an operation for editing the name of the monitoring region, an operation for editing the type of the monitoring region, an operation for editing the background color of the monitoring region when displayed on the region editing page, and an operation for applying the edited monitoring region to the sensing device. The display range is configured to indicate the area occupied by the monitoring region within the detection range.

In one possible implementation, the above various editing operations are detected at the corresponding entries for editing the monitoring region. The process of displaying the entries corresponding to the various editing operations in the region editing page may include the following steps:

Step 410, on the region management page, in response to detecting a trigger operation on the control for adding a region is detected or a trigger operation on the displayed monitoring region is detected, control the region editing page to transition from the region display state to the region editing state.

Still taking the region editing page included in the region management page as an example, the trigger operation on the control for adding a region is for adding a new monitoring region; the trigger operation on the displayed monitoring region is for modifying an existing monitoring region.

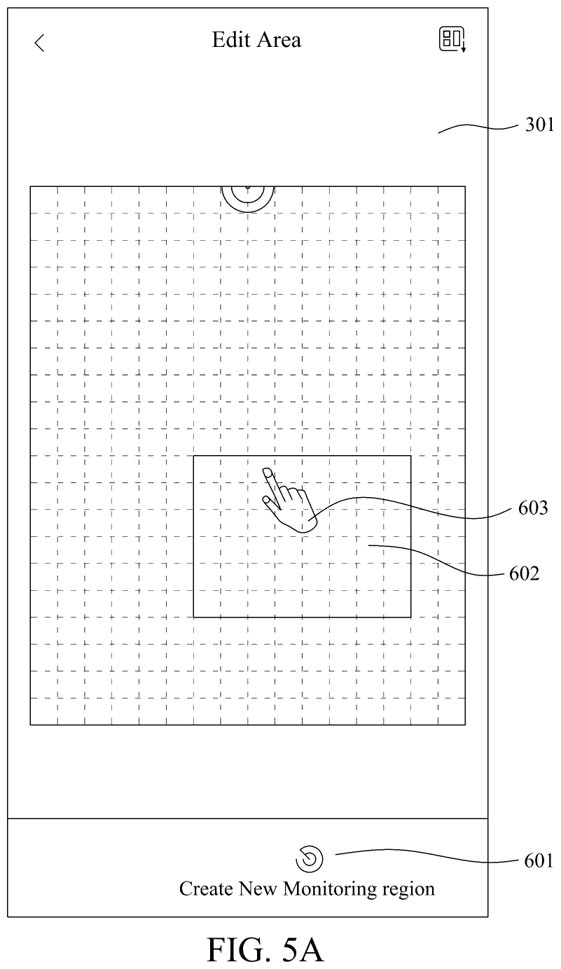

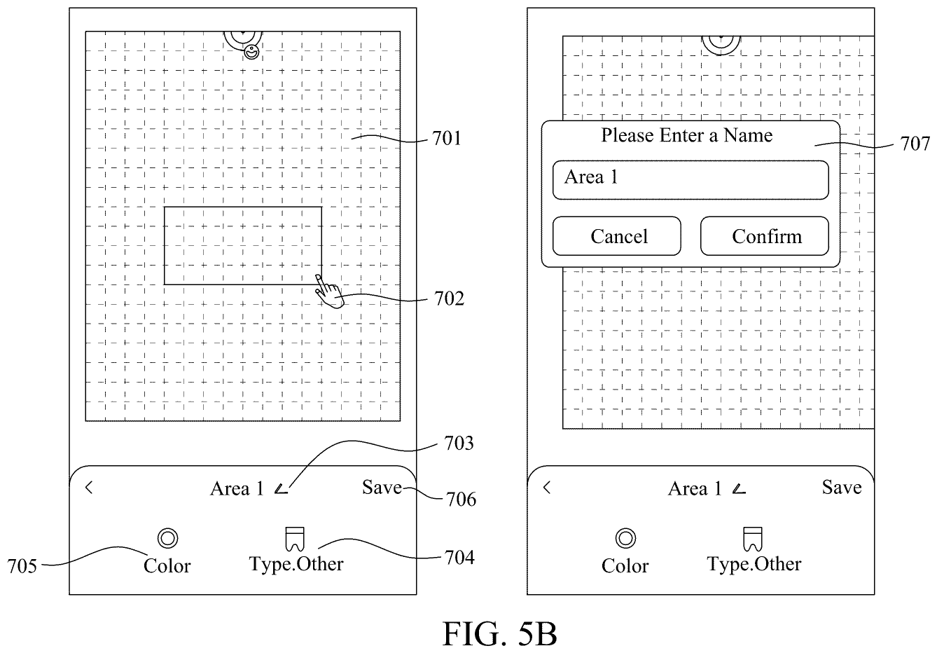

FIG. 5A illustrates a schematic diagram of the region editing page in the region display state. As shown in FIG. 5A, in the region editing page 301 in the region display state, the user may click on the control for adding a region 601 to trigger the region editing page 301 to transition from the region display state to the region editing state, so as to add a new monitoring region within the detection range of the sensing device. In addition, for the monitoring region 602 previously displayed in the region editing page 301, the user may also long press 603 the monitoring region 602 through the user terminal, which will also trigger the region editing page 301 to transition from the region display state to the region editing state, so as to modify the monitoring region 602 in the region editing page in the region editing state. Here, the click operation is considered a trigger operation on the control for adding a region, and the long press operation is considered a trigger operation on the displayed monitoring region.

Step 430, in the region management page in the region editing state, in response to editing operations on each monitoring region, edit each monitoring region.

Still taking the region editing page included in the region management page as an example, in one possible implementation, the region editing page in the region editing state displays at least one entry for editing the monitoring region, so that editing operations may be detected at each entry, and the user terminal responds to the editing operations to edit each monitoring region.

In one possible implementation, the at least one entry for editing the monitoring region is displayed in the region editing page in the region editing state in the form of a floating window.

FIG. 5B illustrates a schematic diagram of the region editing page in the region editing state. As shown in FIG. 5B, after the region editing page enters the region editing state, the page correspondingly displays multiple entries for editing the monitoring region, including but not limited to: an entry 701 for editing the display range of the monitoring region (which is essentially the blank area of the region editing page), an entry 703 for editing the name of the monitoring region, an entry 704 for editing the type of the monitoring region, an entry 705 for editing the background color of the monitoring region, and an entry 706 for applying the edited monitoring region to the sensing device (which may also be considered as an entry for saving the edited monitoring region).

Taking the detection of an editing operation at entry 701 as an example, the user may select the display range of the monitoring region when displayed on the region editing page through a sliding gesture 702 at entry 701 on the user terminal, or select the display range of the monitoring region when displayed on the region editing page by clicking different grids presented on the region editing page multiple times at entry 701, thereby completing the editing of the display range of the monitoring region when displayed on the region editing page. In one possible implementation, the sliding gesture or clicking operation is considered an operation for editing the display range of the monitoring region when displayed on the region editing page. It may be understood that the larger the selected display range of the monitoring region when displayed on the region editing page, the larger the area occupied by the monitoring region within the detection range of the sensing device. In one possible implementation, the display range of the region editing page is set with a predetermined number of grids, which may be flexibly set according to the actual needs of the application scenario. For example, one grid in the region editing page may be mapped to a 0.5 meter×0.5 meter area within the detection range of the sensing device. In this way, not only is high-granularity monitoring region management of the sensing device's detection range facilitated, but also users may configure corresponding device control services for controlled devices within different monitoring regions, thereby facilitating refined device control and greatly enhancing user experience.

Alternatively, taking the detection of an editing operation at entry 703 on the user terminal as an example, the user clicks on entry 703, causing an input dialog box 707 to pop up on the region editing page. The user may then enter the name “Area 1” for the monitoring region in the input dialog box 707 and complete the input by clicking “OK,” thereby completing the editing of the monitoring region's name. Here, the above clicking, inputting, and clicking operations are considered operations for editing the name of the monitoring region.

After the user completes the editing operation on the monitoring region through the user terminal, the user terminal may display the edited monitoring region on the region editing page. Referring back to FIG. 3, FIG. 3 shows a desk monitoring region 303 and a bed monitoring region 304 displayed on the region editing page 301. That is to say, based on the region editing page, the user has configured at least two monitoring regions within the detection range of the sensing device.

Step 350, displaying an automation configuration page for the monitoring region.

The automation configuration page is configured to configure at least one of the trigger conditions and controlled actions related to the monitoring region. The trigger conditions are related to the status of the monitoring region, and the controlled actions refer to the corresponding actions that the controlled devices within the detection range need to perform when the trigger conditions are met.

Regarding the automation configuration page, the user terminal may enter it through an automation control added in the region editing page, or through a dedicated automation control in the client, without specific limitation.

In one possible implementation, the automation configuration page is entered through an automation control in the associated page corresponding to the sensing device. Specifically, step 350 may include the following steps: display the associated page corresponding to the sensing device, which displays an automation control; in response to a trigger operation on the automation control, displaying the automation configuration page.

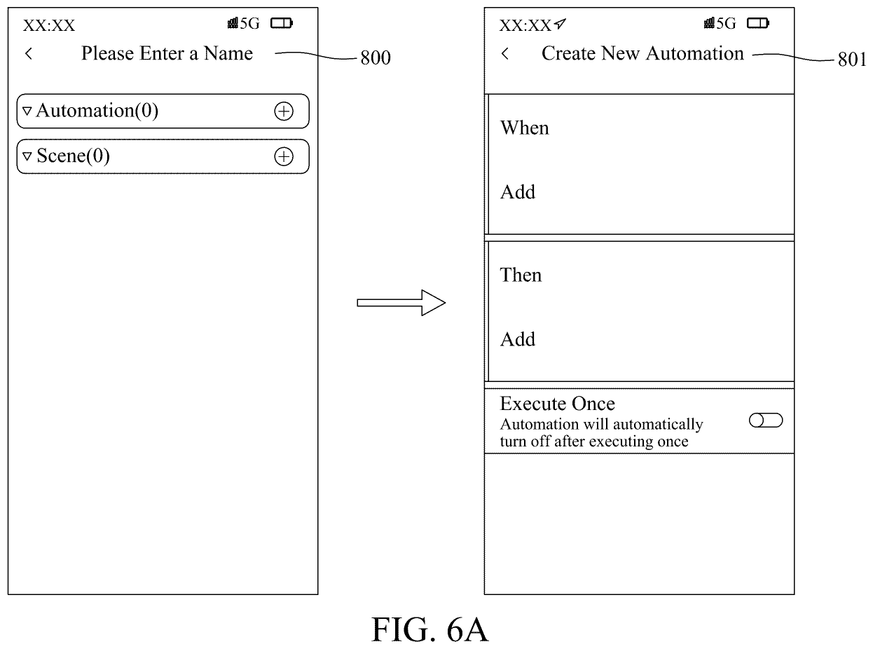

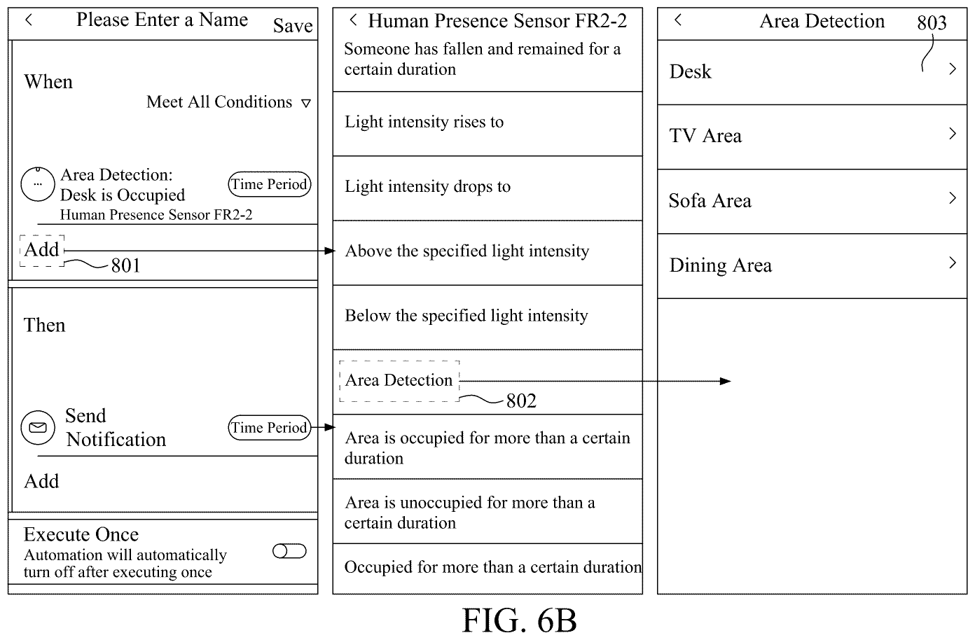

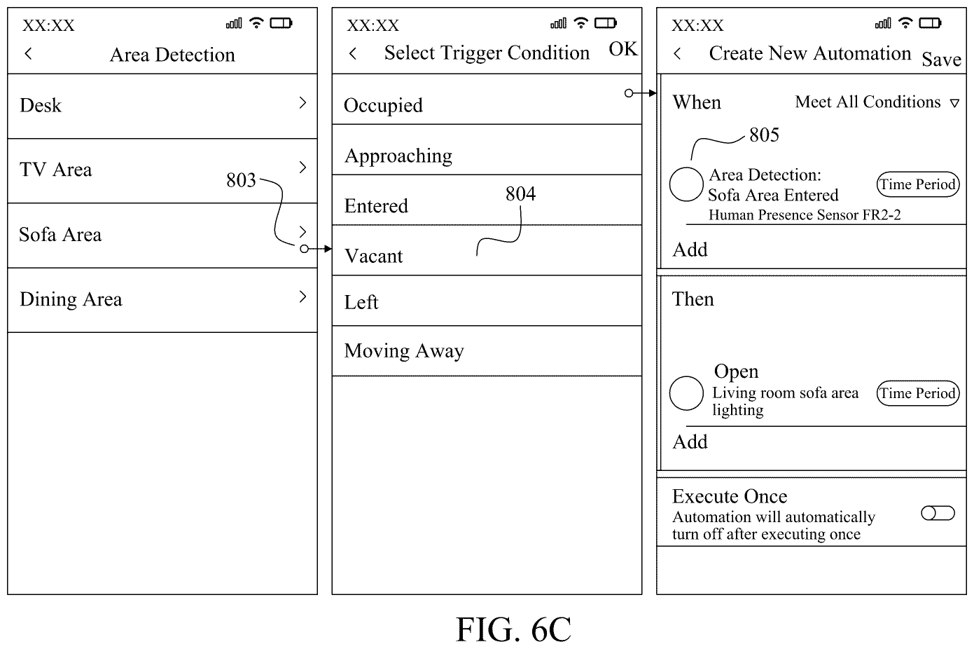

FIG. 6A illustrates a schematic diagram of entering the automation configuration page from the associated page. As shown in FIG. 6A, in the associated page 800, the user terminal displays an automation control “Automation.” When the user clicks on this automation control, the user terminal transitions from the associated page 800 to the automation configuration page 801. On the automation configuration page 801, “when” is configured to configure the trigger conditions related to the monitoring region, and “then” is configured to configure the controlled actions related to the monitoring region. Here, the click operation is considered a trigger operation on the automation control.

Step 370, in response to an automation configuration operation for the monitoring region in the automation configuration page, generating automation configuration schemes corresponding to the monitoring region; the automation configuration schemes are configured to achieve automatic control of the controlled device by monitoring the region status of the monitoring region.

The automation configuration schemes are configured to achieve automatic control of the controlled device by monitoring the status of the monitoring region.

Referring to FIG. 6B, after the user clicks on “when,” the user terminal may enter page 802 from the automation configuration page 801. In page 802, in response to detecting the user continues to click on “area detection,” the user terminal may enter page 803 to view the monitoring regions for which the automation configuration schemes may be generated. For example, in FIG. 6B, the monitoring regions may include TV area, coffee table area, sofa area, dining area, etc.

In one possible implementation, responding to an automation configuration operation on the monitoring region in the automation configuration page and generating automation configuration schemes for the monitoring region include: in the automation configuration page, in response to detecting an automation configuration operation on the trigger condition configuration control is detected, configuring a corresponding trigger condition for the monitoring region of the sensing device; generating the automation configuration schemes based on the completed trigger condition configuration, and displaying the automation configuration schemes on the automation configuration page.

After determining the monitoring region in page 803, as shown in FIG. 6C, the user terminal may enter page 804 to configure the corresponding trigger condition for the monitoring region of the sensing device. For example, the trigger condition may include, but is not limited to: the status of the monitoring region indicating that there is someone in the monitoring region, no one in the monitoring region, someone approaching/entering the monitoring region, someone leaving/moving away from the monitoring region.

After the user selects the trigger condition in the automation configuration page, the automation configuration schemes are generated based on the completed trigger condition configuration and displayed in the automation configuration page.

In some other embodiments, the automation configuration page may also be entered in other ways. For example, it may be entered directly through the editing entry for the monitoring region in the region management page. In short, any automation configuration page entered in any way is applicable.

In one possible implementation, responding to an automation configuration operation on the monitoring region in the automation configuration page and generating automation configuration schemes for the monitoring region include: in response to detecting an automation configuration operation on the controlled action entry is detected, configuring device control data associated with the trigger condition; the device control data is configured to instruct the controlled device to perform a corresponding action; generating the automation configuration schemes based on the completed device control data configuration, and displaying the automation configuration schemes on the automation configuration page.

Similarly, the process of configuring the controlled action is similar, that is, when the user terminal detects a trigger operation on the controlled action entry, configure the device control data associated with the trigger condition. The device control data is configured to instruct the controlled device to perform the corresponding action. The description is not repeated here.

After completing the configuration of at least one of the trigger conditions and controlled actions for the determined monitoring region, the user terminal may generate automation configuration schemes corresponding to the monitoring region. As shown in FIG. 6C, the detection range of the sensing device is the living room, and the monitoring region in the living room includes the sofa area. The trigger condition for this sofa area is that someone enters the sofa area, and the controlled action is to turn on the lighting lamp located in the sofa area of the living room.

Thus, by monitoring whether the status of the sofa area indicates that someone has entered the sofa area, the user terminal may achieve automatic control of whether to turn on the lighting lamp located in the sofa area of the living room.

That is to say, when the monitoring regions displayed in the region editing page are applied to the sensing device, the sensing device will monitor the status of each monitoring region and report the status of each monitoring region to the server end to which the sensing device is connected, such as the gateway 150 or the server end 170 shown in FIG. 1.

Correspondingly, after receiving the status of each monitoring region reported by the sensing device, the server end may determine whether to perform refined device control on the controlled devices within each monitoring region based on the status of each monitoring region monitored by the sensing device. As mentioned earlier, in response to detecting a human sensor detects someone in the desk monitoring region, the server end may turn on the desk lamp; in response to detecting a human sensor detects someone in the bed monitoring region, the server end may turn on the reading lamp by the bed.

Through the above process, the configuration of at least one monitoring region within the detection range of the sensing device is completed. The controlled devices within the detection range may perform corresponding actions triggered by the status of each monitoring region within the detection range. The monitoring of the status of each monitoring region is independent and does not interfere with each other. Moreover, the relationship between each target and each monitoring region is also independent, achieving refined device control. This effectively solves the problem in the related technology that device control is din response to detectingficult to be precise due to the fixed detection range of the sensing device.

Due to the complexity of the target space in which the smart device is located, for example, there may be areas in the target space that interfere with device control. For instance, when the smart device is a human sensor, in response to detecting the target space contains plants, the human sensor may mistakenly detect the movement of the plants caused by the wind as human motion, thereby producing an incorrect human detection result. in response to detecting there is an automation configuration triggered by the human sensor, it will incorrectly control the corresponding smart device to perform actions.

As mentioned above, due to the complexity of the target space, it is very difficult to accurately divide the target space. Based on this, different areas may be set for the smart device to divide the target space into several regions, allowing the smart device to perform different processing for different regions. However, due to the complexity of the target space, it is not only difficult but also inefficient to accurately divide the target space. For example, in response to detecting the target space is a living room containing furniture such as a sofa, plants, a coffee table, and a television, which vary in size and are irregularly placed, the process of setting different regions for the customer is complex and cumbersome.

Regarding the setting of the area range, single-click selection may be used for single selection of the area range, but selecting each grid one by one is inefficient. Alternatively, fixed shapes such as rectangles, circles, and triangles may be used to frame-select the area range through dragging, but framing cannot meet the addition or removal of one or several specific areas.

In other words, neither single-click selection nor framing may efficiently set the area range while allowing free setting of the area range. Therefore, there is an urgent need for a method of setting the area range that combines efficiency and flexibility to divide the target space.

For example, the target space here may be understood as the monitoring range corresponding to the region editing page described in the above embodiments, such as area 302 in FIG. 3, which represents the monitoring range of the sensing device and also represents the monitoring region corresponding to the target space. Here, the setting of the area range may be understood as the setting of the monitoring region described in the above embodiments, such as the setting of area 303 in FIG. 3, for example, the setting of the desk monitoring region and the bed monitoring region.

It may be seen that there is a problem in the related technology that it is difficult to efficiently set the area range.

To this end, the present disclosure also provides a method for setting the area, which may flexibly set the area range for the functional area, thereby effectively improving the efficiency of setting the area range, while also improving the accuracy of setting control. Accordingly, the method for setting the area is applicable to an area setting device, which may be deployed on an electronic device.

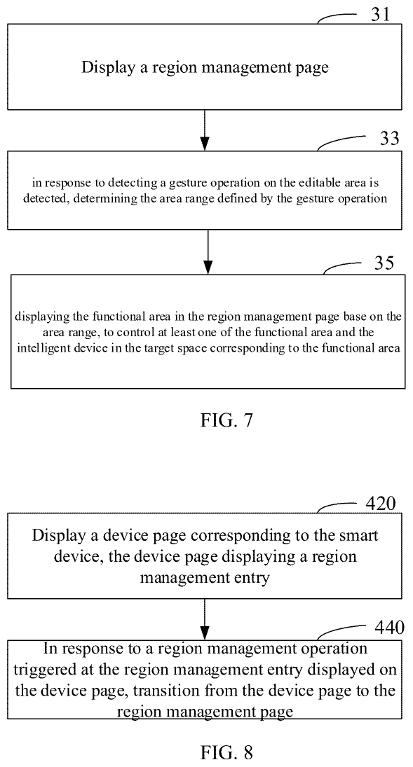

Please refer to FIG. 7. The embodiment of the present disclosure provides a method for setting an area, which is applied to an electronic device. The electronic device may specifically be the user terminal 110 in the implementation environment shown in FIG. 1.

In the following method embodiments, for the sake of description, the electronic device is taken as the subject of each step of the method, but this is not specifically limited.

As shown in FIG. 7, the method may include the following steps:

Step 31: Display a region management page;

The region management page includes an editable area. It should be understood that the editable range of the editable area is limited. Specifically, the editable range of the editable area corresponds to the spatial range of the target space. The target space refers to the space in which the smart device corresponding to the setting page is located. For example, in response to detecting the smart device is deployed in the living room, then the living room is the target space. The editable area here may also be understood as being displayed within the above-mentioned region editing page, and may be all or part of the region editing page.

Regarding the region management page, it may be used to edit the device page, such as creating functional areas and editing functional areas in the device page. Based on this, the editable area in the region management page is configured to edit the functional area, that is, the monitoring region in the region editing page mentioned in the above embodiments. In other words, the functional area here may be a part of the monitoring region mentioned above, that is, the monitoring region includes the functional area.

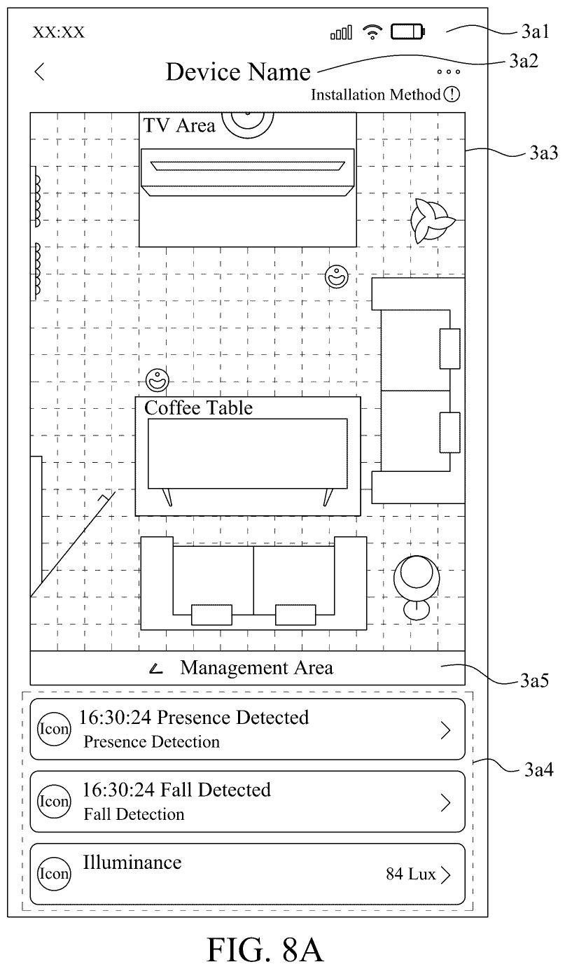

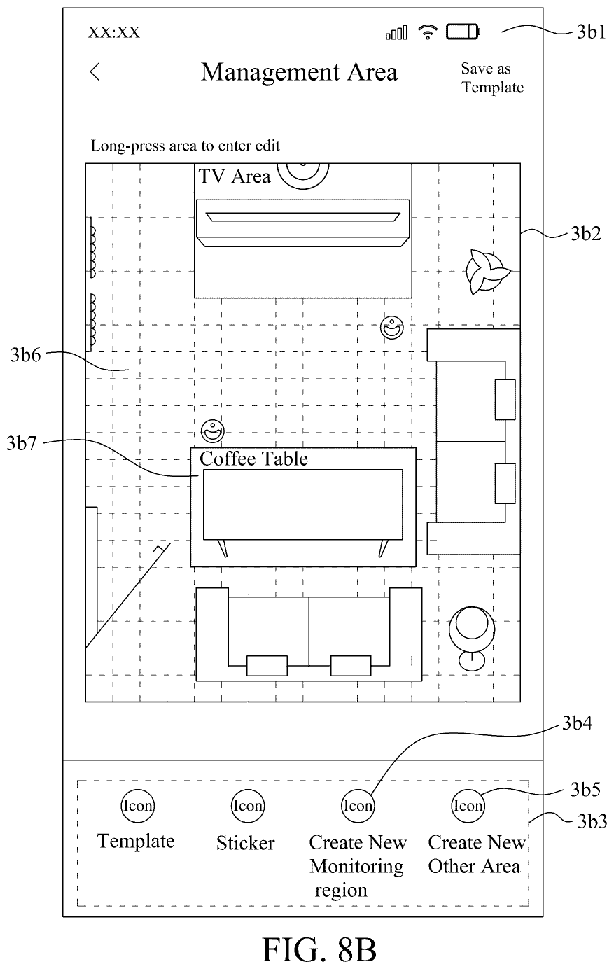

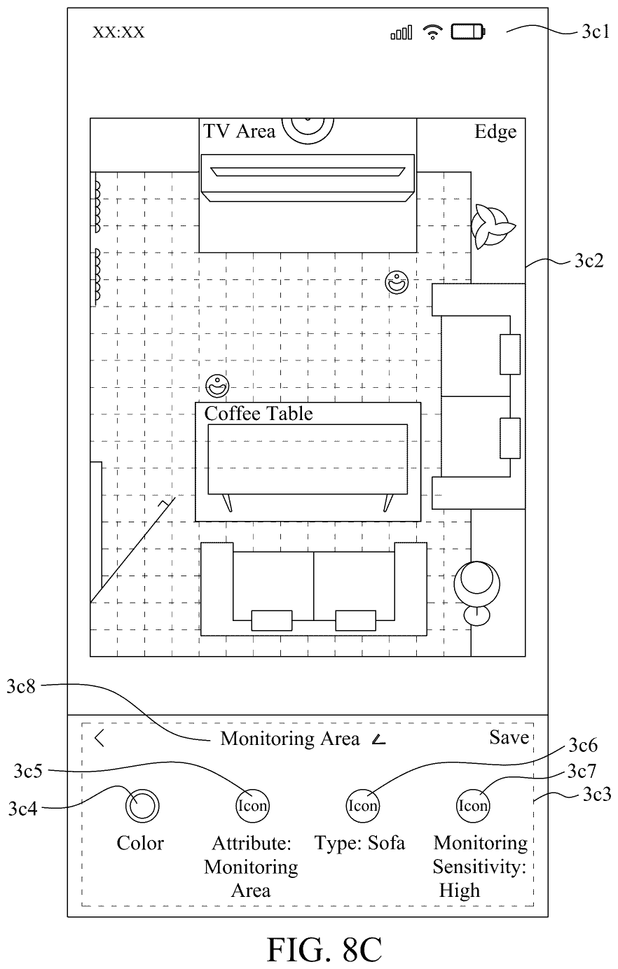

In one possible implementation, as shown in FIG. 8, before step 31, the method further includes the following steps:

Step 420: Display a device page corresponding to the smart device, the device page displaying a region management entry.

The smart device refers to a smart device deployed in the Internet of Things, such as a smart device deployed in a smart home network. The setting page is configured to view and manage the smart device, such as viewing the work log of the smart device and managing the functional area of the smart device.

FIG. 8A illustrates a schematic diagram of a device page. As shown in FIG. 8A, the device page 3al displays a device name 3a2, a target space area 3a3, and a device work log area 3a4. The device name is the name of the smart device. The target space area 3a3 displays the target space and the furniture, equipment, etc. in the target space. The device work log area 3a4 is configured to display the work log of the device. The device page is configured to display information of the smart device. in response to detecting the smart device is set with a functional area, correspondingly, the functional area is not displayed in the target space area 3a3 of the device page 3al. The device page 3al also displays a management area entry 3a5. By triggering the management area entry 3a5, the functional area of the smart device may be set.

Step 440: In response to a region management operation triggered at the region management entry displayed on the device page, transition from the device page to the region management page.

As mentioned above, the device page displays a region management entry. The region management entry corresponds to a region management operation and is configured to display the region management page. in response to detecting a user wishes to manage the functional area of the smart device, the user may trigger a region management operation at the region management entry, thereby displaying the region management page and managing the functional area of the smart device.

For example, referring back to FIG. 8A, the device page 3al also displays a management area entry 3a5. By clicking on the management area entry 3a5, the electronic device detects a region management operation at the region management entry and, in response to the region management operation, displays a region management page 3b1, as shown in FIG. 8B. The region management page 3b1 displays an editable area 3b2 and an editing entry area 3b3. The editing entry area 3b3 displays a template entry, a sticker entry, a new monitoring region entry 3b4, and a new other area entry 3b5. The editable area 3b2 displays a blank area 3b6 and a functional area 3b7. Here, the click operation is considered a region management operation.

As mentioned above, the region management page may be used to create functional areas and edit functional areas in the device page. Based on this, a region setting operation for the functional area is triggered in the region management page, thereby displaying the editable area and editing the functional area.

In one possible implementation, in response to a region setting operation targeting the region creation entry in the region management page; or in response to a region setting operation triggered within the display range of the region management page that does not show a functional area; the region management page transitions from the display state showing the functional area to the edit state showing the editable area, to detect a gesture operation triggered in the editable area and confirm the area range for the newly created functional area.

In one possible implementation, in response to a region setting operation targeting the functional area, the region management page transitions from the display state showing the functional area to the edit state showing the editable area, to detect a gesture operation triggered in the editable area and modify the area range for the functional area.

Firstly, it should be noted that the region setting operation is an operation used to edit the functional area in the editable area. To edit the functional area in the region management page, the control entry for the region setting operation may be set in the region management page, for example, the control entry for the region setting operation may be set in any blank display area, functional area, or creation entry of the region management page, without limitation. In response to detecting a user wishes to edit the functional area in the region management page, the user may trigger the region setting operation through the above-mentioned control entry, thereby editing the functional area in the editable area. The region setting operation may be triggered by clicking or long-pressing the above-mentioned control entry, without limitation.

The region setting operation triggered in any blank display area or at the creation entry in the region management page may be used to create a new functional area for the smart device; the region setting operation triggered at the functional area in the region management page may be used to modify the area range of an existing functional area of the smart device.

It should be noted that before the region editing operation is triggered, the editable area in the region management page is in a non-editable state. After the region editing operation is triggered, the area in the region management page is in an editable state, and a gesture operation triggered in the editable area may be detected to confirm the area range for the newly added functional area or to modify the area range of the functional area. Here, the gesture operation may be a first gesture operation, a second gesture operation, and/or a third gesture operation, without limitation. It may be understood that in response to detecting a region setting operation is not triggered in the region management page, the corresponding functional area cannot be edited.

For example, please refer to FIG. 8B. As shown in FIG. 8B, the editing entry area 3b3 in the region management page 3b1 displays a new monitoring region entry 3b4 and a new other area entry 3b5. The editable area 3b2 displays a blank area 3b6 and a functional area 3b7. The new monitoring region entry 3b4 is configured to add a monitoring region to the smart device, and the new other area entry 3b5 is configured to add a functional area other than the monitoring region to the smart device. When the user clicks on the new monitoring region entry 3b4, the new other area entry 3b5, the blank area 3b6, or the functional area 3b7, the electronic device detects a region setting operation at the above-mentioned control entry and begins to edit the functional area in response to the region setting operation. FIG. 8C illustrates an example of editing a functional area. As shown in FIG. 8C, the region management page 3c1 displays an editable area 3c2 and a region editing entry area 3c3. The editable area 3c2 corresponds to the editable area 3b2 in FIG. 8C, and the functional area may have its area range set in the editable area 3c2. The region editing entry area 3c3 includes a color entry 3c4, a region attribute entry 3c5, a region type entry 3c6, a monitoring sensitivity entry 3c7, and a name entry 3c8. By triggering the above region editing entries, the color, attributes, type, monitoring sensitivity, and name of the functional area may be edited. Here, the click operation is considered a region setting operation.

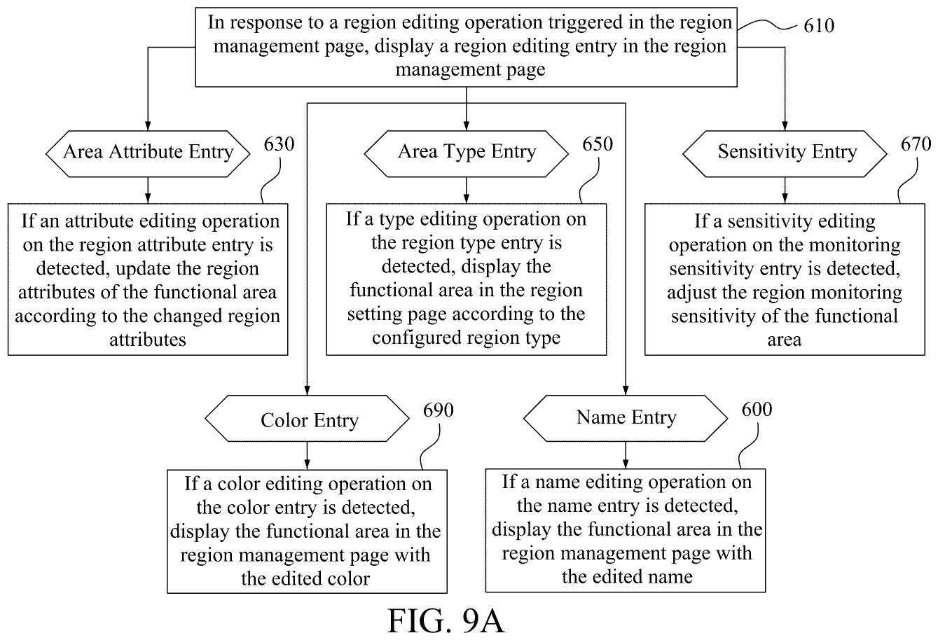

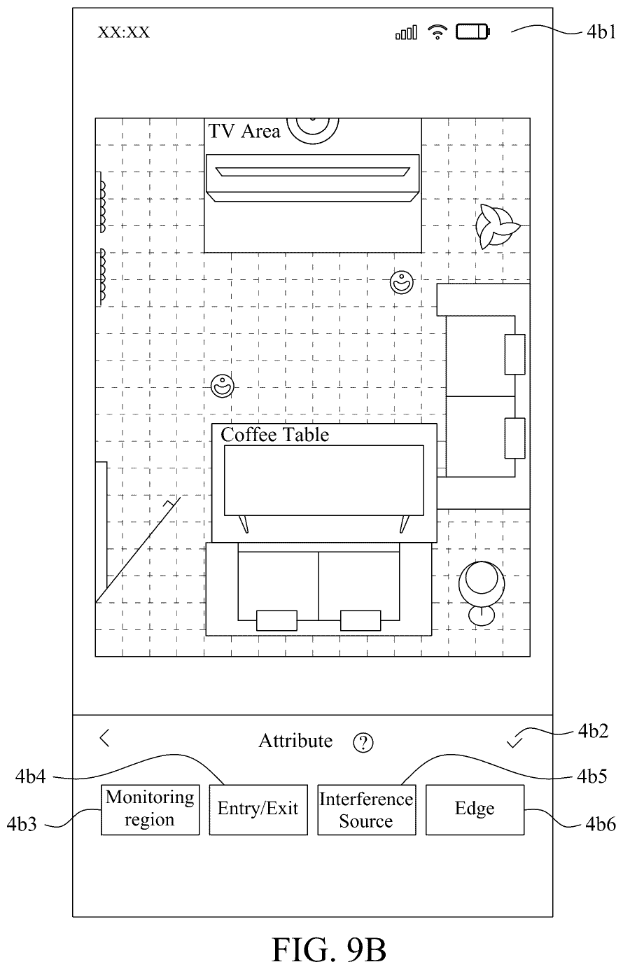

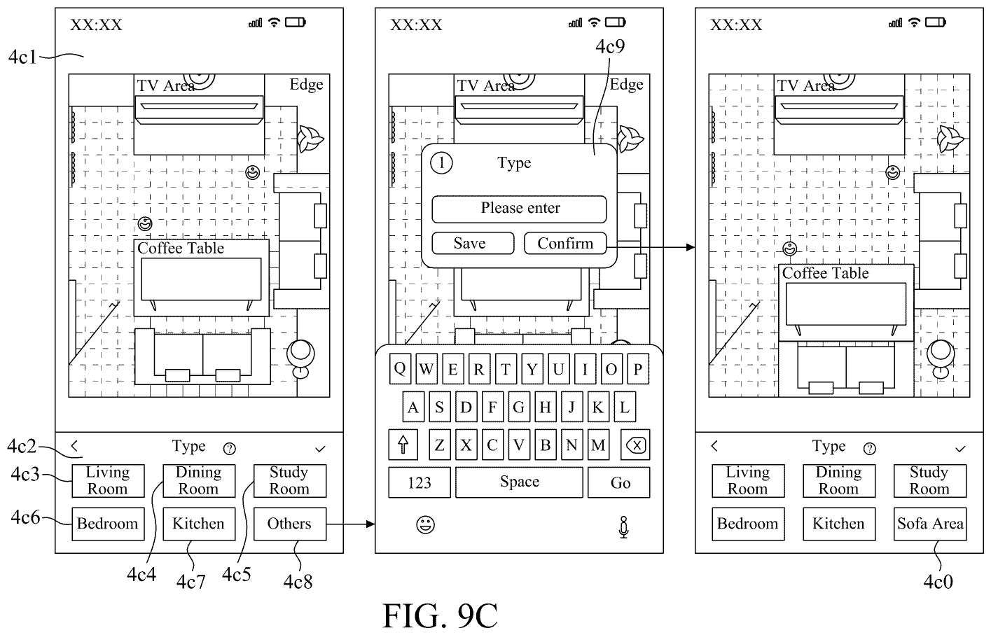

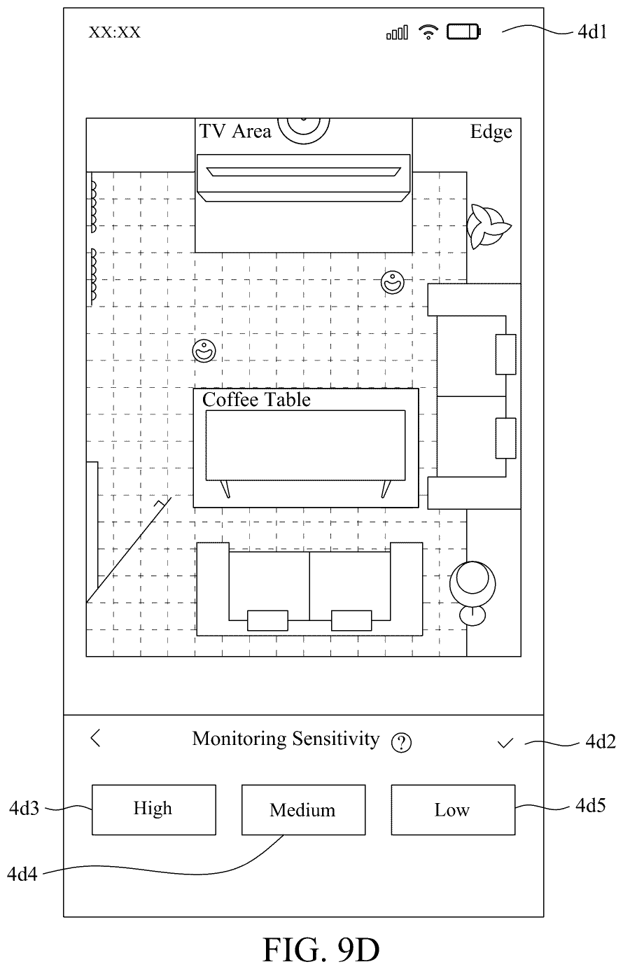

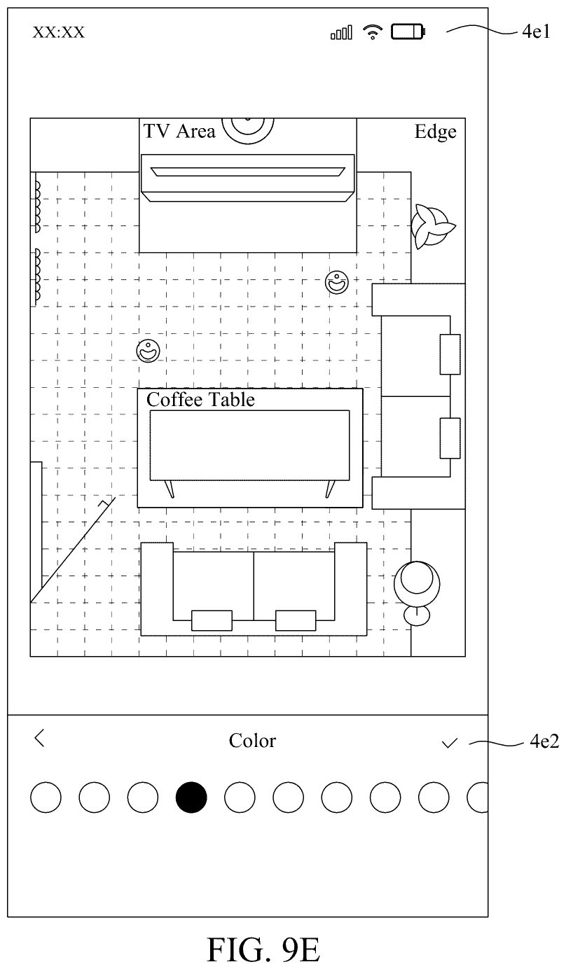

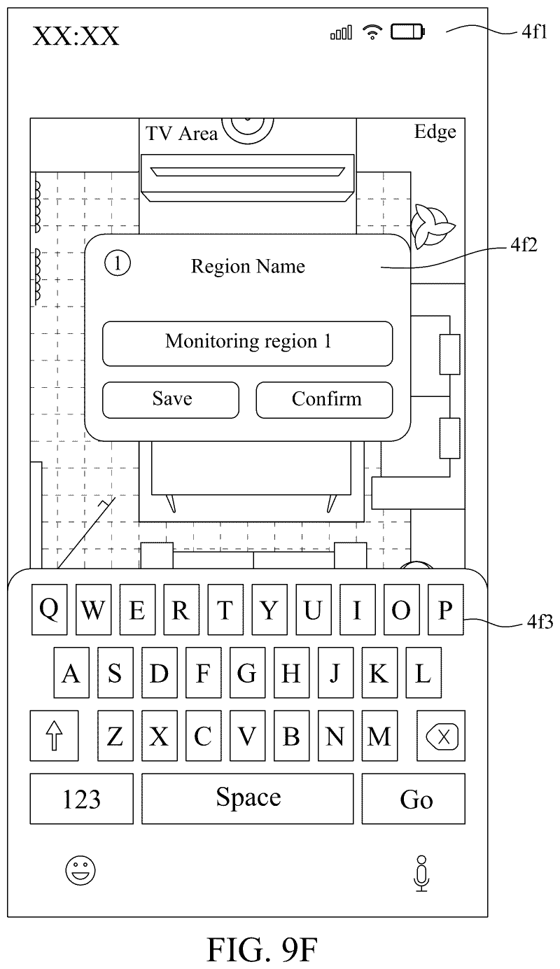

Optionally, in the editable area in the edit state, the area range of the functional area may be set, and the color, attributes, type, monitoring sensitivity, and name of the functional area may be edited to make the functional area more practical and more in line with user needs. In one possible implementation, as shown in FIG. 9A, editing the functional area also includes the following steps:

Step 610: In response to a region editing operation triggered in the region management page, display a region editing entry in the region management page.

The region editing operation is configured to edit the functional area. To edit the functional area, the control entry for the region editing operation may be set in the region management page. In response to detecting a user wishes to edit the functional area, the user may trigger the control entry to edit the region.

Regarding the region editing entry, it provides specific editing items. The region editing entry includes at least one of a region attribute entry, a region type entry, and a monitoring sensitivity entry. It may also include a color entry and a name entry, without limitation. The region attribute entry corresponds to an attribute editing operation, the region type entry corresponds to a type editing operation, the monitoring sensitivity entry corresponds to a sensitivity editing operation, the color entry corresponds to a color editing operation, and the name entry corresponds to a name editing operation.

For example, referring back to FIG. 8C, the region editing entry area 3c3 includes a color entry 3c4, a region attribute entry 3c5, a region type entry 3c6, a monitoring sensitivity entry 3c7, and a name entry 3c8.

Step 630: In response to detecting an attribute editing operation on the region attribute entry is detected, update the region attributes of the functional area according to the changed region attributes.

The region attributes are configured to indicate the attributes of the functional area, which may include monitoring region, entrance/exit, interference source, and edge. It may be understood that for different functional attributes, the smart device differentiates the processing of the functional area based on the functional attributes.

Taking a human sensor as an example of a smart device, the region attributes of the functional areas where moving objects such as fans, air conditioners, and plants in the target space are located may be set to interference sources, and the walls in the target space may be set as edges. When the human sensor is working, it will ignore the movements occurring in this functional area to improve the accuracy of monitoring. The region attributes of the functional areas that need to be monitored may be set to monitoring regions, and the human sensor will monitor the movements occurring in these functional areas. Optionally, users may also configure automation for the functional areas of the monitoring regions based on region attributes. The region attributes of the functional areas at the entrances and exits of the target space may be set to entrances and exits to increase the speed of target creation and deletion at the entrance and exit locations and reduce the probability of target creation at non-entrance and exit locations. The target may be a tracking target, such as an animal or a person, without limitation.

The attribute editing operation is configured to change the attributes of the functional area. In response to detecting a user wishes to edit the attributes of the functional area, the user may trigger the region attribute entry to edit the attributes of the functional area.

For example, referring back to FIG. 8C, the region editing entry area 3c3 includes a region attribute entry 3c5. For the electronic device, an attribute editing operation is detected at the region attribute entry, and in response to the attribute editing operation, an attribute selection area 4b1 is displayed.

FIG. 9B illustrates an example of editing region attributes. As shown in FIG. 9B, the attribute selection area 4b2 in the region management page 4b1 includes a monitoring region 4b3, an entrance/exit 4b4, an interference source 4b5, and an edge 4b6. By selecting the monitoring region 4b3 and confirming, the region attributes of the functional area may be set to “monitoring region.” Here, the click operation is considered an attribute editing operation.

Step 650: In response to detecting a type editing operation on the region type entry is detected, display the functional area in the region setting page according to the configured region type.

The region type is configured to indicate the function of the functional area. For example, the type of the functional area is a TV area, and the functional area is configured to place a TV. It may be understood that the function of the functional area is not fixed. For example, when the settings in the functional area change, the type of the functional area may also change accordingly. For example, in response to detecting the TV in the “TV” functional area is changed to a coffee table, the region type of the “TV” functional area may be changed from “TV” to “coffee table” to obtain a “coffee table” functional area.

The type editing operation is configured to change the type of the functional area. In response to detecting a user wishes to edit the type of the functional area, the user may trigger the region type entry to edit the type of the functional area.

For example, referring back to FIG. 8C, the region editing entry area 3c3 includes a region type entry 3c6. By clicking on the region type entry 3c6, the electronic device detects a type editing operation at the region type entry and, in response to the type editing operation, displays a type selection area 4bl.

FIG. 9C illustrates an example of editing the region type. As shown in FIG. 9C, the type selection area 4c2 in the region management page 4c1 includes a living room 4c3, a dining room 4c4, a study 4c5, a bedroom 4c6, a kitchen 4c7, and others 4c8. By selecting others 4c8, as shown in 4c8 in FIG. 9C, a type input box 4c9 is displayed. By entering “sofa area” and confirming, as shown in 4c0 in FIG. 9C, the region type of the functional area may be changed to a “sofa area” functional area. Here, the click operation is considered a type editing operation.

Step 670: In response to detecting a sensitivity editing operation on the monitoring sensitivity entry is detected, adjust the region monitoring sensitivity of the functional area.

The region monitoring sensitivity is configured to indicate the monitoring sensitivity of the corresponding device to the functional area.

The sensitivity editing operation is configured to adjust the region monitoring sensitivity trigger sensitivity of the functional area. The region monitoring sensitivity trigger sensitivity is configured to indicate the response capability of the smart device when performing a trigger operation on the monitoring sensitivity of the functional area, that is, the minimum signal strength that the smart device may detect for the trigger operation in the functional area. It may be understood that a high region monitoring sensitivity trigger sensitivity allows the smart device to more accurately detect the signal trigger operations occurring in the functional area. For example, in response to detecting the smart device is a human sensor, and the region monitoring sensitivity of the functional area is adjusted to high sensitivity, the human sensor may detect slight human signals in the functional area. In response to detecting a user wishes to adjust the region monitoring sensitivity trigger sensitivity of the functional area, the user may trigger the sensitivity entry to adjust the region monitoring sensitivity trigger sensitivity of the functional area.

For example, referring back to FIG. 8C, as shown in FIG. 8C, the region editing entry area 3c3 includes a monitoring sensitivity entry 3c7. When the user clicks on the monitoring sensitivity entry 3c7, the electronic device detects a sensitivity editing operation at this entry.

As shown in FIG. 9D, the region management page 4d1 displays a sensitivity selection area 4d2, which includes high sensitivity 4d3, medium sensitivity 4d4, and low sensitivity 4d5. By selecting high sensitivity 4d3 and confirming, the monitoring sensitivity of the functional area is adjusted to high. Here, the click operation is considered a sensitivity editing operation.

Step 690: In response to detecting a color editing operation on the color entry is detected, display the functional area in the region management page with the edited color.

It should be noted that each functional area in the region management page may correspond to a different background color. By displaying functional areas with different background colors, it is convenient for users to distinguish between functional areas when viewing the region management page.

The color editing operation is configured to edit the background color of the functional area. In response to detecting a user wishes to change the background color of the functional area, the user may trigger the color entry to change the background color of the functional area.

For example, referring back to FIG. 8C, the region editing entry area 3c3 includes a color entry 3c4. When the user clicks on the color entry 3c4, the electronic device detects a color editing operation at this entry and responds to it.

As shown in FIG. 9E, the region management page 4e1 displays a color selection page 4e2, which shows multiple selectable background colors 3e2. By selecting one of the background colors, the background color of the functional area is changed, and the selected background color is configured as the background color of the functional area. Here, the click operation is considered a color editing operation.

Step 600: In response to detecting a name editing operation on the name entry is detected, display the functional area in the region management page with the edited name.

It should be noted that different functional areas in the region management page may be named using different names for the functional areas, which facilitates users in distinguishing between functional areas when viewing the region management page and also makes it easier for users to accurately identify the desired functional area when configuring automation based on the functional area.

The name editing operation is configured to edit the name of the functional area. In response to detecting a user wishes to change the name of the functional area, the user may trigger the name entry to change the name of the functional area.

For example, referring back to FIG. 8C, the region editing entry area 3c3 includes a name entry 3c8. When the user clicks on the name entry 3c8, the electronic device detects a name editing operation at this entry and responds to it.

As shown in FIG. 9F, the region management page 4f1 displays a name editing area 4f2 and a keyboard area 4f3. By entering a name using the keyboard area 4f3 and confirming, the name of the functional area is changed, and the entered name is used as the name of the functional area. Here, the click operation is considered a name editing operation.

Through the above process, it is possible to customize the editable items such as the name, color, region type, region attributes, and region monitoring sensitivity of the functional area. This makes the functional area more in line with the actual situation, not only facilitating user management and viewing of each functional area, but also making the automation configuration based on the functional area more in line with expectations. The device control using the automation configuration is more precise, thereby enhancing the practicality of device control and, consequently, improving user experience.

Step 33: in response to detecting a gesture operation on the editable area is detected, determining the area range defined by the gesture operation.

As mentioned above, the editable area may be used to set the area range for the functional area. Specifically, users perform various gesture operations on the terminal, and the area range determined by these gesture operations is configured to set the area range for the functional area. Specifically, the gesture operations may include single-click operations, sliding operations, or framing operations, without limitation.

For example, a single-click operation may be used to add or remove a grid area for the functional area in the editable area, a sliding operation may be used to add or remove a row of grid areas for the functional area, and a framing operation may be used to add or remove a rectangular frame of grid areas for the functional area.

Step 35: displaying the functional area in the region management page base on the area range, to control at least one of the functional area and the intelligent device in the target space corresponding to the functional area.

Firstly, it should be noted that the region management page may display the functional area based on the area range set for the functional area in the previous steps. Optionally, since the functional area corresponds to a smart device, and the functional area belongs to the target space, the smart device in the target space may be controlled based on the functional area.

Through the above process, gesture operations may be used to more flexibly determine the area range for the functional area. This not only allows for more efficient setting of the area range but also ensures a more precise area range. On the other hand, using automation services based on the functional area for device control, the precise area range of the functional area helps to prevent the smart device from performing incorrect actions, making the device control more precise and more in line with user expectations, thereby enhancing user experience.

In one possible implementation, detecting a gesture operation on the editable area and determining the area range defined by the gesture operation comprises performing at least one of the following sets of operations:
in response to detecting a gesture operation on the editable area is detected, determining a touch point of the gesture operation in the editable area and determining whether the touch point has moved within the editable area; in response to a determination that the touch point has not moved, determining that the gesture operation is a first gesture operation; and determining the area range based on the touch point of the first gesture operation in the editable area;
in response to detecting the touch point has moved within the editable area, determining a movement direction of the touch point within the editable area; detecting the movement direction is a first direction, determining that the gesture operation is a second gesture operation;
and determining the area range based on the touch point of the second gesture operation in the editable area;
in response to detecting the touch point has moved within the editable area, determining a movement direction of the touch point within the editable area; detecting the movement direction is a second direction, determining that the gesture operation is a third gesture operation; and determining the area range based on the touch point of the third gesture operation in the editable area;
in response to detecting a gesture operation on the editable area is detected, and detecting the number of touch points of the gesture operation in the editable area is greater than a predetermined threshold, determining whether the multiple touch points have moved relatively within the editable area; in response, determining that the gesture operation is a fourth gesture operation; and determining the area range based on the touch points of the fourth gesture operation in the editable area.

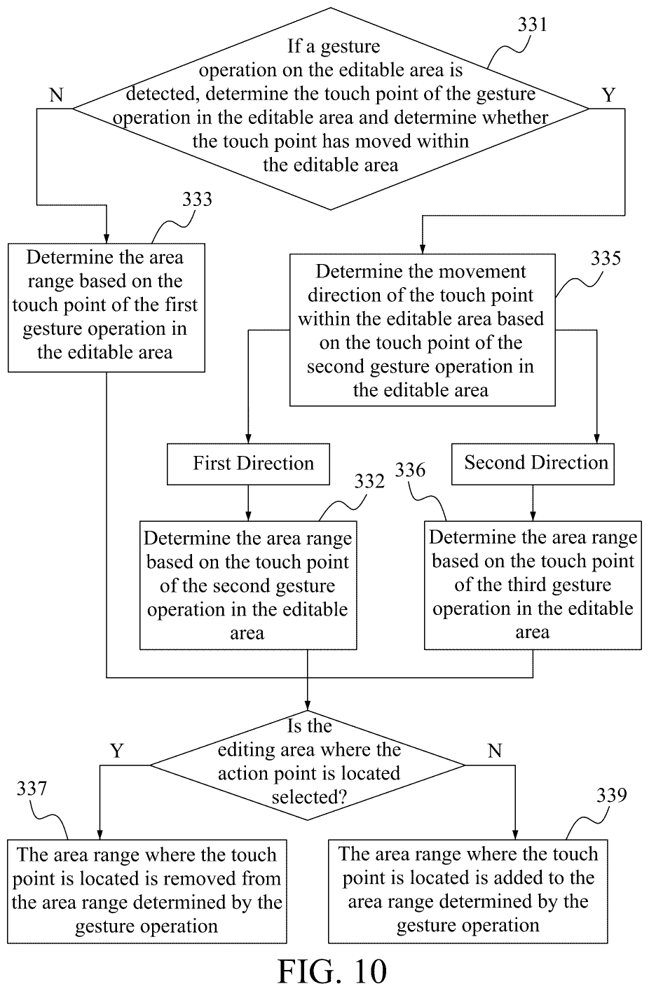

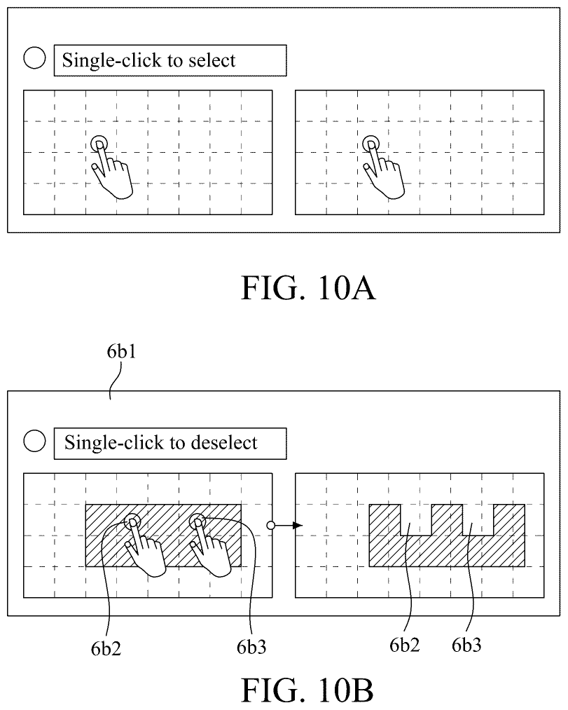

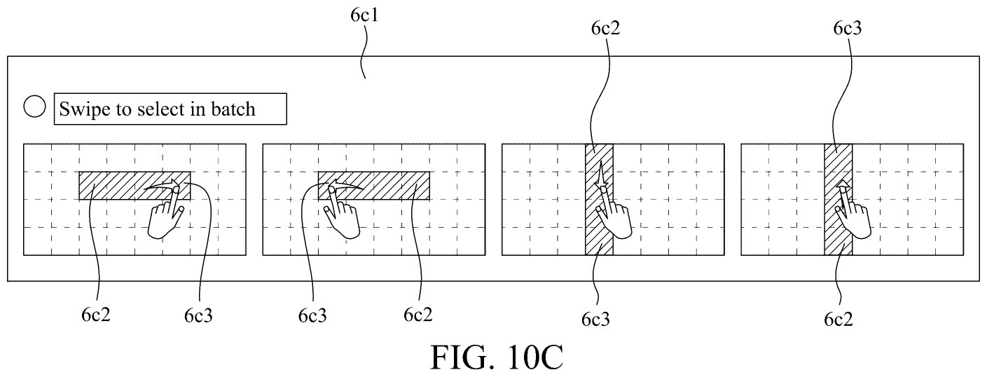

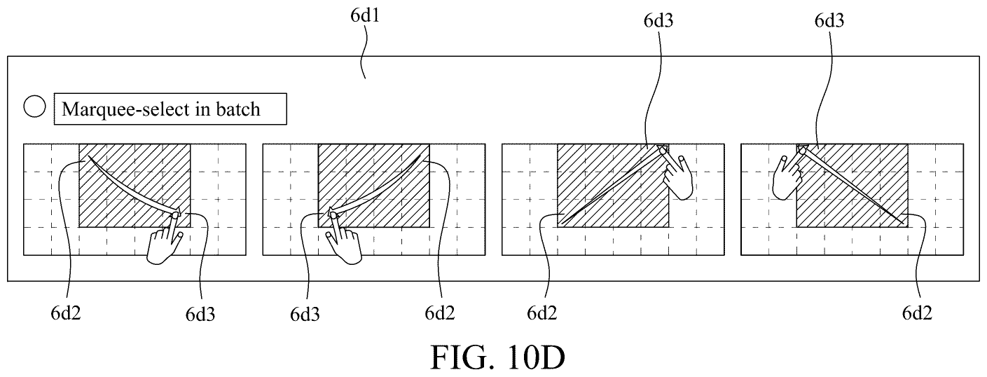

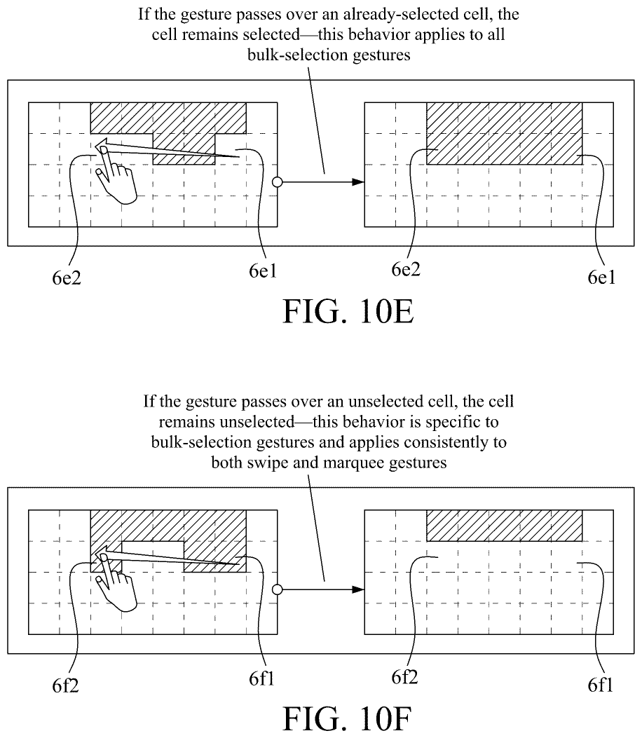

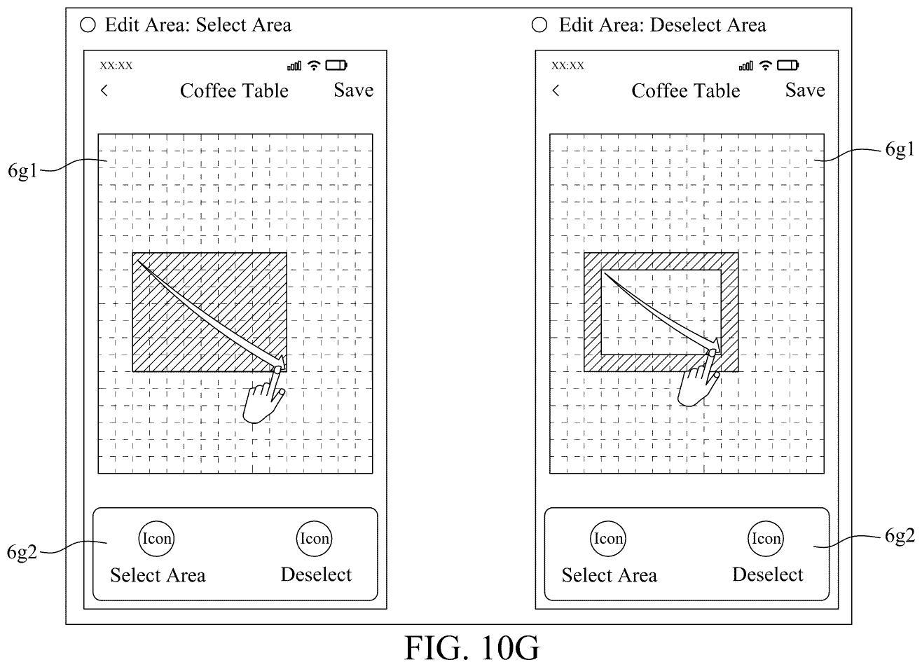

Please refer to FIG. 10. In the embodiments of the present disclosure, a possible implementation is provided, in which step 33 may include the following steps:

Step 331: If a gesture operation on the editable area is detected, determine the touch point of the gesture operation in the editable area and determine whether the touch point has moved within the editable area.

It should be noted that the touch point is configured to indicate the contact point between the gesture operation and the editable area. In a possible implementation, when a user performs a gesture operation on the editable area through the screen of a touch-enabled user terminal, the contact point between the user's gesture operation and the user terminal screen is the touch point.

The number of touch points is related to the gesture operation. For example, in response to detecting a user performs a gesture operation on the user terminal screen with one finger, the number of touch points is 1. In response to detecting the user performs a gesture operation on the user terminal screen with two fingers, the number of touch points is 2.

Regarding the determination of the touch point, it may be determined when the gesture operation interacts with the editable area. For example, the touch point is determined when the user's finger touches the terminal screen. Alternatively, it may be confirmed after the gesture operation has interacted with the editable area for a certain period of time. For example, the touch point is confirmed when the user's finger long-presses the user terminal screen for a preset time. This is not specifically limited here.

Regarding the movement of the touch point, for example, in response to detecting the user's finger touches the terminal screen and then slides on the screen, the touch point will move within the editable area accordingly. In response to detecting the user's finger does not slide on the terminal screen after touching it, the touch point does not move within the editable area.

Based on this, in response to detecting the touch point does not move within the editable area, then the gesture operation is determined to be a first gesture operation, and step 333 is executed: Determine the area range based on the touch point of the first gesture operation in the editable area.

The first gesture operation is configured to confirm the area range of a touch point within the editable area. It may be understood that, using the first gesture operation, a user may add or remove the area range of a touch point for the functional area.

For example, FIG. 10A illustrates a schematic diagram of a first gesture operation. As shown in FIG. 10A, there are multiple selectable grids in the editable area. When a user clicks on one of the grids and releases, the electronic device detects a first gesture operation at the grid and, in response to the first gesture operation, adds the grid to the area range of the functional area.

For another example, FIG. 10B illustrates another schematic diagram of a first gesture operation. As shown in FIG. 10B, there are multiple selected grids in the editable area 6al. When the user clicks on grids 6b2 and 6b3 respectively, the electronic device detects a first gesture operation at grids 6b2 and 6b3 respectively and, in response to the first gesture operation, removes grids 6b2 and 6b3 from the area range of the functional area.

It should be noted that the rectangular grids shown in the above examples are only for illustrative purposes. The shape of the grids may also be hexagonal, star-shaped, triangular, etc., without specific limitation.

in response to detecting the touch point moves within the editable area, then the gesture operation is determined to be a second gesture operation, and step 335 is executed: Determine the movement direction of the touch point within the editable area based on the touch point of the second gesture operation in the editable area.

It may be understood that the movement direction of the touch point within the editable area is related to the movement direction of the second gesture operation. For example, in response to detecting a user's finger clicks on the user terminal screen and then moves horizontally to the right on the screen, the movement direction of the touch point within the editable area is horizontally to the right.

Optionally, the movement direction of the touch point within the editable area may be either the first direction or the second direction. Specifically, the first direction may be the direction where the X and Y axes of the coordinate system with the touch point as the origin coincide, or the angle between them is less than a certain range. The second direction may be the direction where the X and Y axes of the coordinate system with the touch point as the origin form an angle, or the angle between them is greater than a certain range. This range may be 5°, 10°, 15°, etc., without specific limitation.

It should be understood that different movement directions of the touch point may have different effects on the area range of the functional area. In response to detecting the movement direction is the first direction, the gesture operation is determined to be a second gesture operation. In response to detecting the movement direction is the second direction, step 332 is executed: Determine the area range based on the touch point of the second gesture operation in the editable area.

The second gesture operation is configured to confirm the area range within the movement trajectory of the touch point in the editable area.

For example, FIG. 10C illustrates a schematic diagram of a second gesture operation. As shown in FIG. 10C, there are multiple selectable grids in the editable area 6c1. When a user clicks on one of the grids 6c2 and slides to grid 6c3 and releases, the electronic device detects a second gesture operation from grid 6c2 to grid 6c3 and, in response to the second gesture operation, adds grids 6c2 to 6c3 to the area range of the functional area.

In response to detecting the movement direction is the second direction, step 336 is executed: Determine the area range based on the touch point of the third gesture operation in the editable area.

The third gesture operation is configured to confirm the area range within the rectangular frame with the movement trajectory of the touch point as the diagonal in the editable area.

For example, FIG. 10D illustrates a schematic diagram of a third gesture operation. As shown in FIG. 10D, there are multiple selectable grids in the editable area 6d1. When a user clicks on one of the grids 6d2 and slides diagonally to grid 6d3 and releases, the electronic device detects a third gesture operation from grid 6d2 to grid 6d3 and, in response to the third gesture operation, adds all the grids within the rectangular frame 6d4 with 6d2 to 6d3 as the diagonal to the area range of the functional area.

It should be noted that in response to detecting the area range consists of several grids and the touch point of the gesture operation is on a grid within the area range, in a possible implementation, if all the grids on the movement trajectory of the touch point in the editable area are in the same row or column, then the movement direction of the touch point in the editable area is the first direction. In response to detecting there is any grid on the movement trajectory that is not in the same row or column, then the movement direction is the second direction.

Regarding the area range where the touch point is located, this area range may be added to the area range of the functional area or removed from the area range of the functional area, depending on the state of the editable area where the touch point is located. In response to detecting the editable area where the touch point is located has been selected, step 337 is executed, and the area range where the touch point is located is removed from the area range determined by the gesture operation. In response to detecting the editable area where the touch point is located has not been selected, step 339 is executed, and the area range where the touch point is located is added to the area range determined by the gesture operation.

For example, FIG. 10E illustrates a schematic diagram of adding an area range. As shown in FIG. 10E, there are multiple grids in the editable area. When a user clicks on grid 6e1 and slides to grid 6e2, the electronic device detects a second gesture operation from grid 6e1 to grid 6e2. Since 6e1 is not selected, in response to the second gesture operation, all the grids on the movement trajectory from grid 6e1 to grid 6e2 are added to the area range of the functional area.

For another example, FIG. 10F illustrates a schematic diagram of removing an area range. As shown in FIG. 10F, there are multiple grids in the editable area. When a user clicks on grid 6f1 and slides to grid 6f2, the electronic device detects a second gesture operation from grid 6f1 to grid 6f2. Since 6f1 is already selected, in response to the second gesture operation, all the grids on the movement trajectory from grid 6f1 to grid 6f2 are removed from the area range of the functional area.

It should be noted that not only may the state of the editable area where the touch point is located be used to determine whether to add or remove the area range, but also, in a possible implementation, as shown in FIG. 10G, FIG. 10G displays an editable area 6g1 and a functional area 6g2, where 6g2 includes an add entry 6g3 and a remove entry 6g4. When the add entry 6g3 is clicked, the electronic device detects an add operation. In response to detecting a user selects an area range using a gesture operation, the selected area range is added to the area range of the functional area. When the remove entry 6g4 is clicked, the electronic device detects a remove operation. In response to detecting a user selects an area range using a gesture operation, the selected area range is removed from the area range of the functional area.

In summary, by using various gesture operations to obtain the determined area range, the functional area may be displayed in the region management page according to this area range.

Through the above process, users may use the first gesture operation to add or remove the area range of a single grid for the functional area, and use the second or third gesture operation to batch add or remove the area range of multiple grids for the functional area. This allows users to more freely set the area range for the functional area, with higher efficiency.

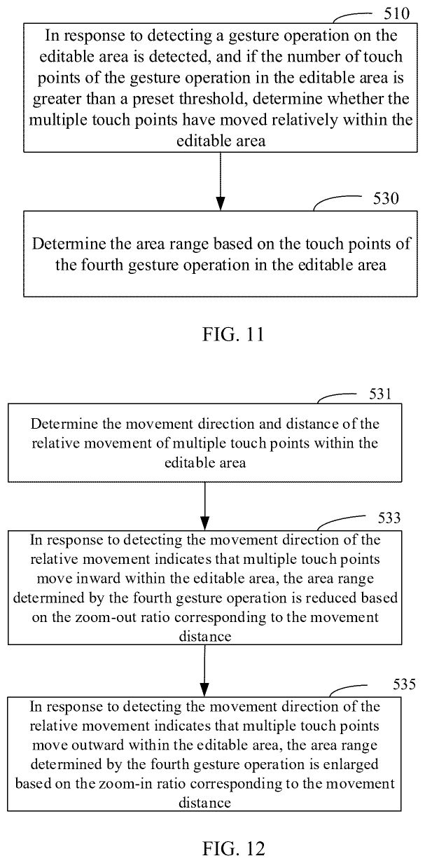

Further explanation is that, as mentioned above, the editable area in the region management page is composed of several grids. In response to detecting the grids are too small, it may cause users to fail to accurately select the desired grids when performing gesture operations. In response to detecting the grids are too large, the region management page may not be able to display the entire editable area, which may cause users to fail to select all the desired grids at once when performing gesture operations. Based on this, in a possible implementation, as shown in FIG. 11, step 33 may also include the following steps:

Step 510: In response to detecting a gesture operation on the editable area is detected, and in response to detecting the number of touch points of the gesture operation in the editable area is greater than a preset threshold, determine whether the multiple touch points have moved relatively within the editable area.

It should be noted that the number of touch points is related to the gesture operation, and thus the setting of the preset threshold is also related to the gesture operation.

In a possible implementation, in response to detecting the touch point in the editable area has been selected, the area range where the touch point is located is removed from the area range determined by the gesture operation. In response to detecting the touch point in the editable area has not been selected, the area range where the touch point is located is added to the area range determined by the gesture operation.

The touch points of the first gesture operation, the second gesture operation, and the third gesture operation are all for adding or removing the area range of the functional area, and the number of touch points for these gesture operations is 1. Therefore, to distinguish different functional gesture operations, the preset threshold may be set as “the number of touch points is not 1” or “the number of touch points is 2”, etc., without limitation.

As mentioned above, as the gesture operation moves on the user terminal, the touch point will also move within the editable area. However, since the number of touch points is greater than the preset threshold, there may be two types of movement for multiple touch points within the editable area: relative movement and movement in the same direction. Optionally, based on these two different types of movement, two different gesture operations may be set to achieve different functions.

Specifically, in response to detecting multiple touch points have moved relatively within the editable area, the gesture operation is determined to be a fourth gesture operation, and step 530 is executed: Determine the area range based on the touch points of the fourth gesture operation in the editable area.

The fourth gesture operation is configured to scale the determined area range. Optionally, since there may be two types of relative movement, one is moving relatively inward and the other is moving relatively outward, these two different types of relative movement may be used to achieve the functions of zooming in and zooming out, respectively.

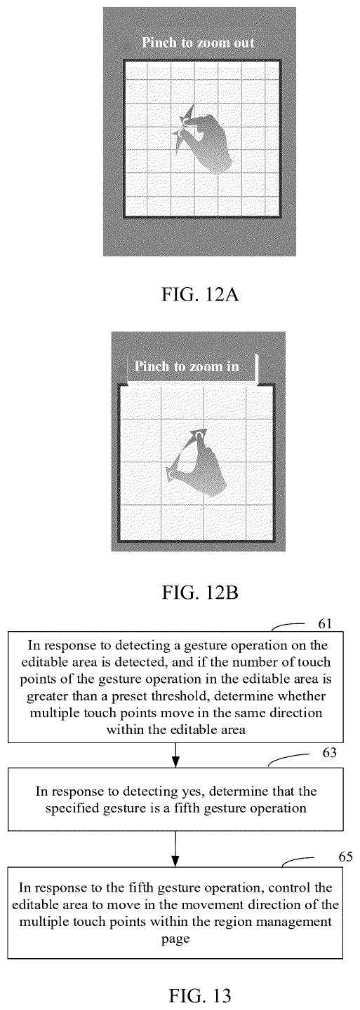

In a possible implementation, as shown in FIG. 12, step 530 may further include the following steps:

Step 531: Determine the movement direction and distance of the relative movement of multiple touch points within the editable area.

It should be noted that in response to detecting the relative movement direction is inward, the fourth gesture operation achieves the zoom-out function. In response to detecting the relative movement direction is outward, the fourth gesture operation achieves the zoom-in function.

The movement distance of the relative movement is related to the scaling ratio. In a possible implementation, the greater the movement distance outward, the larger the zoom-in ratio; the shorter the movement distance outward, the larger the zoom-out ratio.

Step 533: In response to detecting the movement direction of the relative movement indicates that multiple touch points move inward within the editable area, the area range determined by the fourth gesture operation is reduced based on the zoom-out ratio corresponding to the movement distance.

For example, FIG. 12A illustrates a schematic diagram of a fourth gesture operation. As shown in FIG. 12A, when a user's two fingers pinch inward on the user terminal screen, the electronic device detects the fourth gesture operation and, in response to the fourth gesture operation, reduces the area range determined by the fourth gesture operation.

Step 535: In response to detecting the movement direction of the relative movement indicates that multiple touch points move outward within the editable area, the area range determined by the fourth gesture operation is enlarged based on the zoom-in ratio corresponding to the movement distance.

For example, FIG. 12B illustrates a schematic diagram of a fourth gesture operation. As shown in FIG. 12B, when a user's two fingers spread outward on the user terminal screen, the electronic device detects the fourth gesture operation and, in response to the fourth gesture operation, enlarges the area range determined by the fourth gesture operation.

It should be noted that in response to detecting the region management page cannot display all the editable areas, it may cause users to fail to select all the desired grids when performing gesture operations. Therefore, the editable area may be moved to enable users to view and select grids in other areas.

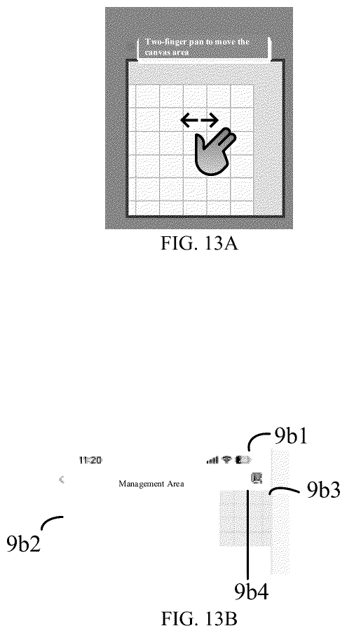

In a possible implementation, as shown in FIG. 13, moving the editable area may include the following steps:

Step 61: In response to detecting a gesture operation on the editable area is detected, and in response to detecting the number of touch points of the gesture operation in the editable area is greater than a preset threshold, determine whether multiple touch points move in the same direction within the editable area.

Step 63: In response to detecting yes, determine that the specified gesture is a fifth gesture operation.

Step 65: In response to the fifth gesture operation, control the editable area to move in the movement direction of the multiple touch points within the region management page.

The fifth gesture operation is configured to control the movement of the editable area within the region management page.

For example, FIG. 13A illustrates a schematic diagram of a fifth gesture operation. As shown in FIG. 13A, when a user's two fingers move in the same direction on the user terminal screen, the electronic device detects the fifth gesture operation and controls the editable area to move in the movement direction of the two fingers within the region management page.

It should be noted that when controlling the editable area to move within the region management page, in response to detecting the set area range is moved outside the editable area, it may be difficult to move it back into the editable area. For example, in response to detecting the target space is large, the editable range of the editable area is also large. After moving the editable area, it may be difficult to locate the position before the movement.

Based on this, in a possible implementation, in response to detecting the editable area is moved to a preset limit range in the region management page, the movement of the editable area is stopped.

The preset limit range is configured to indicate that the editable area stops moving in the movement direction of the multiple touch points. It may be the boundary of the entire set area range. For example, if the set area range is a 6×6 grid, the preset limit range is also a 6×6 grid. In this case, when the editable area is moved to the boundary of the 6×6 grid in the region management page, that is, when the editable area continues to move and cannot display the 6×6 grid, the movement stops. Alternatively, it may be the boundary of a part of the set area range. For example, in response to detecting the set area range is a 6×6 grid and the preset limit range is a 4×4 grid, when the editable area is moved to the boundary of any 4×4 grid within the 6×6 grid in the region management page, that is, when the editable area continues to move and cannot display the 4×4 grid, the movement stops.

For example, FIG. 13B illustrates a schematic diagram of the movement of the editable area in the region management page. As shown in FIG. 13B, the region management page 9b1 displays the editable area 9b2, which shows the set area range 9b3-a 4×4 grid. In response to detecting the preset limit range is a 4×4 grid, then the editable area 9b2 cannot move to the left in the region management page because it would exceed the preset limit range. In response to detecting the preset limit range is a 2×2 grid, when the editable area 9b2 moves to the left in the region management page and reaches the preset limit range 9b4, further movement to the left would exceed the preset limit range 9b4. Therefore, the editable area 9b2 stops moving at the preset limit range 9b4.

Combining the above embodiments, on the one hand, by zooming in, zooming out, and moving the displayed area range, users may more smoothly set the desired area range for the functional area. On the other hand, users may use various gesture operations to add or remove any area range for the functional area individually or in batches, which allows them to set the area range for the functional area more efficiently and freely. As a result, the functional area generated for the smart device is more precise and practical. Using this functional area for device control enhances the user's smart home experience.

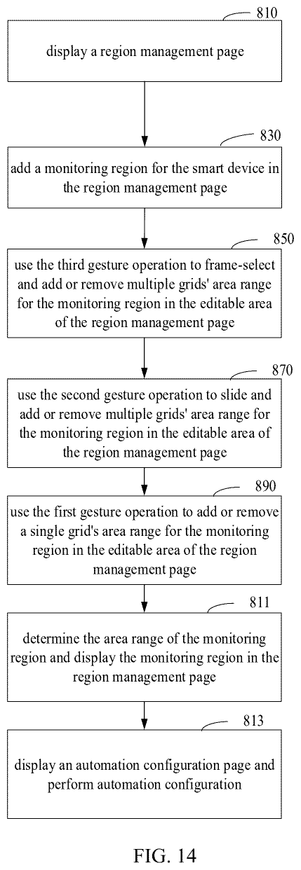

FIG. 14 is a specific implementation diagram of a region setting method in an application scenario. This application scenario is applicable to the user terminal 110 in the implementation environment of FIG. 1.

Through step 810, display a region management page.

Through step 830, add a monitoring region for the smart device in the region management page.

For example, the smart device may be a human sensor.

Through step 850, use the third gesture operation to frame-select and add or remove multiple grids' area range for the monitoring region in the editable area of the region management page.

Through step 870, use the second gesture operation to slide and add or remove multiple grids' area range for the monitoring region in the editable area of the region management page.

Through step 890, use the first gesture operation to add or remove a single grid's area range for the monitoring region in the editable area of the region management page.

Through step 811, determine the area range of the monitoring region and display the monitoring region in the region management page.

As shown in FIG. 14A, FIG. 14A shows the area 14al, or the light-colored grid area, which is the area range set for the monitoring region in this application scenario.

Through step 813, display an automation configuration page and perform automation configuration, using “someone detected in the monitoring region” as the trigger condition and “push alarm notification” as the execution action, to complete the automation configuration.

In this application scenario, on the one hand, by using various gesture operations to draw the desired area range, the overall operation is not only efficient and smooth but also allows for quick drawing of irregular and complex area ranges to meet different needs, achieving high expandability, high efficiency, and high personalization in setting the area range. On the other hand, by setting different functional areas for the target space, the smart device may perform different processing for different functional areas, making device control more precise.

In summary, in the above technical solution, on the one hand, using gesture operations may more flexibly determine the area range for the functional area, which not only allows for more efficient setting of the area range but also ensures a more precise area range. On the other hand, using automation services based on the functional area for device control, the more precise area range helps to prevent the smart device from performing incorrect actions, making the device control more precise and more in line with user expectations, thereby enhancing user experience.

In the current area setting process, the overall area view displays multiple regions with fixed ranges. For example, the overall area view displays bedrooms, living rooms, studies, etc., in a smart home scenario. Based on these displayed regions, users first determine the area that needs to be set, then enter the area list to select the specific area that needs to be set, and finally enter the corresponding setting page of the specific area to set it. The above process has at least the following problems: The display effect of the regions in the overall area view is not intuitive, resulting in inconvenient area settings. Moreover, as the number and complexity of the regions that need to be set increase, users need to repeatedly check the area list and the overall area view, making the area setting efficiency increasingly low. This is not conducive to users configuring corresponding automation schemes for smart devices in different areas.

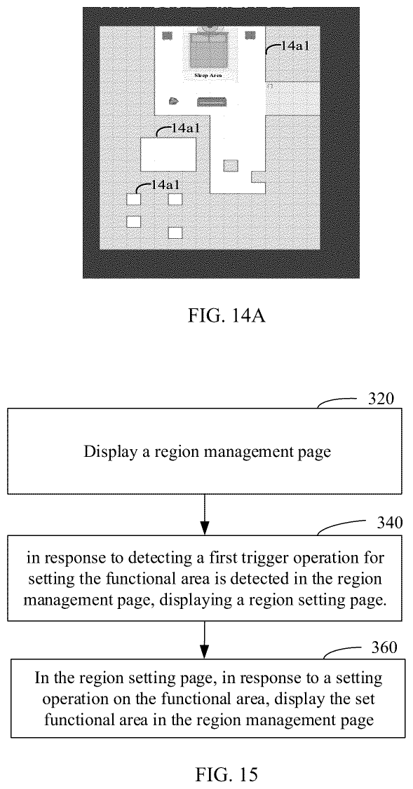

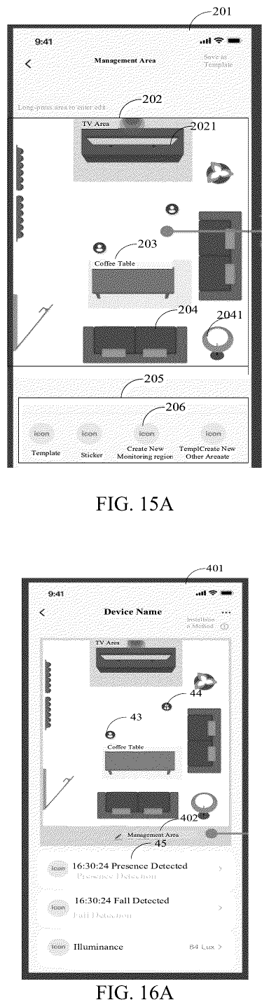

Please refer to FIG. 15. The device control method in the embodiments of the present disclosure may also include the following steps:

Step 320: Display a region management page.

The region management page is configured to display at least one functional area set for the target space. It enables users to directly view multiple functional areas under the target space through the region management page, facilitating refined control of smart devices in the target space.

FIG. 15A illustrates a schematic diagram of the region management page in an embodiment. As shown in FIG. 15A, taking the living room as the target space, the region management page 201 displays the functional areas set for the living room, including the television functional area 202, the coffee table functional area 203, the sofa functional area 204, etc. Based on this, continuing with the human sensor as an example, in response to detecting the television functional area 202 detects a person, the television 2021 in the living room may be turned on. In response to detecting the sofa functional area 204 detects a person, the floor lamp 2041 in the living room may be turned on. However, whether it is the television functional area 202 or the sofa functional area 204 that detects a person, for the detection range of the human sensor, it is considered that a person is detected. But when the television functional area 202 detects a person, the floor lamp 2041 in the living room will not be turned on simply because a person is detected within the detection range. This achieves refined control of smart devices in the target space.

It should be noted that the functional areas in the region management page are represented by graphic markers. For example, in FIG. 15A, the coffee table functional area 203 is marked with a coffee table graphic. Of course, in other embodiments, the graphic marker may also be any other shape. This embodiment does not specifically limit this. In other words, the functional areas displayed in the region management page are essentially graphic markers that have a mapping relationship with the actual functional areas in the target space.

It should be noted that the region management page here includes the region editing page described in the above embodiments.

In a possible implementation, the monitoring page is also used to display at least one of the following: the position of the monitored target in the target space and the status of the functional area. In FIG. 16A, the positions of the monitored targets in the target space are marked as 43 and 44, and the status of the functional area is marked as 45. It should be noted that FIG. 16A only exemplarily shows two monitored targets at positions 43 and 44 in the target space and the status 45 of one functional area. This embodiment does not limit the number of monitored targets and functional areas that may be displayed on the monitoring page.

The monitored target refers to an object that may move within the target space, such as a person, robot, pet, etc. It may be understood that as the monitored target moves within the target space, the position of the monitored target detected by the smart device in the target space will change accordingly. Correspondingly, the position of the monitored target displayed on the monitoring page will also change accordingly. This allows users to adjust the display area range of the functional area in the region management page in a timely manner based on the changing position of the monitored target in the target space, thereby correspondingly adjusting the area occupied by the functional area in the target space. The status of each functional area reflects the relationship between the functional area and the monitored target. For example, the relationship may be that there is a monitored target in each functional area, or the monitored target is away from each functional area. This is not specifically limited here, which is conducive to achieving refined control of smart devices in the target space based on the status of each functional area.

The status of each functional area and the position of the monitored target in the target space are monitored by the smart device and reported to the server to which the smart device is connected. The server then pushes this information to the user terminal for display.

It should be noted that the specific form of the above operations will vary depending on the input components configured in the electronic device (such as a mouse, keyboard, display screen). For example, in response to detecting the electronic device is a smartphone, based on the display screen configured in the smartphone, the above operations may be gesture operations such as clicking and sliding. in response to detecting the electronic device is a desktop computer, based on the mouse configured in the desktop computer, the above operations may be mechanical operations such as single-clicking, double-clicking, and dragging. This is not specifically limited here.

With the display of the region management page on the electronic device, users may achieve refined device control based on the functional areas displayed in the region management page.

Step 340: in response to detecting a first trigger operation for setting the functional area is detected in the region management page, displaying a region setting page.

As mentioned earlier, the fixed range of the target space may easily lead to inaccurate device control of the smart devices within the target space. To address this, this embodiment provides a region setting page for setting at least one functional area for the target space. The functional area may refer to the functional area previously displayed in the region management page or a newly created functional area.

The display method of the region setting page may be either covering the region management page or floating within the region management page. Covering display specifically means canceling the display of the region management page and adding the display of the region setting page. Floating display specifically means displaying each functional area and the region setting page in different display areas within the region management page. For example, each functional area is displayed in the upper display area of the region management page, while the region setting page is displayed in the lower display area of the region management page. It should be understood that under the floating display method, the region setting page does not affect the editing of the functional areas displayed in the region management page, such as moving, zooming in, or zooming out the functional areas in the region management page. It should be noted that the region setting page here may be understood as a region setting page that may edit the functional areas.

For setting the displayed functional area, the first trigger operation is a first selection operation for selecting the functional area previously displayed in the region management page. In a possible implementation, step 340 may include the following steps: In response to the first selection operation triggered in the region management page, determining the selected functional area in the region management page; displaying a region editing page corresponding to the selected functional area. The region editing page displays the area information of the selected functional area, and the region editing page is a region setting page for editing the selected functional area.

In one possible implementation, the area information of the functional area includes but is not limited to: the name of the functional area, the type of the functional area, the attribute of the functional area, the detection sensitivity of the functional area, and the background color of the functional area when displayed on the region management page. The attribute is configured to indicate the function of the functional area, including but not limited to: a monitoring region for implementing an automated configuration scheme, an edge area for reducing tracking interference of the monitoring target, an interference source for ignoring movement within the functional area, and the entrance and exit of the functional area. The type is configured to indicate the function of the functional area, for example, the type may be a dining area, a rest area, an entertainment area, a reception area, etc. The detection sensitivity is related to the size/complexity of the target space/functional area, for example, for target spaces such as bedrooms, studies, small offices, etc., where the space content is relatively simple and there are not many interference sources, high detection sensitivity may be used; for target spaces such as bathrooms, small meeting rooms, etc., where the space content is of moderate complexity and the interference sources are also moderate, medium detection sensitivity may be used; for target spaces that are larger in area and have plants, curtains, etc., the space content is more complex and there are more interference sources that may affect the area status monitoring of the functional area, so low detection sensitivity may be used.

In one possible implementation, a region setting page corresponding to the selected functional area is displayed, including: in separate display areas of the region management page, respectively displaying each functional area and the region editing page corresponding to the selected functional area.

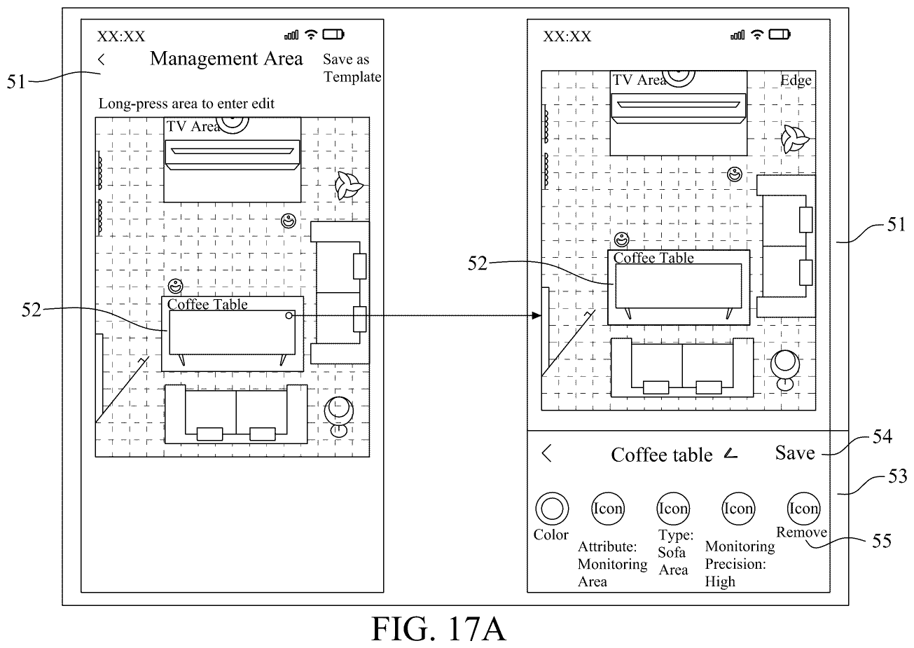

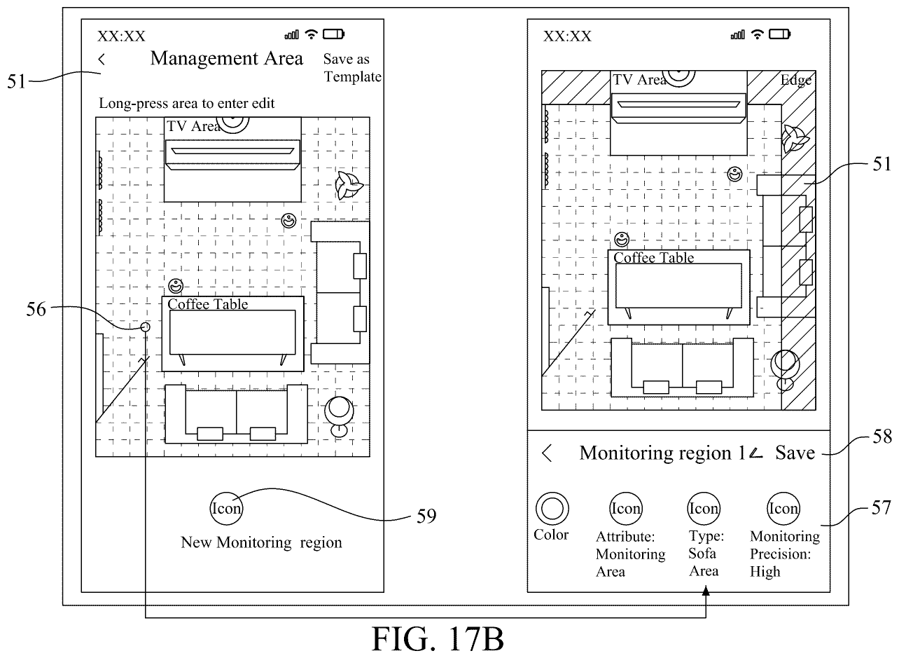

FIG. 17A illustrates a schematic diagram of the region editing page floating on the region management page. As shown in FIG. 17A, in the region management page 51, at least the coffee table functional area 52 is displayed. Suppose a user wishes to set up this coffee table functional area 52. They may long press on the coffee table functional area 52. For the electronic device, it may detect this long press operation and then float the region editing page 53 corresponding to the coffee table functional area 52 on the region management page 51. Here, the long press operation is considered as the first selection operation on the functional area in the region management page 51, and the coffee table functional area 52 is the selected functional area.

In the region editing page 53, the area information of the coffee table functional area 52 is displayed, for example, the area information includes name, background color, attribute, type, detection sensitivity, and a save entry 54 is also displayed. Thus, the user may edit the area information of the coffee table functional area 52 through the region editing page 53, and then, in response to a trigger operation on the save entry 54, the coffee table functional area 52, after setting is completed, may be updated and displayed in the region management page 51.

Additionally, as shown in FIG. 17A, the region editing page 53 also displays a delete entry 55. By responding to a trigger operation on the delete entry 55, the coffee table functional area 52 may be deleted from the region management page 51. This embodiment does not constitute a specific limitation on this.

For setting up a new functional area, the first trigger operation is a new-area operation for creating a new functional area. In one possible implementation, step 340 may also include the following steps: in response to a new-area operation triggered in the region management page, display a new-area page. The new-area page displays the area information of the new functional area and is configured to edit the area settings of the new functional area.

In one possible implementation, the new-area operation includes any of the following: an operation on a blank display area in the region management page; or an operation on a new-area entry in the region management page. The blank display area refers to a display area that does not display a functional area.

FIG. 17B illustrates a schematic diagram of the new-area page floating on the region management page. As shown in FIG. 17B, in the region management page 51, there is at least a blank display area 56. In response to detecting a user wants to create a new functional area in the blank display area 56, they may long press the blank display area 56. For the electronic device, it may detect this long-press operation and then float the new-area page 57 on the region management page 51. This long-press operation is considered an operation on the blank display area in the region management page 51.

Continuing to refer to FIG. 17B, the region management page 51 also displays a new-area entry 59. In response to detecting a user wants to set up a new functional area for the target space, they may click the new-area entry 59. For the electronic device, it may detect this click operation and then float the new-area page 57 on the region management page 51. This click operation is considered an operation on the new-area entry in the region management page 51.

In the new-area page 57, the area information of the new functional area is displayed. For example, the area information includes name, background color, attribute, type, detection sensitivity, and a save entry 58 is also displayed. Thus, the user may edit the area information of the new functional area through the new-area page 57. Then, by responding to a trigger operation on the save entry 58, the newly set functional area may be displayed in the blank display area 56 of the region management page 51. It should be noted that the area information of the new functional area will be assigned default values to improve the efficiency of area settings.

In this process, through the area setting page, users may edit the area information of displayed or newly created functional areas to complete the settings of functional areas. In addition, as the area setting page floats on the region management page, the region management page may switch between the area display state and the area editing state. This allows users to view and edit functional areas on the same page, achieving an “what-you-see-is-what-you-get” interaction effect. It avoids users repeatedly flipping through the area list and the overall area view, thereby improving the efficiency of area settings and enhancing the user experience.

Step 360: In the region setting page, in response to a setting operation on the functional area, display the set functional area in the region management page.

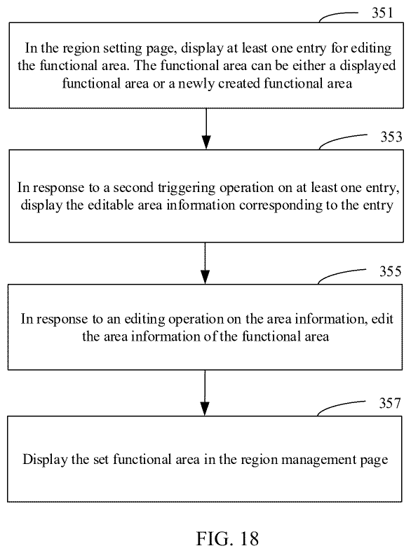

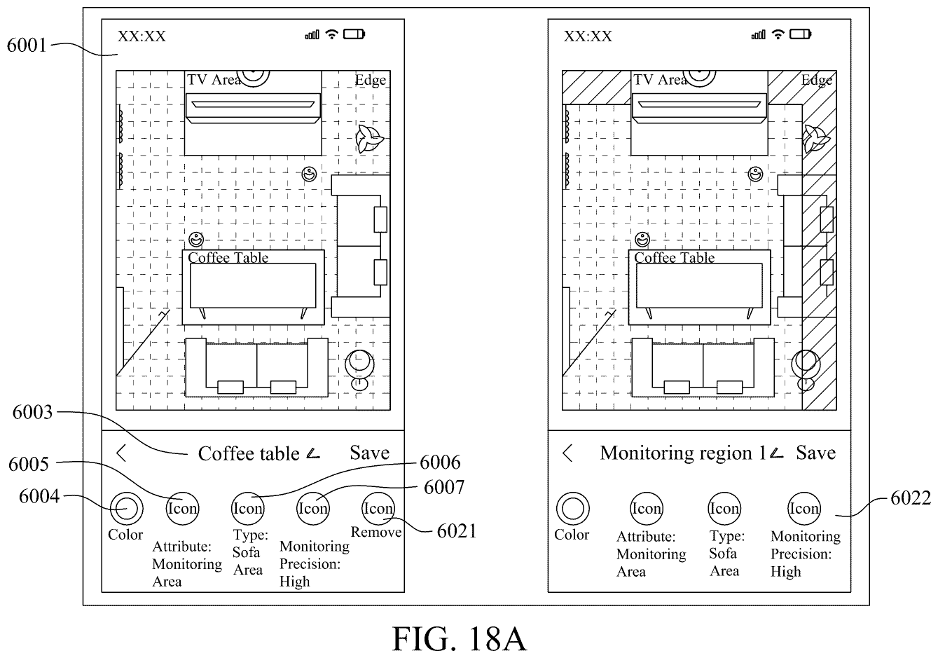

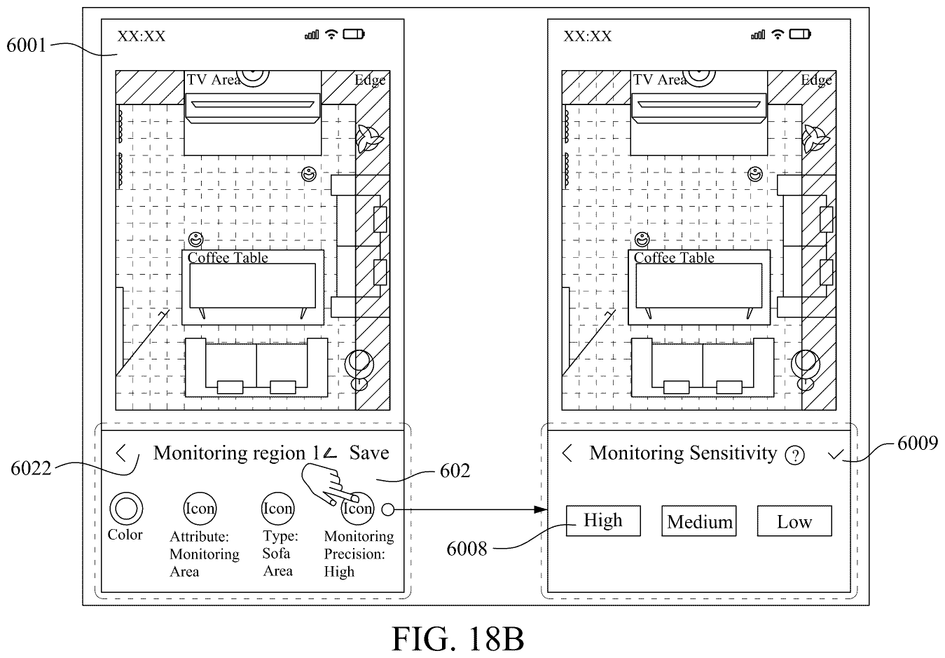

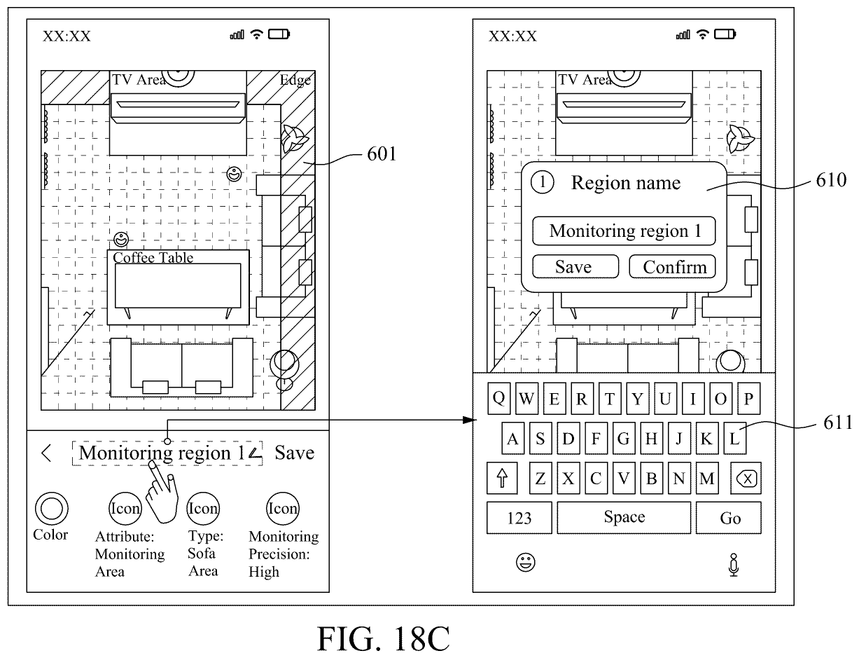

As shown in FIG. 18, in one possible implementation, step 360 may include the following steps:

Step 351: In the region setting page, display at least one entry for editing the functional area. The functional area may be either a displayed functional area or a newly created functional area.

As shown in FIG. 18, whether it is the region setting page 6021 for setting up a displayed functional area or the region setting page 6022 for setting up a newly created functional area, after the region setting page is displayed in the region management page, the page displays multiple entries for editing the functional area. These entries include a name editing entry 6003, a color editing entry 6004, an attribute editing entry 6005, a type editing entry 6006, and a detection sensitivity editing entry 6007.

Step 353: In response to a second trigger operation on at least one entry, display the editable area information corresponding to the entry.

Through the multiple entries shown in FIG. 18A, it is possible to detect a trigger operation on any entry and then display the editable area information corresponding to that entry.

The display method for the editable area information corresponding to the entry may be overlay display, floating display, or pop-up display. No specific limitation is imposed here.

FIG. 18B illustrates a schematic diagram of the display method for the editable area information corresponding to the detection sensitivity editing entry in one embodiment. As shown in FIG. 18B, in response to detecting a user wants to edit the detection sensitivity of the functional area, they may click the detection sensitivity editing entry. For the electronic device, it may detect this click operation and then, in the region setting page 6022, cancel the display of the multiple entries and add the display of the editable area information corresponding to the detection sensitivity editing entry at the original display position of the multiple entries. The editable area information includes high, medium, and low. Here, the click operation is considered as the second trigger operation on the detection sensitivity editing entry.

Step 355: In response to an editing operation on the area information, edit the area information of the functional area.

As mentioned above, the area information of the functional area includes but is not limited to: name, type, attribute, background color, detection sensitivity, etc. Accordingly, in one possible implementation, the editing operation may include at least one of the following: an operation for editing the name of the functional area, an operation for editing the type of the functional area, an operation for editing the background color of the functional area when displayed on the region management page, an operation for editing the attribute of the functional area, and an operation for editing the detection sensitivity of the functional area.

Continuing to refer to FIG. 18B, the user selects the editable area information 6008, namely “high,” and clicks on the “V” to complete the editing of the detection sensitivity of the functional area. The selection operation may be regarded as an editing operation on the area information.

Alternatively, as shown in FIG. 18C, the user clicks on “monitoring region” to cancel the display of the multiple entries and to add the display of the editable area information corresponding to the name editing entry. This includes the input dialog box 610 that pops up on the region management page 601 and the keyboard page 611. Thus, the user may enter the name “monitoring region 1” for the functional area in the input dialog box 610 through the keyboard page 611 and click “OK” to complete the editing of the functional area's name. The input operation is considered an editing operation on the area information.

It is worth mentioning that through the floating display method, the display area located at the top of the region management page may display each functional area, while the display area located at the bottom may sequentially display the multiple entries and the editable area information corresponding to the entries. The different display areas do not affect each other, achieving an intuitive and convenient interaction form, which is conducive to improving the efficiency of area settings.

Step 357: Display the set functional area in the region management page.

For displayed functional areas, the set functional area is updated and displayed in the region management page; or, for newly created functional areas, the set functional area is displayed in the blank display area of the region management page.

Referring back to FIG. 15A, after the user completes the editing of the area information of the functional area, that is, after the setting of the functional area is completed, the electronic device may display the set functional area in the region management page. In FIG. 15A, the region management page 201 displays the TV functional area 202, the coffee table functional area 203, and the sofa functional area 204. This means that, based on the region setting page, the user has configured at least three functional areas for the target space. Based on this, the functional areas displayed in the region management page are applied in the case of intelligent settings, and the intelligent device will monitor the area status of each functional area and report the area status of each functional area to the service end to which the intelligent device is connected. For example, the service end may be the gateway 150 or the server end 170 shown in the implementation environment in FIG. 1.

Correspondingly, after receiving the area status of each functional area reported by the intelligent device, the service end may determine whether to perform refined device control on the intelligent devices in the target space based on the area status of each functional area monitored by the intelligent device.

Through the above process, the interaction form is changed. Users only need to use the region management page to set any number of functional areas for the target space with a fixed range and may intuitively view these functional areas. There is no need to repeatedly flip through the area list and the overall area view, which may effectively solve the problem of inconvenient area settings caused by the unintuitive display of areas in the related technology.

In addition, through the change of the interaction form, all the area display information and area editing information related to area settings are presented on the same page without the need for page scrolling. This not only has good scalability but also effectively improves the utilization rate of the page.

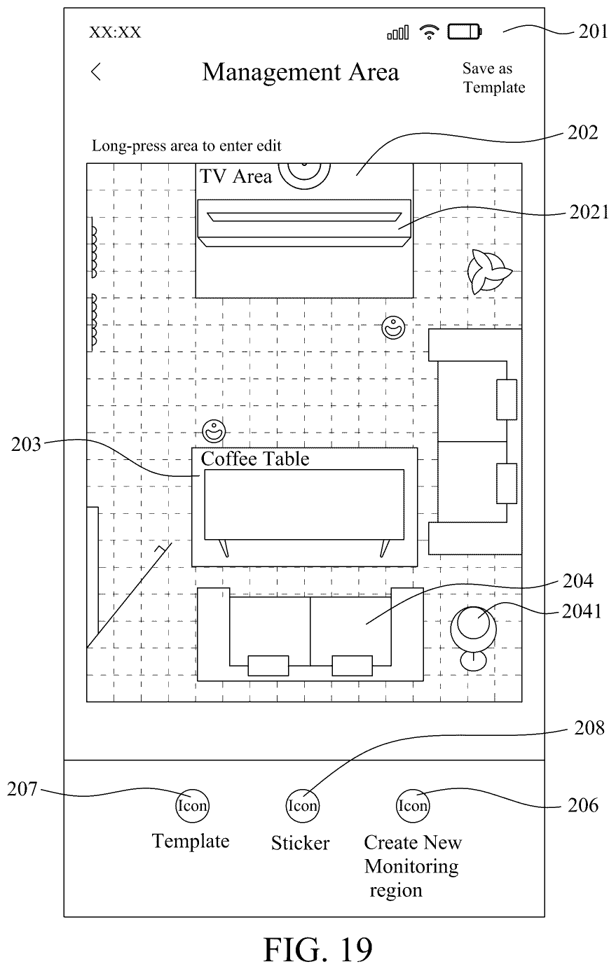

FIG. 19 illustrates a schematic diagram of the region management page in another embodiment. As shown in FIG. 19A, the region management page 201 also displays a template recommendation entry 207 and a region recommendation entry 208. The template recommendation entry is configured to recommend intelligent space templates to users, and these templates include at least one functional area that is compatible with the target space. The region recommendation entry is configured to recommend functional areas that may be set up in the target space.

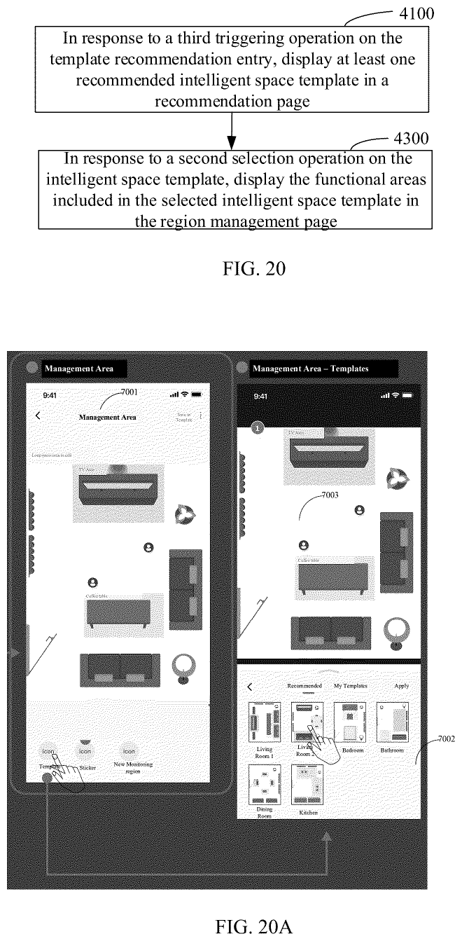

Referring to FIG. 20, in an exemplary embodiment, before step 320, the method may also include the following steps:

Step 4100: In response to a third trigger operation on the template recommendation entry, display at least one recommended intelligent space template in a recommendation page.

The display method for the recommendation page may be overlay display or floating display, without any specific limitation here. For example, overlay display means canceling the display of the region management page and adding the display of the recommendation page. Floating display means that the recommendation page is shown as a floating window on the region management page.

Step 4300: In response to a second selection operation on the intelligent space template, display the functional areas included in the selected intelligent space template in the region management page.

As shown in FIG. 20A, in the region management page 7001, when the user clicks on the “Template” template recommendation entry, the recommendation page 7002 is displayed in the region management page 7001. Specifically, the upper display area of the region management page 7001 is configured to display the functional areas set for the target space, while the lower display area is configured to show the recommendation page 702. Here, the click operation is considered as a trigger operation on the template recommendation entry.

In the recommendation page 7002, multiple intelligent space templates are displayed, such as Living Room 1, Living Room 2, etc. The user may click on Living Room 2 to display the functional areas included in Living Room 2 in the upper display area 7003 of the region management page. Here, the click operation is considered as a selection operation on the intelligent space template.

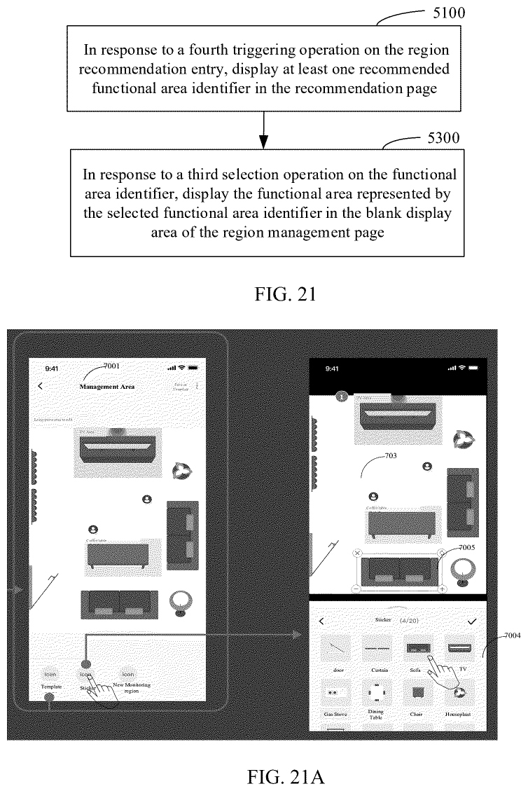

Referring to FIG. 21, in an exemplary embodiment, before step 320, the method may also include the following steps:

Step 5100: In response to a fourth trigger operation on the region recommendation entry, display at least one recommended functional area identifier in the recommendation page.

The functional area identifier is configured to represent a functional area.

Step 5300: In response to a third selection operation on the functional area identifier, display the functional area represented by the selected functional area identifier in the blank display area of the region management page.

As shown in FIG. 21A, in the region management page 7001, when the user clicks on the “Sticker” region recommendation entry, the recommendation page 7004 is displayed in the region management page 7001. Specifically, the upper display area of the region management page 7001 is configured to display the functional areas set for the target space, while the lower display area is configured to show the recommendation page 7004. Here, the click operation is considered as a trigger operation on the region recommendation entry.

In the recommendation page 7004, multiple functional area identifiers representing different functional areas are displayed. For example, the door identifier represents the door functional area, and the sofa identifier represents the sofa functional area. The user may click on the sofa identifier to display the sofa functional area 7005 represented by the sofa identifier in the upper display area 7003 of the region management page. Here, the click operation is considered as a selection operation on the functional area identifier.

With the cooperation of the above-mentioned embodiments, recommendations based on templates and functional area identifiers are realized. Users may apply templates/functional area identifiers with a single click. For example, based on templates, users may quickly apply the template that best matches the spatial layout of the target space. Alternatively, based on functional area identifiers, users may quickly select functional areas to better simulate a spatial layout that is most similar to that of the target space. This effectively reduces the workload for users in setting up areas and greatly enhances the user experience.

In addition, through the hierarchical setting between the region management page and the recommendation page, an intuitive and convenient interaction form is realized. This avoids the need to repeatedly flip through the area list and the overall configuration view, making it convenient for users to set up areas. It helps to reduce user operation costs and improve the efficiency of area settings.

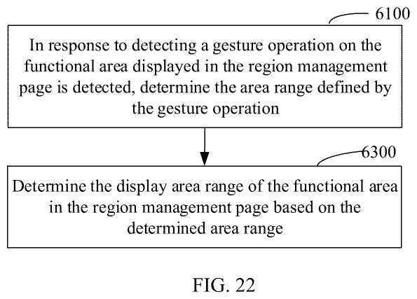

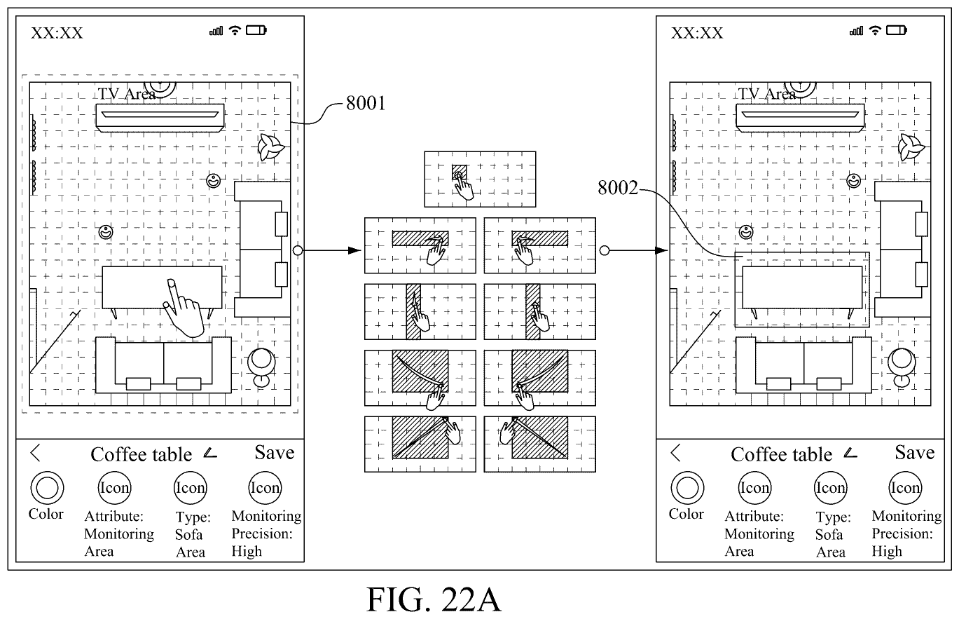

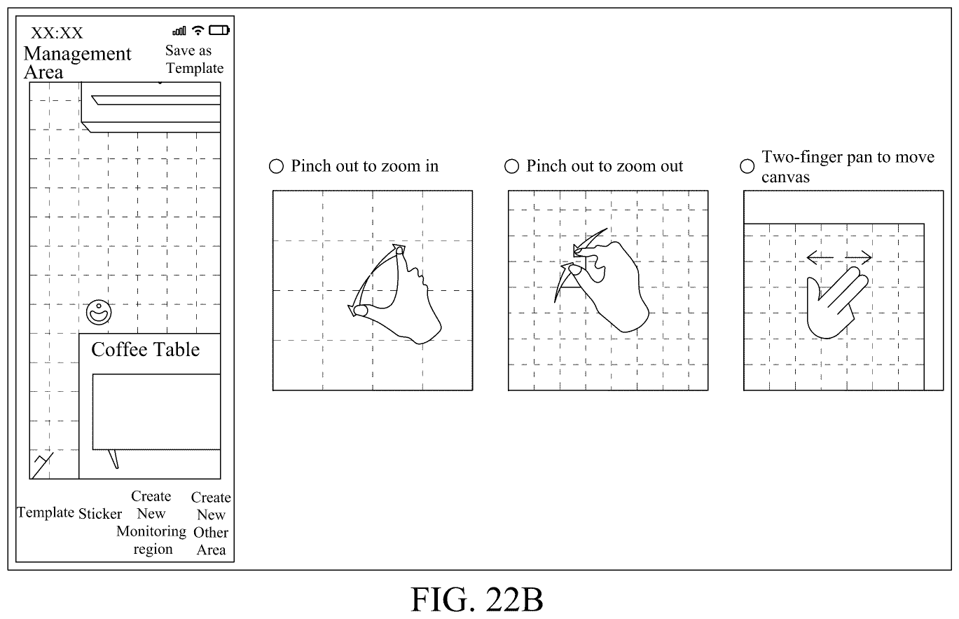

Referring to FIG. 22, in an exemplary embodiment, after step 320, the method further includes the following steps:

Step 6100: In response to detecting a gesture operation on the functional area displayed in the region management page is detected, determine the area range defined by the gesture operation.

To more accurately implement device control, this embodiment provides gesture operations to define the display area range of the functional area in the region management page. The gesture operations include but are not limited to: single-click operation, single-finger swipe operation, single-finger frame selection operation, two-finger zoom-in operation, two-finger zoom-out operation, two-finger move operation, etc. No specific limitation is imposed here.

Step 6300: Determine the display area range of the functional area in the region management page based on the determined area range.

FIG. 22A illustrates a schematic diagram of different gesture operations defining the area range. As shown in FIG. 22A, in the region management page 8001, users may define the area range 8002 through different gesture operations. The area range 8002 is represented by grids in the region management page 8001. For example, a single-click operation may be used to select/deselect a grid, a single-finger swipe operation, may be used to select/deselect multiple grids along the swipe direction, and a single-finger frame selection operation may be used to batch-select/deselect multiple grids. It should be noted that, for grids that are not selected, based on the above-mentioned gesture operations, the unselected grids may be added to the area range. For grids that have been selected, based on the above-mentioned gesture operations, the selected grids are removed from the area range, that is, the selection of the grid is canceled.

FIG. 22B illustrates a schematic diagram of different gesture operations editing the display area range. As shown in FIG. 22B, users may use different gesture operations to zoom or move the display area range of the functional area in the region management page. For example, in response to detecting the display area range of the functional area in the region management page is too small, a two-finger zoom-in operation may be used to enlarge the display area range. Optionally, in response to detecting the enlarged display area range exceeds the display range of the screen configured by the electronic device, a two-finger move operation may be used to move the display area range that needs to be displayed into the display range. In response to detecting the display area range of the functional area in the region management page is too large, a two-finger zoom-out operation may be used to reduce the display area range.

Under the effect of the above-mentioned embodiments, on the one hand, a fast and intuitive way to determine the area range is realized. On the other hand, without page scrolling, the display area range that users need may be displayed on the same page. This not only has good scalability and may be applied to electronic devices of any screen size, but also effectively improves the utilization rate of the page.

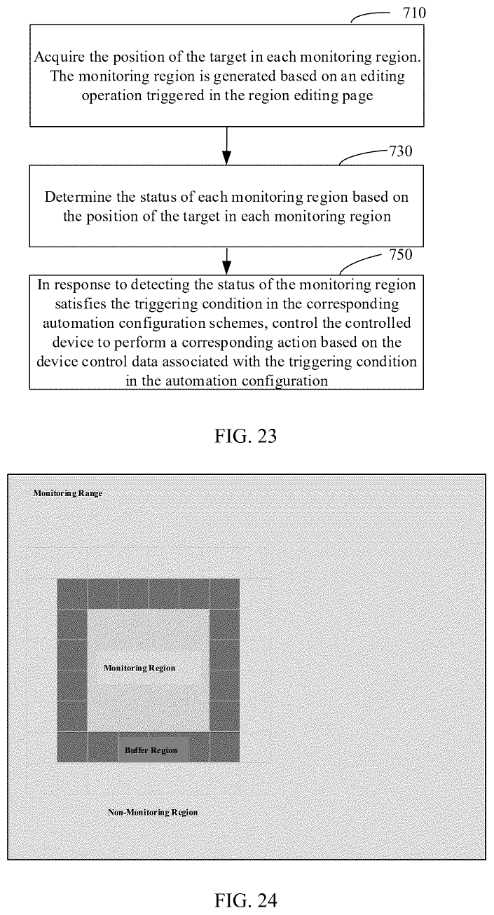

Referring to FIG. 23, the present disclosure provides a device control method that is applicable to an electronic device. The electronic device may be a sensing device, specifically the intelligent device 130 shown in the implementation environment in FIG. 1. For example, the intelligent device 130 may be a radar device, a human body sensor, or other electronic devices. The electronic device may also be the gateway 150 or the server end 170 shown in the implementation environment in FIG. 1. In the following method embodiments, for the sake of convenient description, the method steps are described with the electronic device as the executing subject. However, this does not constitute a specific limitation. As shown in FIG. 24, the method may include the following steps:

Step 710: Acquire the position of the target in each monitoring region. The monitoring region is generated based on an editing operation triggered in the region editing page.

The region editing page is configured to configure at least one monitoring region within the detection range of the sensing device according to the current position of the target.

Step 730: Determine the status of each monitoring region based on the position of the target in each monitoring region.

That is to say, the status of each monitoring region reflects the positional relationship between the target and the monitoring region, the sensing device, and the detection range at different times.

Step 750: In response to detecting the status of the monitoring region satisfies the trigger condition in the corresponding automation configuration schemes, control the controlled device to perform a corresponding action based on the device control data associated with the trigger condition in the automation configuration.

In the above process, the status of each monitoring region detected by the sensing device is reported to the connected service end. On the one hand, the service end may be the gateway 150 shown in the implementation environment in FIG. 1, and then the gateway notifies the controlled devices in each monitoring region to perform corresponding actions through the local area network path. On the other hand, the service end may be the server end 170 shown in the implementation environment in FIG. 1, and then the server end notifies the controlled devices in each monitoring region to perform corresponding actions through the wide area network path. It may be understood that the detection results and area automation control may be completed inside the sensing device. Therefore, even in the case of network disconnection, as long as the local area network is not disconnected, it may be executed through the local area network, which greatly improves the stability of area monitoring and area automation execution.

In other words, when the target enters different monitoring regions within the detection range of the sensing device, the electronic device may achieve refined device control for different monitoring regions.

Step 731: For each monitoring region, determining the positional relationship between the target and the monitoring region at different times based on the position of the target in the monitoring region.

Step 733: Determining the status of the monitoring region based on the positional relationship between the target and the monitoring region over time.

The status of the monitoring region essentially reflects the positional relationship between the target and at least one of the monitoring region, the sensing device, and the detection range.

In one possible implementation, the monitoring method used by the sensing device to monitor the status of each monitoring region includes at least one of the following: directional monitoring and non-directional monitoring. Directional monitoring refers to monitoring targets in the up-down direction/left-right direction within each monitoring region/detection range. Non-directional monitoring refers to monitoring all targets within each monitoring region/detection range. Then, step 733 may include the following steps: in response to detecting the sensing device has directional monitoring capability, determining a direction in which the target enters the monitoring region based on the positional relationship over time, and determining the status based on the direction and the positional relationship; determining the status of the monitoring region based on the determined direction and positional relationship.

In one possible implementation, the monitoring method used by the sensing device to monitor the status of each monitoring region includes at least one of the following: target mobility monitoring and target presence monitoring. Target mobility monitoring refers to monitoring whether there are targets entering/approaching/leaving/moving away from each monitoring region/detection range. Target presence monitoring refers to monitoring whether there are targets in each monitoring region/detection range.

In one possible implementation, the status of the monitoring region may include at least one of the following: the target entering the detection range of the sensing device, the target leaving the detection range of the sensing device, the target entering the monitoring region, the target leaving the monitoring region, the target approaching the monitoring region, the target moving away from the monitoring region, the target approaching the sensing device, the target moving away from the sensing device, the presence of targets in the detection range, the absence of targets in the detection range, the presence of targets in the monitoring region, and the absence of targets in the monitoring region. It should be noted that the target approaching the sensing device may be considered a special case of the target approaching the monitoring region. In this special case, the target is approaching the monitoring region where the sensing device is located. Similarly, the target moving away from the sensing device may be considered a special case of the target moving away from the monitoring region, that is, the target is moving away from the monitoring region where the sensing device is located.

In one possible implementation, in combination with directional detection, the status of the monitoring region may also include at least one of the following: the target entering the detection range of the sensing device from the left/right side, the target leaving the detection range of the sensing device from the left/right side, the target entering the monitoring region from the left/right side, the target leaving the monitoring region from the left/right side, the target entering the detection range of the sensing device from the top/bottom side, the target leaving the detection range of the sensing device from the top/bottom side, the target entering the monitoring region from the top/bottom side, and the target leaving the monitoring region from the top/bottom side.

It should be noted that the target entering the monitoring region is different from the target approaching the monitoring region. FIG. 24 illustrates a schematic diagram of different areas within the detection range of the sensing device. In FIG. 24, the detection range of the sensing device includes at least one monitoring region, and a buffer area is set at the boundary of the monitoring region to isolate the monitoring region from the non-monitoring region through this buffer area. It should be noted that the non-monitoring region is only relative to the monitoring region but still within the detection range of the sensing device.

Based on this, when the target enters the buffer area, it is only considered that the target is approaching the monitoring region. However, when the target leaves the buffer area and enters the monitoring region, it may then be considered that the target has entered the monitoring region. Similarly, the electronic device uses the buffer area between the monitoring region and the non-monitoring region to distinguish between the target leaving the monitoring region and the target moving away from the monitoring region. In this way, it avoids the situation where the sensing device, when locating the target at the boundary of the monitoring region, causes the target to jump back and forth between the monitoring and non-monitoring regions due to noise. This effectively improves the accuracy of the area status of each monitoring region detected by the sensing device. It also avoids incorrect device control caused by repeated changes in the area status of the monitoring region, thereby further improving the accuracy of device control.

Therefore, step 733 may include the following steps: Based on the positional relationship between the target and the monitoring region at different times, in response to detecting the positional relationship indicates that the target is currently located in the buffer area, determine whether the target was approaching the non-monitoring region in the previous moment. The buffer area is located between the monitoring region and the non-monitoring region. If not, determine that the status of the monitoring region is that the target is approaching the monitoring region.

It should be noted that the difference between entering the monitoring region and the presence of a target in the monitoring region lies in the different monitoring methods. That is, entering the monitoring region belongs to target mobility monitoring, while the presence of a target in the monitoring region belongs to target presence monitoring. In other words, the two may be considered the same area status.

When the monitoring regions displayed in the region editing page of the user terminal are applied to the sensing device, the sensing device will monitor the area status of each monitoring region to obtain the area status of each monitoring region.

It should be added that, on the user terminal side, as shown in FIG. 24, when displaying the monitoring region in the region editing page, the buffer area at the boundary of the monitoring region is also displayed. For example, the buffer area is automatically generated based on the selection of the monitoring region according to a preset expansion distance, such as automatically expanding the distance corresponding to one grid.

Step 751: Determine whether the status of the monitoring region satisfies the trigger condition in the automation configuration schemes.

The automation configuration schemes is configured based on the status of the monitoring region and the actions executed by the controlled devices within the monitoring region. In other words, the automation configuration schemes include a trigger condition and device control data. The trigger condition is configured to confirm whether the status of the monitoring region is satisfied, and the device control data is configured to instruct the controlled devices within the monitoring region to perform corresponding actions.

In response to detecting it is determined that the status of the monitoring region satisfies the trigger condition in the automation configuration schemes, then proceed to step 753.

Conversely, in response to detecting it is determined that the status of the monitoring region does not satisfy the trigger condition in the automation configuration schemes, the electronic device continues to execute step 751 until the status of the monitoring region satisfies the trigger condition in the automation configuration schemes, and then proceeds to step 753 to execute device control.

It should be noted that in this embodiment, the status of each monitoring region detected by the sensing device may be pushed to the user terminal via the connected service end, so that the user terminal may achieve refined device control based on the status of each monitoring region.

Step 753: In response to detecting the status of the monitoring region satisfies the trigger condition in the corresponding automation configuration schemes, control the controlled device to perform a corresponding action based on the device control data associated with the trigger condition in the automation configuration schemes.

With the effect of the above-mentioned embodiments, the area status of each monitoring region under various monitoring methods is monitored, which serves as the trigger basis for device linkage. This enables refined automatic device control and improves user experience. For example, in a smart home scenario, when a user enters the bathroom, the human body sensor deployed in the bathroom works. In response to detecting it detects that someone is in the toilet monitoring region, it may accurately control the toilet to perform the action of opening the toilet seat cover, which greatly facilitates the user's smart home life.

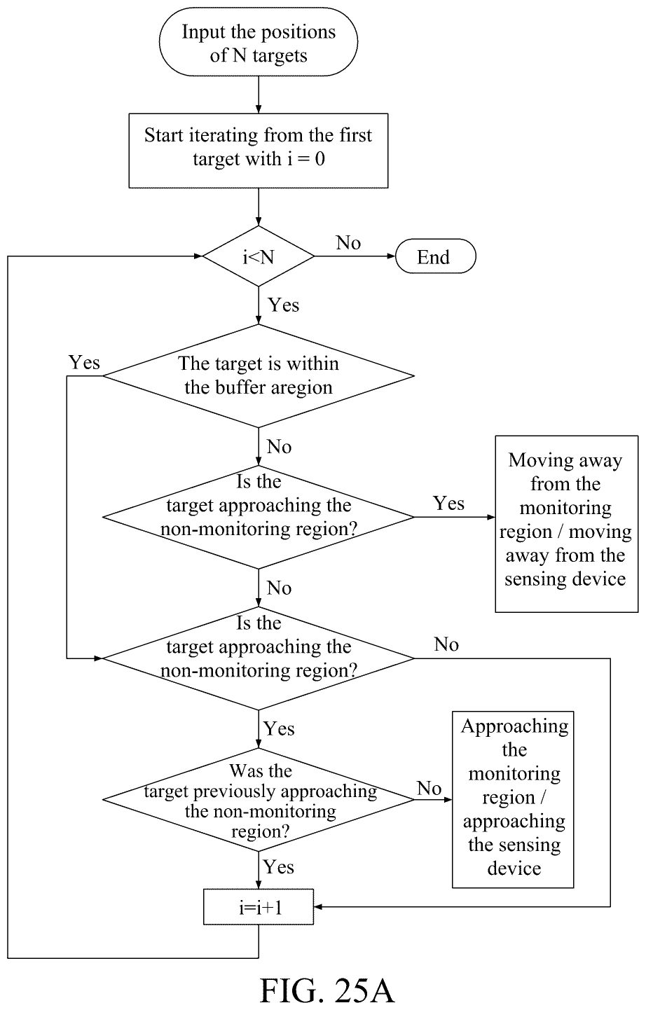

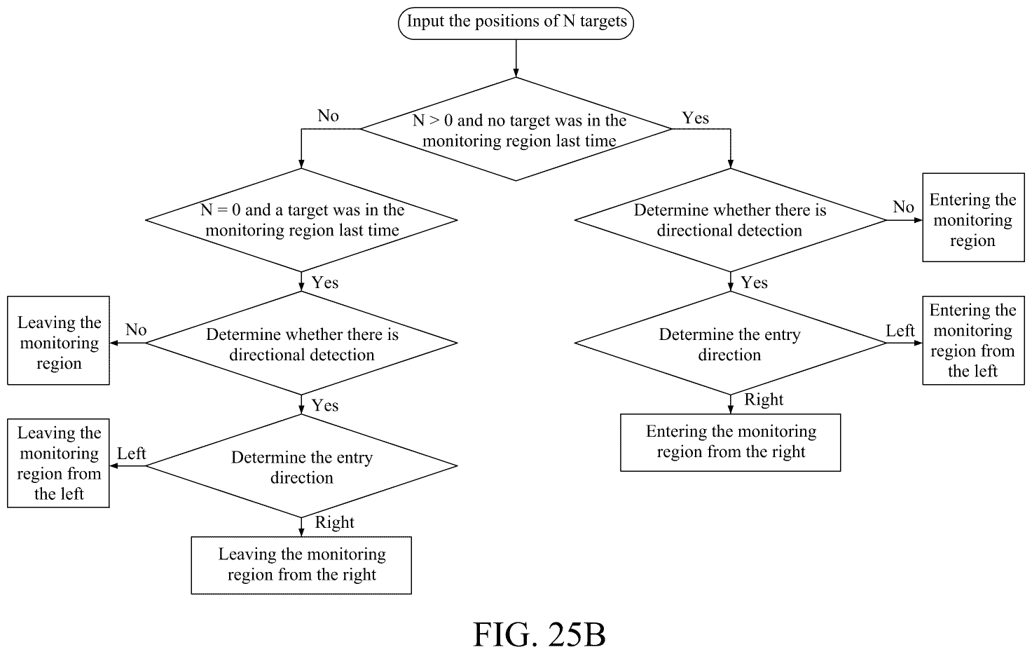

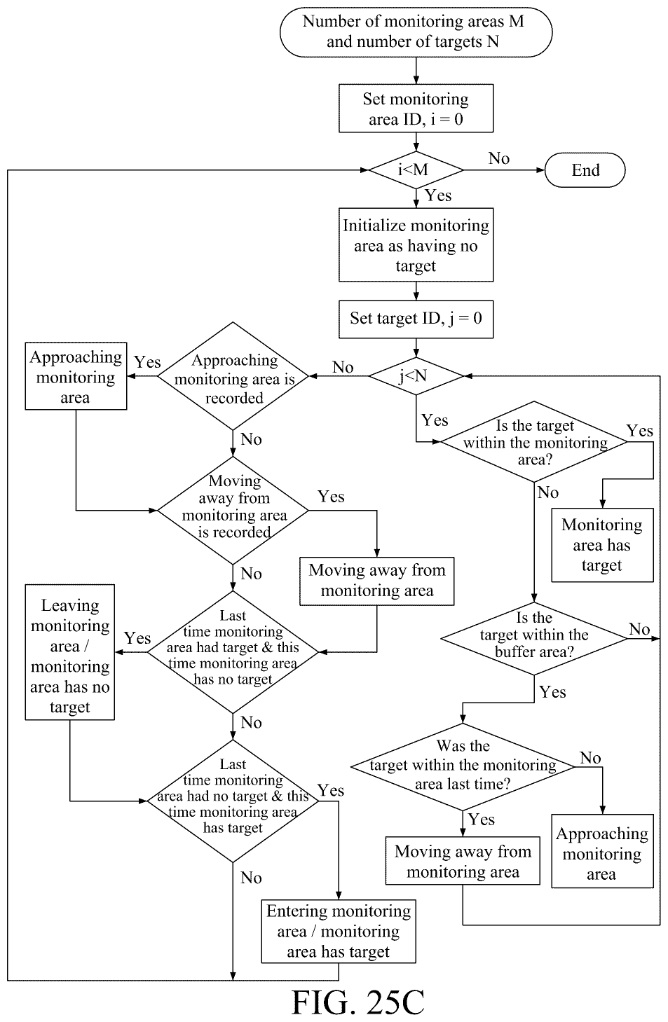

In one embodiment, FIGS. 25A to 25C illustrate the monitoring process of the area status of each monitoring region. FIG. 25A illustrates the monitoring process of the area status of at least one of approaching and moving away from the monitoring region. Based on the monitoring process shown in FIG. 25A, the area status of each monitoring region that may be detected by the sensing device includes the target approaching the monitoring region and the target moving away from the monitoring region.

Specifically, the target may be a human body. The electronic device acquires the coordinate information of N targets within the detection range and iterates through the position of each target. In response to detecting it is identified that the target is outside the buffer area and was previously inside the buffer area, it is considered that the target is moving away from the sensing device. The purpose of setting the buffer area is that there is a certain error in the target coordinates output by radar target detection. Without setting the buffer area, at the boundary of the detection range, it may continuously report that the target is approaching or moving away from the sensing device. In response to detecting the target is within the approaching-away area and the last detection result was not within the approaching-away area, it is determined that the target is approaching the sensing device.

Specifically, referring back to FIG. 25A, input the positions of N targets and start iterating from the first target with i=0. In response to detecting i<N, determine whether the target is within the buffer area. In response to detecting the target is within the buffer area, further determine whether the target is approaching the non-monitoring region. in response to detecting the target is approaching the non-monitoring region, determine whether the target was previously approaching the non-monitoring region. In response to detecting the target was previously approaching the non-monitoring region, set i=i+1. In response to detecting the target was not previously approaching the non-monitoring region, determine that the target is approaching the monitoring region/approaching the sensing device. In response to detecting the target is not within the buffer area, determine whether the target was previously within the buffer area. In response to detecting the target was previously within the buffer area, determine that the target is moving away from the monitoring region/moving away from the sensing device. In response to detecting the target was not previously within the buffer area, determine whether the target is approaching the non-monitoring region.

FIG. 25B illustrates the monitoring process of the area status of at least one of entering and leaving the monitoring region in combination with directional detection. Based on the monitoring process shown in FIG. 25B, the area status of each monitoring region that may be detected by the sensing device includes the target entering the monitoring region, the target leaving the monitoring region, the target entering the monitoring region from the left, the target leaving the monitoring region from the left, the target entering the monitoring region from the right, and the target leaving the monitoring region from the right.

Specifically, referring back to FIG. 25B, input the positions of N targets and determine whether N>0 and whether there was no target in the monitoring region last time. If so, determine whether there is directional detection. In response to detecting there is directional detection, determine the direction. In response to detecting it is to the left, the target enters the monitoring region from the left. In response to detecting it is to the right, the target enters the monitoring region from the right. In response to detecting there is no directional detection, the target enters the monitoring region. In response to detecting there was a target in the monitoring region last time, determine whether N=0 and whether there was a target in the monitoring region last time. In response to detecting, determine whether there is directional detection. In response to detecting there is, determine whether the target is leaving from the left or right. In response to detecting it is to the left, the target leaves the monitoring region from the left. In response to detecting it is to the right, the target leaves the monitoring region from the right. In response to detecting there is no directional detection, the target leaves the monitoring region.

Specifically, taking the target as a human body as an example, the entire monitoring region is judged based on the first person entering and the last person leaving. The steps are as follows:

Determine whether it is the first person entering. The judgment condition is that the last detection result was that there was no one in the area, but this time it is detected that there is someone in the area.

In response to detecting it is the first person entering, determine whether the detection direction is directional or non-directional to output corresponding information. In response to detecting the detection direction is non-directional, the electronic device reports that someone has entered and there is someone in the area.

In response to detecting the detection direction is directional, determine the direction of entry. In response to detecting it is entering from the left, the electronic device sends that it is entering from the left and there is someone in the area. In response to detecting it is entering from the right, it sends that it is entering from the right and there is someone in the area.

Determine whether it is the last person leaving. The judgment condition is that the last detection result was that there was someone in the area, but this time it is detected that there is no one in the area.

In response to detecting it is the last person leaving, determine whether it is directional or non-directional detection and output corresponding information. In response to detecting it is non-directional detection, the electronic device reports that someone has left and there is no one in the area.

In response to detecting it is directional detection, determine the direction of entry. In response to detecting it is leaving from the left, the electronic device sends that it is leaving from the left and there is no one in the area. In response to detecting it is leaving from the right, it reports that it is leaving from the right and there is no one in the area.

FIG. 25C illustrates the monitoring process of the area status of the monitoring region in combination with target mobility monitoring and target presence monitoring. Based on the monitoring process shown in FIG. 25C, the area status of each monitoring region that may be detected by the sensing device includes the presence of a target in the monitoring region, the absence of a target in the monitoring region, the target approaching the monitoring region, the target moving away from the monitoring region, the target entering the monitoring region, and the target leaving the monitoring region.

Specifically, referring back to FIG. 25C, set the number of monitoring regions as M and the number of targets as N. Set the monitoring region ID, i=0. Determine whether i<M. If not, end the process. If so, initialize the monitoring region as having no target. Set the target ID, j=0. Determine whether j<N. If so, determine whether the target is within the monitoring region. If the target is within the monitoring region, the monitoring region is considered to have a target. If the target is not within the monitoring region, determine whether the target is in the buffer area. If the target is in the buffer area, determine whether the target was previously within the monitoring region. If the target was previously within the monitoring region, it is determined that the target is moving away from the monitoring region. If the target was not previously within the monitoring region, it is determined that the target is approaching the monitoring region. If the target is not in the buffer area, it is determined that the target is moving away from the monitoring region. Determine whether j<N. If not, determine whether the approach to the monitoring region has been recorded. If so, the target is approaching the monitoring region. Continue to determine whether the movement away from the monitoring region has been recorded. If not, determine whether the movement away from the monitoring region has been recorded. If so, it is determined that the target is moving away from the monitoring region, and continue to determine whether the previous and current monitoring regions have no target. If not, determine whether the previous monitoring region had a target and the current monitoring region has no target. If so, it is determined that the target has left the monitoring region/the monitoring region has no target. If not, determine whether the previous monitoring region had a target and the current monitoring region has a target. If so, it is determined that the target has entered the monitoring region/the monitoring region has a target. If not, return to the process of determining whether i<M.

Specifically, the area automation judgment is performed for each monitoring region. Each monitoring region is independent and needs to be compared with each target. The judgment logic is as follows:

The electronic device sets the status of monitoring region i to no person.

The electronic device compares monitoring region i with all targets. In response to detecting a target is within the monitoring region, the status of monitoring region i is set to having a person.

The electronic device determines whether the target is within the buffer area.

When the target is within the buffer area and was previously outside monitoring region i, it is determined that someone is approaching monitoring region i.

When the target is within the buffer area and was previously inside monitoring region i, it is determined that someone is moving away from monitoring region i.

The electronic device iterates through all targets.

When someone approaching monitoring region i is recorded, the electronic device sends a signal indicating that someone is approaching monitoring region i.

When someone moving away from monitoring region i is recorded, the electronic device reports that someone is moving away from monitoring region i.

When the previous frame's entire area status was having a person and the current status is no person, the electronic device reports that someone has left monitoring region i and that monitoring region i is now empty.

When the previous frame's entire area status was no person and the current status is having a person, the electronic device reports that someone has entered monitoring region i and that monitoring region i now has a person.

The electronic device iterates through all monitoring regions and outputs the monitoring results.

In this embodiment, by setting the buffer area for approaching and moving away, it prevents the target at the boundary from frequently reporting the presence or absence of a person due to measurement noise from the sensing device. This effectively improves the accuracy of the area status of each monitoring region detected by the sensing device. It also avoids incorrect device control caused by repeated changes in the area status of the monitoring region, thereby further improving the accuracy of device control.

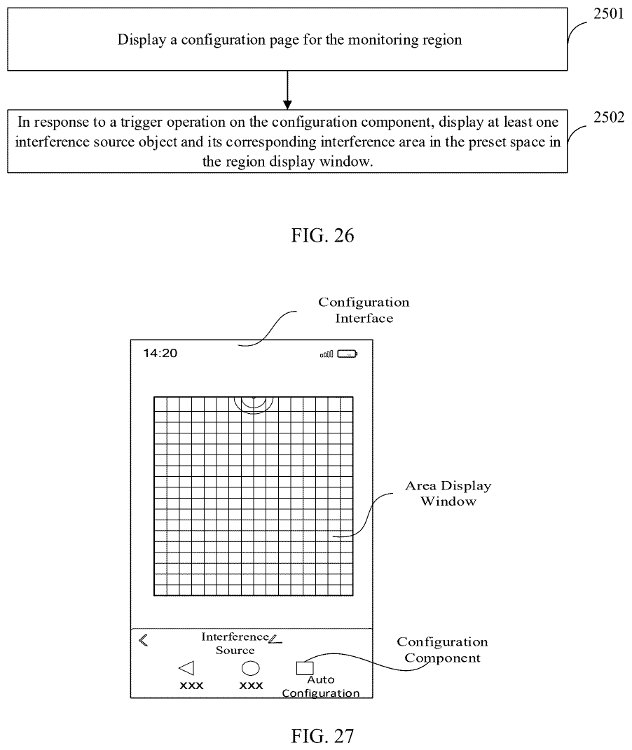

In one possible implementation, the accuracy of the monitoring region as the target detection object cannot be ignored. Referring to FIG. 26, FIG. 26 illustrates a flowchart of an object determination method according to an embodiment of the present disclosure, which may be applied to the user terminal 110 shown in FIG. 1. The object determination method specifically includes the following steps:

Step 2501: Display a configuration page for the monitoring region.

Considering that when detecting real objects in space (such as people or other animals), there are some micro-motion interference objects in the space (such as fans, plants swaying in the wind, or curtains, etc.) that may also be detected as real objects, thereby reducing the accuracy of target detection. Therefore, the present disclosure also provides a method for determining interference objects in space. By automatically configuring the interference objects, the interference areas of the detected interference source objects may be accurately displayed on the configuration interface. It should be noted that the target space includes a preset space. The preset space includes interference objects, corresponding to the interference areas included in the monitoring region.

It should be noted that the region management page includes the configuration page. The configuration interface is different from the automation configuration page. The configuration interface refers to the interface included in the electronic device for automatically configuring interference source objects in space. The configuration interface may include at least a region display window and a configuration component. The configuration component is configured to trigger the determination of interference objects in the preset space. When the interference areas of the interference source objects are determined, the region display window may display the interference areas. For example, the configuration interface may be the region editing page mentioned above.

Referring to FIG. 27, FIG. 27 illustrates an interface diagram of a configuration interface. As shown in FIG. 27, the configuration interface includes a region display window and a configuration component “Auto-Configuration.” It should be noted that in the embodiments of the present disclosure, the region display window, configuration component, and other components are all virtual components (also known as controls) implemented by computer programming technology to perform specific application functions, facilitating human-computer interaction between users and electronic devices and information display.

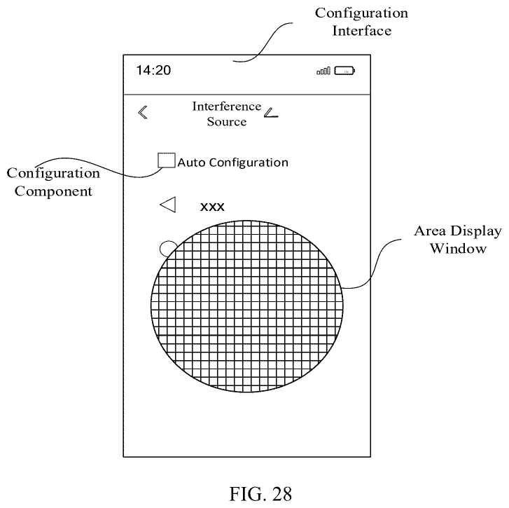

It may be understood that the display form and interaction mode of the virtual component may be personalized according to the specific interaction scenario, without limitation. For example, referring to FIG. 28, FIG. 28 illustrates another interface diagram of a configuration interface. As shown in FIG. 28, the configuration component in the configuration interface may be displayed in a list form with other components, and the region display window may also be displayed on the configuration interface in the form of a circular floating window.

Step 2502: In response to a trigger operation on the configuration component, display at least one interference source object and its corresponding interference area in the preset space in the region display window.

Here, the trigger operation refers to the human-computer interaction operation between the user and the configuration interface when the user needs to determine the interference source objects in the space. The trigger operation may include a single-point or double-point operation by the user's finger on the configuration component, or a single-click or double-click operation by the user using a mouse on the configuration component, without limitation. The preset space refers to the space used to monitor the existence of at least one of interference source objects or real objects, which may be an office place or a residential room, etc. It may be understood that the preset space is located within the target space, or in other words, the target space includes the preset space.

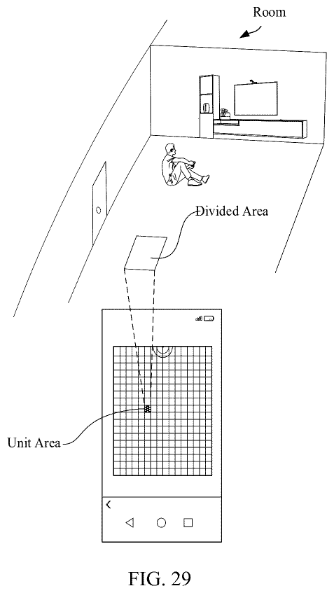

The interference area refers to a virtual area displayed in the region display window for an interference source object, which corresponds to the real area where an interference object is located in the preset space. To accurately represent the real area, the preset space may be divided into multiple divided areas. Referring to FIG. 29, FIG. 29 illustrates a schematic diagram of area relationships. As shown in FIG. 29, a divided area in the room (preset space) corresponds to a unit area in the region display window. Optionally, the correspondence between the divided area and the unit area may be stored in a relationship mapping table. The interference area may include one or more unit areas.

As an implementation, the step of responding to a trigger operation on the configuration component to display at least one interference object and its corresponding interference area in the preset space in the region display window may include:

(1) Responding to a trigger operation on the configuration component to generate a detection prompt message;

Considering that when determining interference objects in the preset space, in response to detecting there is activity of users or pets and other animals in the preset space, it will reduce the accuracy of determining interference objects. Therefore, when determining the interference source, a detection prompt message may be sent to the user to indicate that there is no animal activity in the preset space.

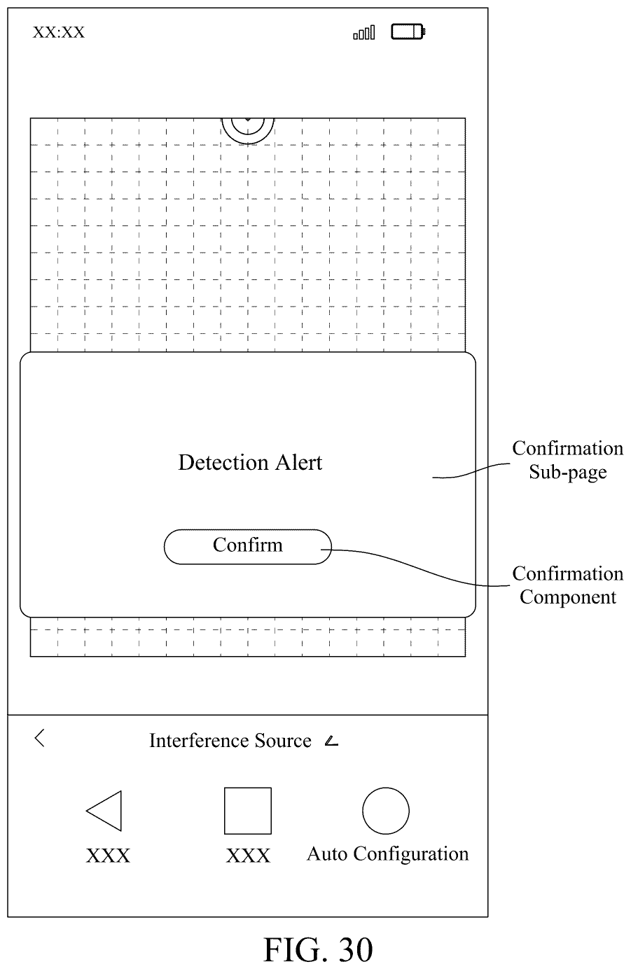

In some embodiments, a confirmation sub-interface with a detection prompt message may be generated and displayed in response to a trigger operation on the configuration component. For example, referring to FIG. 30, FIG. 30 illustrates a schematic diagram of an information confirmation interface. In response to a click operation on the configuration component, a confirmation sub-interface may be displayed on the configuration interface, which displays a detection prompt message and a confirmation component “Confirm” button.

(2) Responding to a confirmation operation on the detection prompt message, display at least one interference source object and its corresponding interference area in the preset space in the region display window.

The present disclosure may generate a configuration instruction in response to a trigger operation on the configuration component. The configuration instruction may be sent to a target device equipped with, for example, a radar module to control the target device to determine interference objects in the preset space.

In some embodiments, the step of displaying at least one interference object and its corresponding interference area in the preset space in the region display window may include:

(2.1) Sending the configuration instruction to the target device to enable the target device to detect at least one interference source object and its corresponding interference area in the preset space based on the configuration instruction, and return the area display information corresponding to the at least one interference area.

The area display information may refer to the number of interference areas, the size of the interference areas, and the location of the interference areas. The configuration interface may display the interference areas corresponding to the area display information. The target device refers to a device equipped with a radar module for detecting interference source objects in the preset space. Optionally, the target device may be a device that is separately equipped with a radar module, or it may be the device itself that generates and sends the configuration instruction, which is also equipped with a radar module.

For example, the configuration instruction may be sent to the target device. A smartphone may generate a configuration instruction and send it to a radar monitoring device. Optionally, in response to detecting the smartphone has a radar module, the configuration may be sent to its own radar module.

Further, the radar monitoring device may control the target device to detect the divided areas where at least one interference source object is located in the preset space based on the configuration instruction, and determine the interference areas corresponding to the divided areas where each interference source object is located based on the relationship mapping table, and generate the area display information corresponding to each interference area. Then, the target device may return the area display information.

(2.2) Receiving the area display information and displaying at least one interference area in the region display window based on the area display information.

When the target device detects the preset space, it may detect more than one interference source object in the preset space. Therefore, the area display information will include the interference areas of each interference source object. After receiving the area display information, the interference areas corresponding to each interference object will be displayed in the region display window based on the area display information. The interference source areas may be continuous or discontinuous with each other.

Specifically, the number of interference areas and the size and location of each interference area may be determined based on the area display information. Further, each interference area may be displayed in the region display window based on the number, size, and location. For example, based on the area display information, three interference areas are determined. The size of each interference area may be composed of a 1×1 unit area, and the location of the interference area may be determined based on a Cartesian coordinate system with the lower-left corner of the region display window as the origin.

Considering that different types of interference source objects have certain amplitude variations in their movements within the preset space, and these amplitude variations are different, the area display information may be adjusted based on the movement information of the interference source objects in space to improve the adaptability and accuracy of the interference area display. The movement information may include the movement range and frequency of the interference source objects in the preset space.

Specifically, obtain the movement information of each interference source object in the preset space, and adjust the size and location of the interference areas corresponding to each interference source object based on the movement information to obtain new sizes and locations. Then, display each interference area in the region display window based on the new sizes and locations.

For example, when obtaining the movement range and frequency of the interference source objects in the preset space, the adjustment cycle for the size and location of the interference areas may be determined based on the movement frequency. Then, based on the adjustment cycle, the size and location of the interference areas may be periodically adjusted according to the movement range.

For example, at moment n, the size and location of the interference area are represented as {(wₙ,hₙ), (xₙ,yₙ)}, where wₙ may represent the width of the interference area at moment n, hₙ may represent the height of the interference area at moment n, xₙ may represent the x-coordinate of the lower-left corner of the interference area at moment n, and yₙ may represent the y-coordinate of the lower-left corner of the interference area at moment n.

Further, based on the movement range, it may be determined that the area size needs to increase the width and height by 3, and the y-coordinate of the lower-left corner of the interference area needs to be decreased by 1. The size and location of the interference area are adjusted at moment n+m, where m is the size of the adjustment cycle determined based on the movement frequency. After the adjustment, the new area size and new location may be obtained as {(wₙ+3,hₙ+3), (xₙ,yₙ−1)}.

In response to detecting the user feels that the interference area automatically configured through the configuration instruction does not match the actual interference source area, the user may also manually adjust the interference area displayed in the region display window. To meet the user's need to adjust the display of the interference area, the configuration interface may allow users to quickly edit the interference area when displaying it.

Optionally, in response to a selection operation on a target interference area in the region display window, the target interference area may be displayed in an editable state. Then, in response to an editing operation on the target interference area in the editable state, the format of the target interference area may be adjusted, where the format adjustment includes at least size adjustment and position adjustment. When the editing operation is completed, the area display information of the target interference area may be updated based on the format adjustment and synchronized to the target device.

The editable state refers to the state where the target interference area is displayed as editable. The selection operation may include right-clicking with a mouse or long-pressing, and the editing operation may include long-pressing with two fingers and adjusting the size of the fingertips, long-pressing and dragging, long-pressing and dragging, and editing from a format menu.

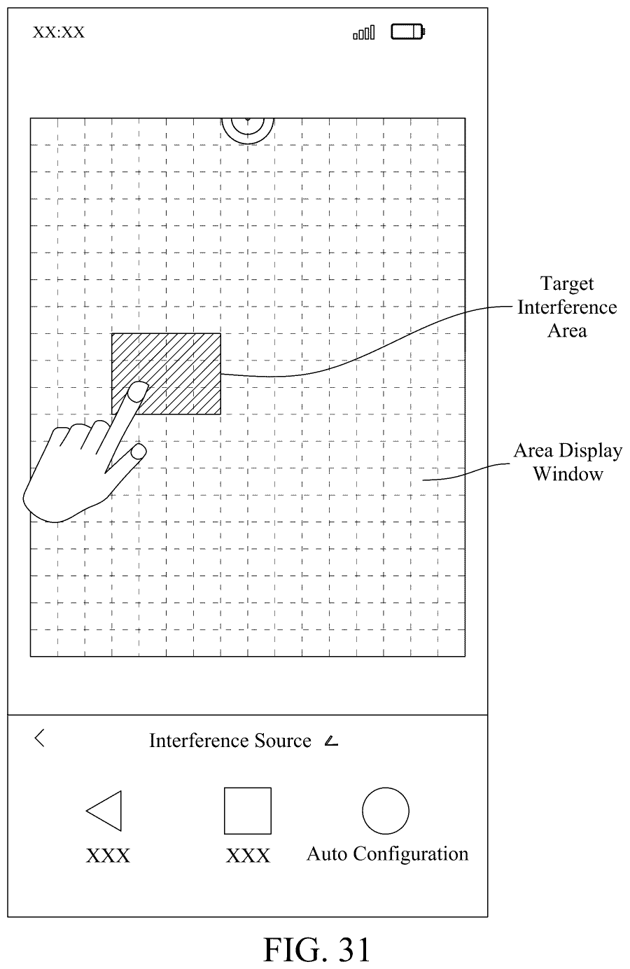

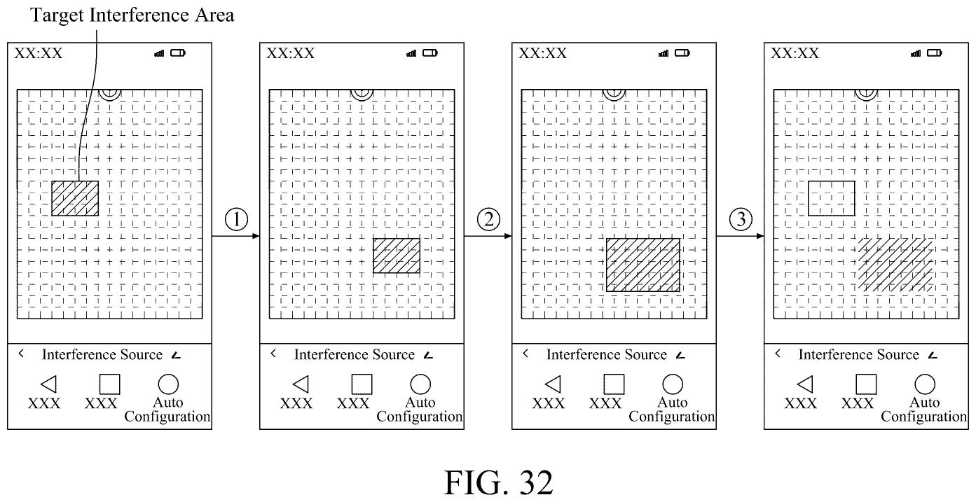

Referring to FIGS. 31 and 32, FIG. 31 illustrates an editing diagram of an interference area, and FIG. 32 illustrates an example of the editing process of an interference area. As shown in FIG. 31, the user may long-press the target interference area on the configuration interface with a finger. In response to this long-press operation, the target interference area is displayed in an editable state (indicated by a dashed line around the target interference area).

Further, as shown in FIG. 32, \textcircled{1} the position of the target interference area may be adjusted in response to the user's dragging operation on the target interference area. Further, \textcircled{2} the area of the target interference area may be increased in response to the user's long-pressing with two fingers and separating them. Further, \textcircled{3} when the long-pressing with two fingers and separating operation is terminated, and a single-click operation is detected outside the target interference area, the updated target interference area is displayed, and the area display information of the target interference area is updated to the target device.

Optionally, after displaying at least one interference area corresponding to the interference source object in the preset space, the target position of the target object in the preset space may be obtained from the target device. The target position is determined based on the location of each interference area and the spatial detection information of the preset space. The target device may return the target position of the target object in real-time.

Further, the corresponding position mark of the target position in the region display window of the sensing interface may be determined based on the received target position. Further, the position mark corresponding to the target position and the interference area may be displayed in the region display window. The position mark of the target object in the region display window may change with the movement of the target object.

The present disclosure may display a configuration interface, which at least includes a region display window and a configuration component. The configuration component is configured to trigger the determination of interference source objects in the preset space. In response to a trigger operation on the configuration component, at least one interference area corresponding to the interference source object in the preset space is displayed in the region display window. In this way, by triggering the configuration component on the configuration interface, the interference area corresponding to the interference source object in the preset space may be automatically configured and displayed on the configuration interface, thereby facilitating the accurate determination of the target object.

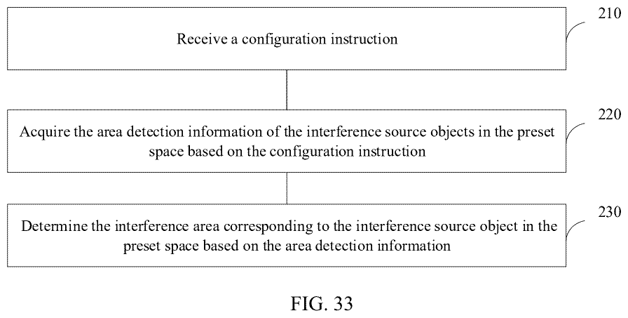

Referring to FIG. 33, FIG. 33 illustrates a flowchart of an object determination method according to another embodiment of the present disclosure. As shown in FIG. 33, the object determination method specifically includes the following steps:

Step 210: Receive a configuration instruction.

The configuration instruction is generated based on a trigger operation on the configuration component of the configuration interface, that is, it is a computer instruction used to control the detection and return of the interference areas of interference source objects in the preset space. For example, the target device may receive a configuration instruction sent from a smartphone. Optionally, it may also be the radar module of the smartphone that receives the configuration instruction sent from the smartphone.

Step 220: Acquire the area detection information of the interference source objects in the preset space based on the configuration instruction.

The acquired interference areas are configured to respond to the trigger operation on the configuration component, and then the interference areas may be displayed on the configuration interface based on the area display information of the interference areas. The area detection information may refer to the number of point clouds in each divided area within the preset space.

As an implementation, the step of acquiring the area detection information of the interference source objects in the preset space based on the configuration instruction may include:

(1) Acquiring point cloud information within the preset space in response to the trigger operation on the configuration component in the configuration interface.

In some embodiments, upon receiving the configuration instruction, point cloud information within the preset space may be obtained through radar. The point cloud information refers to the three-dimensional coordinates of the points reflected back from the surfaces of objects detected by the radar in the preset space. Optionally, depending on the functional requirements of radar detection, the point cloud information may also include color information (RGB) or reflectance intensity information (Intensity).

For example, based on the configuration instruction, a laser radar (Laser Radar) may be controlled to emit a detection signal (laser beam) into a room. Then, by comparing and calculating the received signal (target echo) reflected back from the room with the emitted signal, the point cloud information of the detected objects in the room may be obtained.

(2) Determining the number of point clouds in each divided area within the preset space based on the point cloud information, wherein one interference area in the region display window corresponds to at least one divided area in the preset space.

In some embodiments, when acquiring the point cloud information within the preset space, a point cloud scan may be performed on the preset space to obtain at least one data point within the preset space. Then, based on the at least one data point, the target divided area where each data point is located may be determined, and the number of target point clouds that have been matched in the target divided area may be determined.

Specifically, based on the traversal order, a target data point may be determined from the at least one data point, and the target divided area where the target data point is located may be determined. Further, an increment operation may be performed on the number of target point clouds in the target divided area to update the number of target point clouds matched in the target divided area. Then, the process iterates back to the step of determining a target data point from the at least one data point based on the traversal order until all data points have been traversed, resulting in the number of point clouds corresponding to each target divided area.

Further, based on the iteration count of the point cloud scan, the step of performing a point cloud scan on the preset space to obtain at least one data point in the preset space is iteratively executed until the iteration count of the point cloud scan equals the preset number of scan frames, resulting in the number of point clouds corresponding to each divided area.

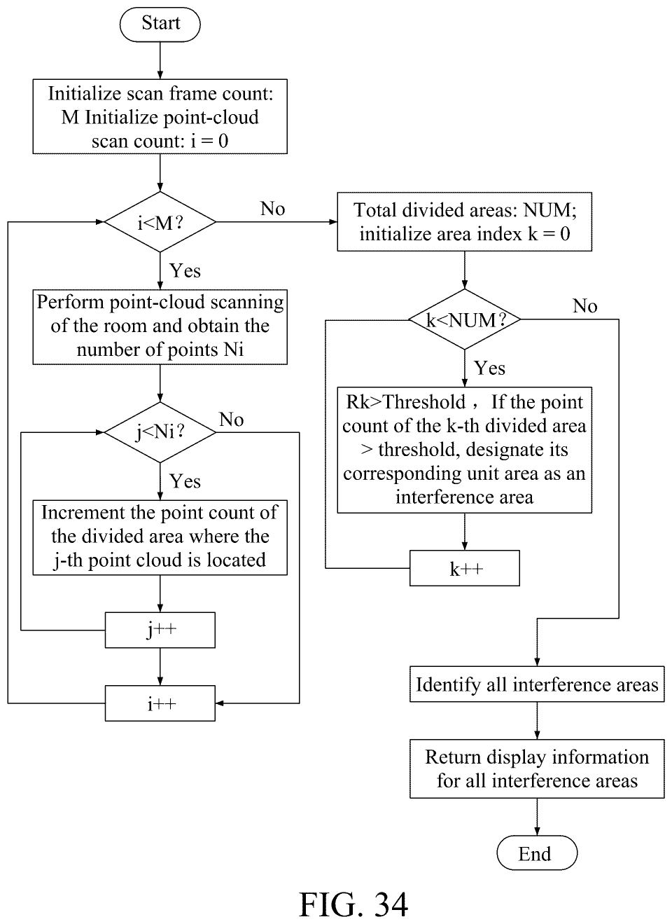

Referring to FIG. 34, FIG. 34 illustrates a flowchart for determining interference objects. For example, a preset number of scan frames M may be set, and the point cloud scan count i may be initialized to 0, allowing the radar to perform M point cloud scans on the room based on the preset number of scan frames M. Further, the i-th point cloud scan of the room is conducted to obtain the i-th frame of point cloud data, thereby obtaining the number of point clouds Nᵢ in the room during the i-th point cloud scan.

Further, traverse all the point clouds (target data points) within a frame of point cloud data to determine the target divided area corresponding to each point cloud in the point cloud data frame, and increment the point cloud count for the target divided area where the j-th point cloud is located. When it is determined that all point clouds within the point cloud data frame have been traversed (j=_{N}), increment the point cloud scan count (i++), and check whether the point cloud scan count i has reached the preset number of scan frames M. in response to detecting the point cloud scan count i has not reached the preset number of scan frames M (i<M), proceed to the point cloud statistics for the next point cloud data frame. in response to detecting the point cloud scan count i has reached the preset number of scan frames M (i=M), the point cloud scanning may be stopped.

Specifically, referring back to FIG. 34, start the process by presetting the number of scan frames M and initializing the point cloud scan count i=0. Determine whether i<M. If yes, perform a point cloud scan of the room to obtain the number of point clouds N within the room. Determine whether j<M. If j<M, increment the point cloud count for the target divided area where the j-th point cloud is located, and increment j (j++). Then, continue to determine whether j<M. If j is not less than M, increment i (i++). Then, continue to determine whether i<M. If i is not less than M, determine the number of divided areas NUM, initialize the divided area k=0, and determine whether k<NUM. If k<NUM and Rₖ>Threshold, determine the unit area corresponding to the k-th divided area as the interference area, and increment k (k++). Then, continue to determine whether k<NUM. If k is not less than NUM, determine all interference areas, return the area display information for all interference areas, and end the process.

Step 230: Determine the interference area corresponding to the interference source object in the preset space based on the area detection information.

As an implementation, the divided areas with a number of point clouds greater than a preset threshold may be determined as the interference areas corresponding to the interference source objects in the preset space based on the number of point clouds in each divided area, and return the area display information corresponding to at least one interference area.

Referring to FIG. 34, in response to detecting the point cloud scan count reaches the preset number of scan frames M (i=M), the point cloud scanning may be stopped. Traverse the number of point clouds corresponding to each divided area in the room, where the number of divided areas in the room may be NUM. Specifically, initialize the first divided area k=0. When k<NUM, that is, not all divided areas in the room have been traversed, determine whether the number of point clouds Rₖ in the k-th divided area is greater than the preset threshold Threshold.

In response to detecting the number of point clouds in the k-th divided area is greater than the preset threshold Threshold, the unit area corresponding to the k-th divided area is determined. Further, after determining all the divided areas in the room with a number of point clouds greater than the preset threshold, the unit areas corresponding to the divided areas with a number of point clouds greater than the preset threshold may be used as the interference areas, and the area display information corresponding to all interference areas may be returned to display each interference area in the region display window.

Optionally, after determining the interference area corresponding to the interference source object in the preset space, a point cloud scan of the preset space may be performed to obtain a monitoring point cloud, and it may be determined whether the monitoring point cloud has an associated historical track.

In response to detecting the monitoring point cloud has no associated historical track, a new track may be created based on the monitoring point cloud. It may then be determined whether the creation position of the new track is not within the preset range of the interference area. In response to detecting the creation position of the new track is not within the preset range of the interference area, the new track may be determined as a target track. Further, the target position of the target object may be determined based on the target track. In response to detecting the creation position of the new track is within the preset range of the interference area, the new track may be determined as an interference source track.

In response to detecting the monitoring point cloud has an associated historical track, the starting point of the historical track may be determined. In response to detecting the starting point of the historical track is not within the preset range of the interference area, the historical track may be updated based on the monitoring point cloud, and the historical track may be determined as a target track. Then, the target position of the target object may be determined and returned based on the target track.

The present disclosure may receive a configuration instruction, which is generated based on a trigger operation on the configuration component of the configuration interface; acquire the area detection information of the interference source objects in the preset space based on the configuration instruction; determine the interference area corresponding to the interference source objects in the preset space based on the area detection information; wherein the acquired interference area is configured to respond to the trigger operation on the configuration component. In this way, by automatically configuring the interference area corresponding to the interference source objects in the preset space and returning the interference area to be displayed on the configuration interface, the accuracy of determining the target object is improved.

Combining the methods described in the above embodiments, the following will provide further detailed explanations through examples.

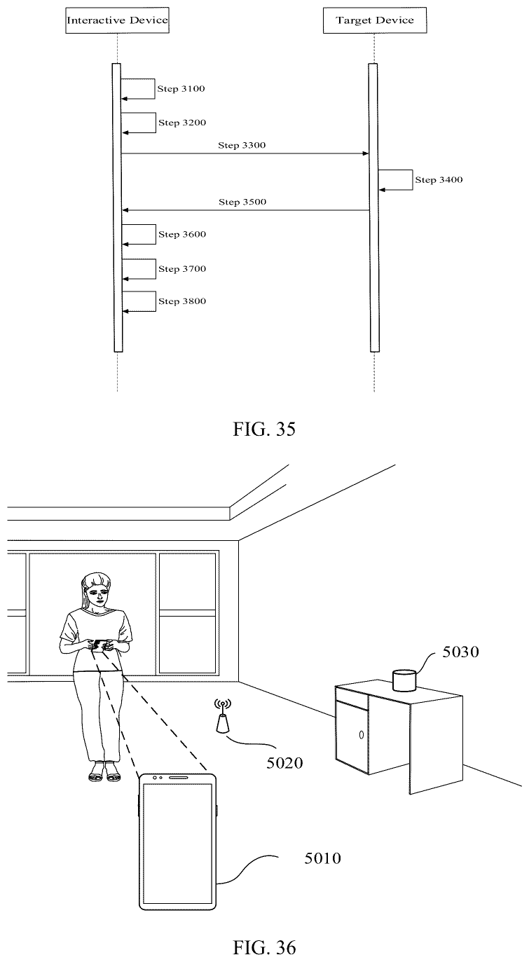

The object determination method provided in this embodiment specifically involves automatic control and other technologies, and will be detailed in conjunction with the process and application scenario shown in FIG. 35. Referring to FIG. 35, FIG. 35 illustrates a timing diagram of an object determination method according to an embodiment of the present disclosure.

In a specific embodiment, the object determination method may be applied to the intelligent control scenario shown in FIG. 36. In the intelligent control scenario, smartphone 5010 may work in conjunction with radar 5020 to automatically configure interference source objects in the room and display the interference areas of the interference source objects and the target object (such as a user) on smartphone 5010. The radar 5020 may perform point cloud scanning of the room. The smartphone 5010 and radar 5020 may communicate through the wireless local area network issued by router 5030. It should be noted that the smartphone 5010 may be the user terminal 110 in FIG. 1, the radar 5020 may be the intelligent device 130 in FIG. 1, and the router 5030 may be the router 190 in FIG. 1. The following will take the user terminal 110 as the interaction device and the intelligent device 130 as the target device as examples.

It should be noted that FIG. 36 is only one application scenario provided by the embodiments of the present disclosure. The application scenarios described in the embodiments of the present disclosure are intended to more clearly explain the technical solutions of the present disclosure and do not limit the technical solutions provided by the embodiments of the present disclosure. For example, in other cases, the smartphone 5010 and radar 5020 may be the same device to achieve interaction and detection of interference. Ordinary technical personnel in the field may know that, with the evolution of the system architecture and the emergence of new application scenarios, the technical solutions provided by the embodiments of the present disclosure are also applicable to solving similar technical problems. Specifically, referring back to FIG. 35, the object determination method specifically includes the following steps:

Step 3100: The interaction device displays a configuration interface.

The configuration interface at least includes a region display window and a configuration component, which is configured to trigger the determination of interference source objects in the preset space. In the embodiments of the present disclosure, the intelligent control software installed on the smartphone 5010 by the user may be used to configure interference sources, display interference areas, and real targets. The user may create different types of virtual areas on the intelligent control software to simulate the layout of the room.

For example, virtual areas may include interference areas, entrances/exits, and boundaries. Interference areas may be used to simulate the areas where interference source objects are located in the room, entrances/exits may be used to simulate the doors and windows of the room, and boundaries may be used to simulate the walls of the room. The virtual areas configured and displayed on the intelligent control software may improve the accuracy of locating and displaying real targets (such as people or pets) in the room.

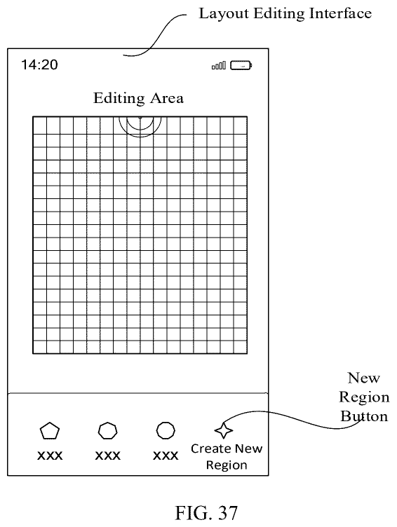

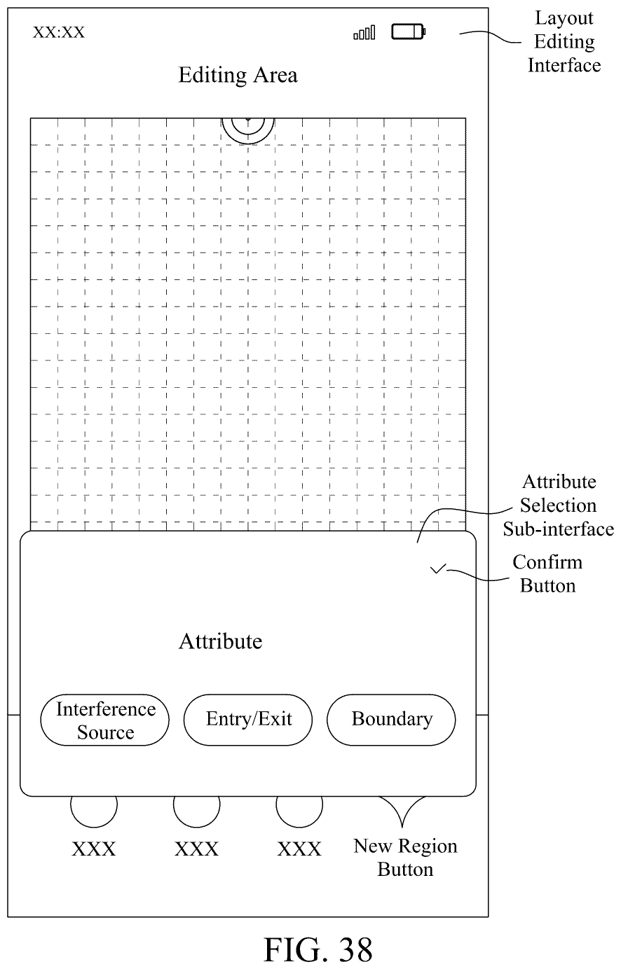

As an implementation, referring to FIGS. 37 and 38, FIG. 37 shows a layout editing interface, which includes a new area button (new component). The smartphone 5010 may display the layout editing interface, which includes the new component. The smartphone 5010 may respond to the trigger operation of the new component and display a property selection sub-interface, so that users may select the type of virtual area they want to create.

FIG. 38 shows a property selection sub-interface. The smartphone 5010 may respond to the click operation of the new area button and display the property selection sub-interface as shown in FIG. 38. The property selection sub-interface may include three optional properties: interference source, entrance/exit, and boundary. Then, when the user selects the target property and triggers the confirmation button, the smartphone 5010 may respond to the trigger operation of the confirmation button and display the configuration interface corresponding to the target property.

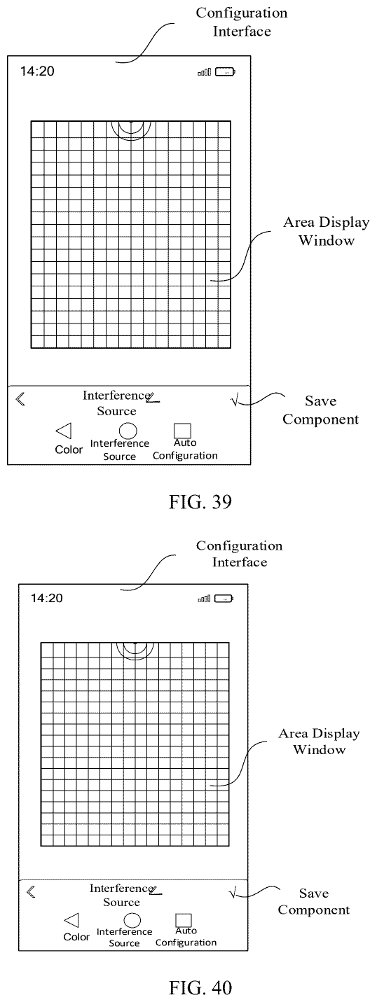

For example, referring to FIGS. 39 and 40, FIG. 39 shows a configuration interface for interference source properties, and FIG. 40 shows a color editing interface. As shown in FIG. 39, the configuration interface for interference source properties may display a region display window, a configuration component (auto-configuration), a color editing component (color), and a save component. The color editing component may be used for users to edit the color type of the interference area corresponding to the interference source. As shown in FIG. 40, the smartphone 5010 may respond to the trigger operation of the color editing component and display a color editing sub-interface, where users may select colors by clicking. The save component may be used for users to confirm the display of the interference area when the interference source configuration is completed.

Step 3200: The interaction device responds to the trigger operation on the configuration component to generate a detection prompt message.

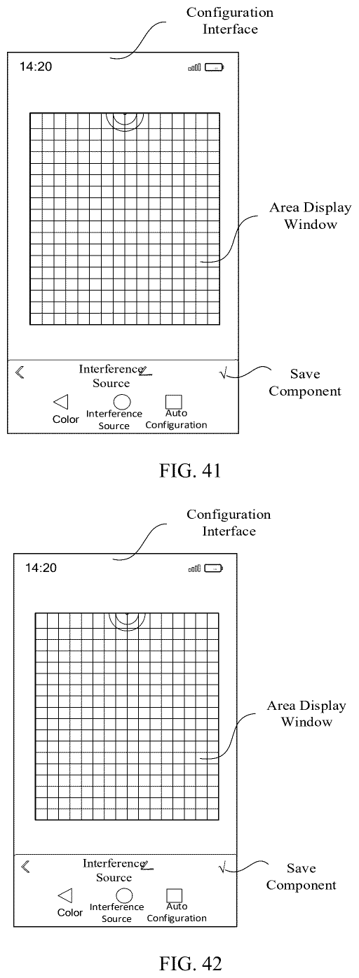

As an implementation, the smartphone 5010 may respond to the trigger operation on the configuration component to generate and display a confirmation sub-interface with a detection prompt message. For example, referring to FIG. 41, FIG. 41 shows an information prompt interface. The smartphone 5010 may respond to the click on the configuration component and display a confirmation sub-interface on the configuration interface, which displays a detection prompt message and a confirmation component.

Step 3300: The interaction device responds to the confirmation operation on the detection prompt message and sends the configuration instruction to the target device.

In the embodiments of the present disclosure, the smartphone 5010 may generate a configuration instruction based on the trigger operation on the configuration component, so that the target device may detect at least one interference source object and its corresponding interference area in the preset space based on the configuration instruction, and return the area display information corresponding to at least one interference area. As an implementation, the smartphone 5010 may respond to the confirmation operation on the detection prompt message and send the configuration instruction to the radar 5020 through the wireless local area network.

Step 3400: The target device receives the configuration instruction and acquires the area detection information of the interference source objects in the preset space based on the configuration instruction.

As an implementation, the radar 5020 may acquire the point cloud information within the preset space based on the configuration instruction when receiving the configuration instruction. Specifically, upon receiving the configuration instruction, the radar 5020 may obtain the point cloud information within the preset space through radar. For example, the radar 5020 may control the laser radar to emit a detection signal in the room according to the configuration instruction. Then, by comparing and calculating the received signal reflected back from the room with the emitted signal, the point cloud information of the detected objects in the room may be obtained.

Further, the radar 5020 may determine the number of point clouds in each divided area within the preset space based on the point cloud information within the preset space. Specifically, when acquiring the point cloud information within the preset space, the radar 5020 may perform a point cloud scan on the preset space to obtain at least one data point within the preset space. Then, based on the at least one data point, the radar 5020 may determine the target divided area where each data point is located and determine the number of target point clouds that have been matched in the target divided area.

For example, based on the traversal order, the radar 5020 may determine a target data point from the at least one data point and determine the target divided area where the target data point is located. Further, an increment operation may be performed on the number of target point clouds in the target divided area to update the number of target point clouds matched in the target divided area. Then, the process iterates back to the step of determining a target data point from the at least one data point based on the traversal order until all data points have been traversed, resulting in the number of point clouds corresponding to each target divided area.

Further, based on the iteration count of the point cloud scan, the radar 5020 may iteratively execute the step of performing a point cloud scan on the preset space to obtain at least one data point in the preset space until the iteration count of the point cloud scan equals the preset number of scan frames, resulting in the number of point clouds corresponding to each divided area.

Step 3500: The target device determines the interference area corresponding to the interference source objects in the preset space based on the area detection information and returns the area display information corresponding to the interference area.

As an implementation, the radar 5020 may determine the divided areas with a number of point clouds greater than a preset threshold as the interference areas corresponding to the interference source objects in the preset space based on the number of point clouds in each divided area, and return the area display information corresponding to at least one interference area. The preset threshold may be determined based on experimental experience.

For example, the radar 5020 obtains four divided areas with a number of point clouds greater than the preset threshold, and these four divided areas are adjacent to each other. Therefore, the radar 5020 may determine these four divided areas as one interference area.

Further, the radar 5020 may convert the real-position of these four divided areas in the room into the virtual-position of the virtual area in the region display window through a relationship mapping table, thereby obtaining the area display information. For example, the area size and area location may be represented as {(w=2,h=2), (x=3,y=9)}, where w may represent the width of the interference area, h may represent the height of the interference area, x may represent the x-coordinate of the lower-left corner of the interference area, and y may represent the y-coordinate of the lower-left corner of the interference area.

Step 3600: The interaction device receives the area display information and displays at least one interference area in the region display window based on the area display information.

As an implementation, the smartphone 5010 may obtain the movement information of each interference source object in the preset space and adjust the size and location of the interference areas corresponding to each interference source object based on the movement information to obtain new sizes and locations. Then, the smartphone 5010 may display each interference area in the region display window based on the new sizes and locations.

For example, when the smartphone 5010 obtains the movement range and frequency of the interference source objects in the preset space, it may determine the adjustment cycle for the size and location of the interference areas based on the movement frequency. Then, based on the adjustment cycle, the smartphone 5010 may periodically adjust the size and location of the interference areas according to the movement range, and display the interference areas with the new sizes and locations in the region display window.

Optionally, the smartphone 5010 may respond to a selection operation on a target interference area in the region display window, display the target interference area in an editable state, and respond to an editing operation on the target interference area in the editable state to adjust the format of the target interference area. The format adjustment includes at least area adjustment and location adjustment. When the editing operation is completed, the area display information of the target interference area is updated to the target device.

Referring to FIG. 42, FIG. 42 illustrates a schematic diagram of a region display window. As shown in FIG. 42, the smartphone 5010 may receive the area display information {(w=2,h=2), (x=3,y=9)} of an interference area from the radar 5020. Further, based on this area display information, the interference area is displayed in the region display window of the configuration interface. The area of the interference area may be composed of four 1×1 unit areas. The location of the interference area may be determined based on a Cartesian coordinate system with the lower-left corner of the region display window as the origin.

Step 3700: The interaction device acquires the target position of the target object in the preset space.

When the interference source objects in the preset space are determined, the position of the target object, that is, the user or pet in the preset space, may be accurately determined based on the position of the interference source objects. This position is referred to as the target position. The target position is determined based on the location of each interference area and the spatial detection information of the preset space to avoid the impact of interference sources on the detection of real targets. The spatial detection information may refer to the point cloud information obtained in the preset space.

As an implementation, the radar 5020 may perform a point cloud scan of the preset space to obtain a monitoring point cloud. This monitoring point cloud may be obtained by the radar 5020 through point cloud scanning in the room. Further, the radar 5020 may determine whether there is a historical track associated with the monitoring point cloud. The historical track is a track generated based on historical point cloud information, for example, a track composed of multiple point clouds connected together.

in response to detecting the monitoring point cloud has no associated historical track, the radar 5020 may create a new track based on the monitoring point cloud and determine whether the creation position of the new track is within the preset range of the interference area. The creation position may refer to the starting point of a track when it is generated. The preset range of the interference area refers to the range covered by the actual area of the interference area in the preset space.

In response to detecting the creation position of the new track is not within the preset range of the interference area, the radar 5020 may determine the new track as a target track and determine the target position of the target object based on the target track. The radar 5020 may then report the target position of the target object to the smartphone 5010 in real-time. In response to detecting the creation position of the new track is within the preset range of the interference area, the new track is determined as an interference source track, and the radar 5020 may not report the interference source track to the smartphone 5010.

As another implementation, the radar 5020 may perform a point cloud scan of the preset space to obtain a monitoring point cloud and determine whether there is a historical track associated with the monitoring point cloud. In response to detecting the monitoring point cloud has an associated historical track, the radar 5020 may determine the starting point of the historical track based on the track information. The track starting point refers to the starting point when the track is generated.

In response to detecting the starting point of the historical track is not within the preset range of the interference area, the radar 5020 may update the historical track based on the monitoring point cloud and determine the historical track as a target track. Further, the radar 5020 may determine the target position of the target object based on the target track and report the target position of the target object to the smartphone 5010 in real-time. The radar 5020 may not report the interference source track to the smartphone 5010.

It should be noted that when an interference source track is determined, in response to detecting the point cloud information corresponding to the interference source is directly deleted, a situation may occur where there is no point cloud data around the track of the target object when the target object is at the position of the interference source. This may lead to the mistaken belief that the target object cannot be detected, resulting in the deletion of the target object's track, that is, the target object is lost.

In response to detecting the interference source track is not deleted, when the target object moves near the interference source, the point clouds at the position of the interference source may be associated with the target object. This may lead to the mistaken belief that the target object has moved to the position of the interference source, although in fact the target object has not moved to the position of the interference source. This may also result in the loss of the target object.

To address this, a hidden track, that is, an interference source track, may be created at the interference source. When the track of the target object intersects with the interference source track, the point clouds may be assigned to the nearest track. In this way, point clouds closer to the interference source track will be associated with the track at the interference source, and point clouds closer to the target object's track will be associated with the target object. In this way, the track will not be deleted due to the lack of associated point clouds, nor will it be absorbed by the interference source. Thus, the accuracy of detecting the target object in the preset space may be effectively improved.

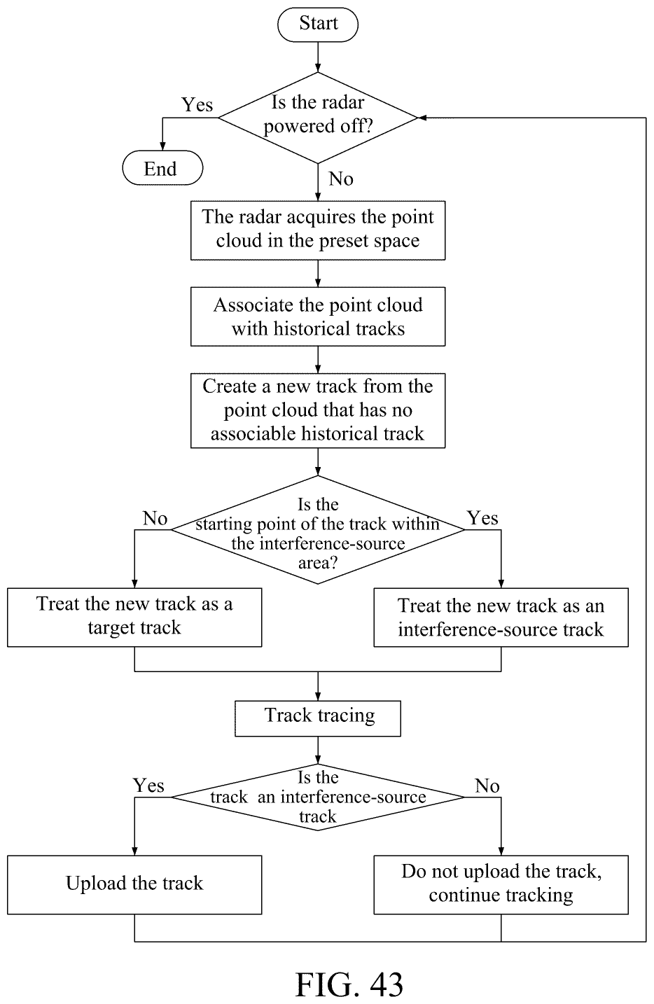

Referring to FIG. 43, FIG. 43 illustrates a flowchart for determining the target position. As shown in FIG. 43, after the radar 5020 is turned on, it may acquire the point cloud in the preset space (that is, the monitoring point cloud), and then associate the point cloud with historical tracks. In response to detecting there is no historical track that may be associated with the point cloud, a new track is created based on the point cloud. Further, the radar 5020 determines whether the starting point of the new track is within the preset range of the interference source area.

In response to detecting the starting point of the new track is within the preset range of the interference source area, the new track is treated as an interference source track. In response to detecting the starting point of the new track is not within the preset range of the interference source area, the new track is treated as a target track, and real-time track tracking is performed on both the interference source track and the target track. The radar 5020 sends the target track to the smartphone 5010. For example, the radar 5020 uploads the target track to the cloud, and the smartphone 5010 may download the target track from the cloud and determine the target position of the target object based on the target track. The radar 5020 does not upload the interference source track but continues to track it.

Step 3800: The interaction device displays a sensing interface including a position mark corresponding to the target position of the target object and each interference area based on the target position of the target object.

The position mark may refer to the mark in the region display interface corresponding to the target position of the target object in the preset space. This position mark may be displayed in the sensing interface in the form of a mark component. The sensing interface is the interface that users enter after configuring the interference source objects' interference areas in the configuration interface. It is configured to display the position marks of the target objects and each interference area. That is, on the sensing interface, users may see both the corresponding position of the target object and the corresponding position of the interference source.

As an implementation, the smartphone 5010 may acquire the target position of the target object in response to the user's trigger operation on the save component in the configuration interface. When the smartphone 5010 displays the sensing interface, it may update the target position of the target object in real-time and display the sensing interface including the position mark corresponding to the target position and each interference area.

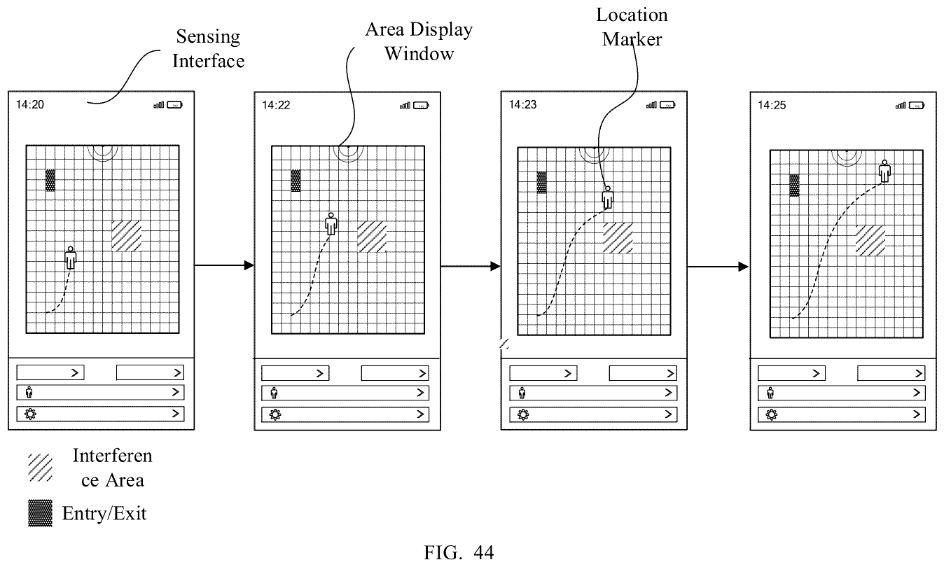

Referring to FIG. 44, FIG. 44 illustrates a schematic diagram of the interface transformation of the sensing interface. The radar 5020 may update the target position of the target object to the smartphone 5010 in real-time. Then, the smartphone 5010 may determine the position mark corresponding to the target position in the region display window of the sensing interface based on the received target position. Further, the smartphone 5010 may display the position mark corresponding to the target position and the interference area in the region display window. As shown in FIG. 44, the position mark of the target object in the region display window changes with the movement of the target object. The dashed line represents the virtual track of the target object relative to the sensing interface, which may not be displayed in practice.

The present disclosure may display a configuration interface and generate a detection prompt message in response to a trigger operation on the configuration component. Further, in response to a confirmation operation on the detection prompt message, a configuration instruction is sent to the target device, which receives the configuration instruction and acquires the area detection information of the interference source objects in the preset space based on the configuration instruction. Further, based on the area detection information, the interference area corresponding to the interference source objects in the preset space is determined, and the area display information corresponding to the interference area is returned.

Further, the area display information is received, and at least one interference area is displayed in the region display window based on the area display information. Then, the target position of the target object in the preset space is acquired, and a sensing interface including a position mark corresponding to the target position and each interference area is displayed based on the target position of the target object. In this way, by triggering the configuration component on the configuration interface, the interference area corresponding to the interference source objects in the preset space may be automatically configured and displayed on the sensing interface along with the position mark of the target object, thereby facilitating the accurate determination of the target object.

It should be understood that although the steps in the above flowcharts are displayed in sequence according to the direction of the arrows, these steps are not necessarily performed in the order indicated by the arrows. Unless explicitly stated otherwise in this text, there is no strict order of execution for these steps, and they may be performed in other sequences. Moreover, at least some of the steps in the above flowcharts may include multiple sub-steps or stages, which do not necessarily have to be completed at the same moment but may be executed at different times. The order of execution for these sub-steps or stages is not necessarily sequential but may be performed alternately or in rotation with other steps or sub-steps or stages of other steps.

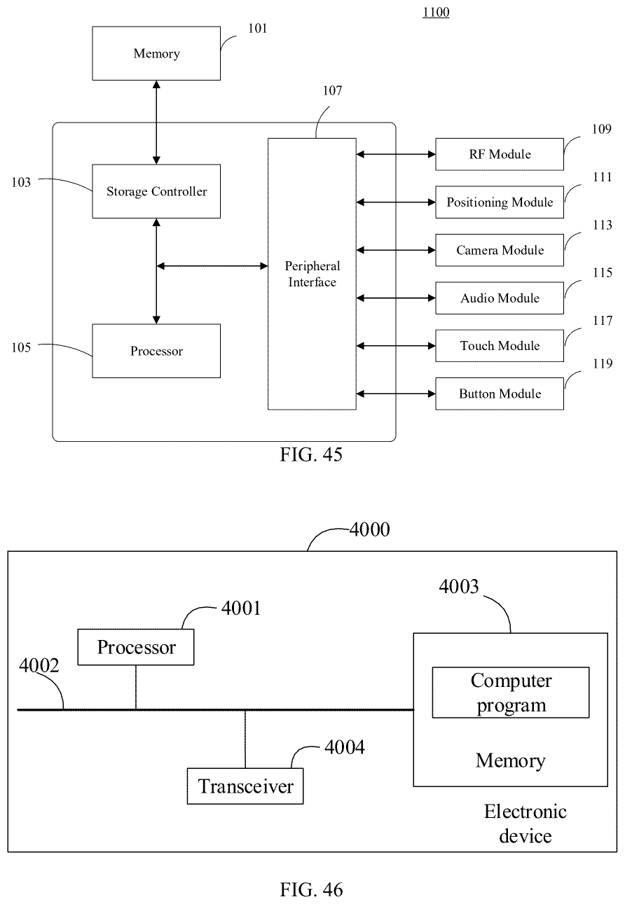

Referring to FIG. 45, FIG. 45 illustrates a structural diagram of a terminal according to an exemplary embodiment. The terminal is applicable to the user terminal 110 shown in FIG. 1.

It should be noted that the terminal is only an example adapted to the present disclosure and should not be considered as providing any limitation on the scope of use of the present disclosure. The terminal should not be interpreted as necessarily relying on or having one or more components shown in the exemplary terminal 1100 in FIG. 45.

As shown in FIG. 45, the terminal 1100 includes a memory 101, a storage controller 103, one or more (only one is shown in FIG. 12) processors 105, a peripheral interface 107, a radio frequency module 109, a positioning module 111, a camera module 113, an audio module 115, a touch screen 117, and a button module 119. These components communicate with each other through one or more communication buses/signal lines 121.

The memory 101 may be used to store program instructions or code, such as the program instructions or code corresponding to the device control method and apparatus in the exemplary embodiments of the present disclosure. The processor 105 executes various functions and data processing by running the program instructions or code stored in the memory 101, that is, to complete the device control method.

The memory 101, as a carrier for resource storage, may be random access memory, such as high-speed random access memory, non-volatile memory, such as one or more magnetic storage devices, flash memory, or other solid-state memory. The storage method may be temporary storage or permanent storage.

The peripheral interface 107 may include at least one wired or wireless network interface, at least one serial-parallel conversion interface, at least one input-output interface, and at least one USB interface, etc., to couple various external input/output devices to the memory 101 and the processor 105 to achieve communication with various external input/output devices.

The radio frequency module 109 is configured to transmit and receive electromagnetic waves, to realize the mutual conversion between electromagnetic waves and electrical signals, and to communicate with other devices through a communication network. The communication network includes cellular telephone networks, wireless local area networks, or metropolitan area networks. The above-mentioned communication networks may use various communication standards, protocols, and technologies.

The positioning module 111 is configured to obtain the current geographical location of the terminal 1100. Examples of the positioning module 111 include but are not limited to the Global Positioning System (GPS), positioning technologies based on wireless local area networks or mobile communication networks.

The camera module 113 belongs to the camera and is configured to take pictures or videos. The taken pictures or videos may be stored in the memory 101 and may also be sent to the host computer through the radio frequency module 109.

The audio module 115 provides an audio interface for users, which may include one or more microphone interfaces, one or more speaker interfaces, and one or more headphone interfaces. Audio data may be stored in the memory 101 and may also be sent through the radio frequency module 109.

The touch screen 117 provides an input-output interface between the terminal 1100 and the user. Specifically, users may perform input operations through the touch screen 117, such as clicking, touching, and sliding gestures, to make the terminal 1100 respond to these input operations. The terminal 1100 then displays output content in the form of text, pictures, or videos, or a combination thereof, to the user through the touch screen 117.

The button module 119 includes at least one button, which provides an interface for users to input to the terminal 1100. Users may press different buttons to make the terminal 1100 perform different functions. For example, the volume adjustment button allows users to adjust the volume of the sound played by the terminal 1100.

It should be understood that the structure shown in FIG. 45 is only for illustration. The terminal 1100 may include more or fewer components than those shown in FIG. 45, or it may have components different from those shown in FIG. 45. The components shown in FIG. 45 may be implemented using hardware, software, or a combination thereof.

Referring to FIG. 46, an electronic device 4000 is provided in the embodiments of the present disclosure. The electronic device 4000 may include smartphones, tablet computers, intelligent devices, etc. As shown in FIG. 46, the electronic device 4000 includes at least one processor 4001 and at least one memory 4003.

The data interaction between the processor 4001 and the memory 4003 may be realized through at least one communication bus 4002. The communication bus 4002 may include a path for transmitting data between the processor 4001 and the memory 4003. The communication bus 4002 may be a PCI (Peripheral Component Interconnect) bus or an EISA (Extended Industry Standard Architecture) bus, etc. The communication bus 4002 may be divided into address bus, data bus, control bus, etc. For the sake of simplicity, FIG. 46 only shows one thick line, but it does not mean that there is only one bus or only one type of bus.

Optionally, the electronic device 4000 may also include a transceiver 4004. The transceiver 4004 may be used for data interaction between the electronic device and other electronic devices, such as data transmission and/or data reception. It should be noted that in practical applications, the transceiver 4004 is not limited to one, and the structure of the electronic device 4000 does not constitute a limitation on the embodiments of the present disclosure.

The processor 4001 may be a CPU (Central Processing Unit), a general-purpose processor, a DSP (Digital Signal Processor), an ASIC (Application-Specific Integrated Circuit), an FPGA (Field-Programmable Gate Array), or other programmable logic devices, transistor logic devices, hardware components, or any combination thereof. It may realize or execute various exemplary logic blocks, modules, and circuits described in combination with the content disclosed in the present disclosure. The processor 4001 may also be a combination that realizes computing functions, such as a combination of one or more microprocessors, a combination of DSP and microprocessors, etc.

The memory 4003 may be ROM (Read-Only Memory) or other types of static storage devices that may store static information and instructions, RAM (Random Access Memory) or other types of dynamic storage devices that may store information and instructions, or EEPROM (Electrically Erasable Programmable Read-Only Memory), CD-ROM (Compact Disc Read-Only Memory), or other optical disk storage, optical disc storage (including compact discs, laser discs, optical discs, digital versatile discs, Blu-ray discs, etc.), magnetic disk storage media or other magnetic storage devices, or any other medium that may be used to carry or store desired program instructions or code in the form of instructions or data structures and may be accessed by the electronic device 4000, but not limited to this.

The memory 4003 stores program instructions or code, and the processor 4001 may read the program instructions or code stored in the memory 4003 through the communication bus 4002. When the program instructions or code are executed by the processor 4001, the device control method described in the above embodiments is realized.

In addition, the present disclosure provides a computer-readable storage medium. The computer-readable storage medium stores program instructions or code. When the program instructions or code are loaded and executed by the processor, the device control method described above is realized.

The present disclosure also provides an application program product. The application program product includes program instructions or code stored in a computer-readable storage medium. The processor of the electronic device reads the program instructions or code from the computer-readable storage medium, loads and executes the program instructions or code, so that the electronic device realizes the device control method described above.

Compared with the related technologies, the present disclosure may configure up to 30 monitoring regions in the target space of the sensing device. Each monitoring region may be configured with corresponding device control services, not limited to automated services, but also scene services. Not only is the monitoring of the area status of each monitoring region independent and non-interfering with each other, but also the relationship between each target and each monitoring region is independent, fully ensuring refined device control. The sensing device is configured to monitor the area status of each monitoring region, which may be reported to the server through the wide-area network, and may also be reported to the gateway within the local-area network. As long as the local-area network is not disconnected, device control may be realized through the local-area network, fully ensuring the success rate of device control. By setting a buffer area between the monitoring region and the non-monitoring region, it effectively prevents incorrect device control caused by noise in the sensing device when the target is at the boundary of the monitoring region, which further helps to improve the accuracy of device control. In addition, by introducing the pitch angle of the radar device installation through the accelerometer to correct the pitch angle measured by the radar device itself, the accuracy of the target position is effectively ensured.

The above-mentioned embodiments are only part of the implementation of the present disclosure. It should be pointed out that for those of ordinary skill in the technical field, several improvements and refinements may be made without departing from the principles of the present disclosure, and these improvements and refinements should also be regarded as the scope of protection of the present disclosure.

What is claimed is:

1. A device control method, performed by an electronic device, the method comprising:
displaying a region management page, wherein the region management page displays a current position of a target and is configured to set at least one monitoring region within a target space corresponding toa sensing device based on the current position of the target;
in response to detecting a region editing operation triggered in the region management page for configuring the monitoring region, and generating a custom monitoring region;
displaying an automation configuration page for the monitoring region;
in response to an automation configuration operation for the monitoring region in the automation configuration page, generating automation configuration schemes corresponding to the monitoring region; the automation configuration schemes are configured to achieve automatic control of the controlled device by monitoring the region status of the monitoring region.

2. The method of claim 1, wherein displaying the automation configuration page for the monitoring region comprises:
displaying an associated page corresponding to the sensing device, the associated page displaying an automation control;
in response to a trigger operation on the automation control, displaying the automation configuration page, the automation configuration page is configured to configure at least one of a trigger condition and a controlled action related to the monitoring region.

3. The method of claim 1, wherein generating automation configuration schemes corresponding to the monitoring region in response to an automation configuration operation on the monitoring region in the automation configuration page comprises:
in the automation configuration page, in response to detecting an automation configuration operation on the trigger condition configuration control is detected, configuring a corresponding trigger condition for the monitoring region of the sensing device;
generating the automation configuration schemes based on the completed trigger condition configuration, and displaying the automation configuration schemes on the automation configuration page.

4. The method of claim 1, wherein generating automation configuration schemes corresponding to the monitoring region in response to an automation configuration operation on the monitoring region in the automation configuration page comprises:
in response to detecting an automation configuration operation on the controlled action entry is detected, configuring device control data associated with the trigger condition; the device control data is configured to instruct the controlled device to perform a corresponding action;
generating the automation configuration schemes based on the completed device control data configuration, and displaying the automation configuration schemes on the automation configuration page.

5. The method of claim 1, wherein after displaying the region management page, further comprising:
in the region management page, in response to detecting a trigger operation on at least one of a control for adding a region and a displayed monitoring region, controlling the region management page to switch from a region display state to a region editing state;
in the region management page in the region editing state, in response to editing operations on each of the monitoring regions, editing each of the monitoring regions.

6. The method of claim 1, wherein the monitoring region includes a functional area; the region management page includes an editable area, the editable range of which corresponds to the spatial range of the target space, the method further comprising:
in response to detecting a gesture operation on the editable area is detected, determining the area range defined by the gesture operation;
displaying the functional area in the region management page base on the area range, to control at least one of the functional area and the intelligent device in the target space corresponding to the functional area.

7. The method of claim 6, wherein detecting a gesture operation on the editable area and determining the area range defined by the gesture operation comprises performing at least one of the following sets of operations:
in response to detecting a gesture operation on the editable area is detected, determining a touch point of the gesture operation in the editable area and determining whether the touch point has moved within the editable area; in response to a determination that the touch point has not moved, determining that the gesture operation is a first gesture operation; and determining the area range based on the touch point of the first gesture operation in the editable area;
in response to detecting the touch point has moved within the editable area, determining a movement direction of the touch point within the editable area; detecting the movement direction is a first direction, determining that the gesture operation is a second gesture operation; and determining the area range based on the touch point of the second gesture operation in the editable area;
in response to detecting the touch point has moved within the editable area, determining a movement direction of the touch point within the editable area; detecting the movement direction is a second direction, determining that the gesture operation is a third gesture operation; and determining the area range based on the touch point of the third gesture operation in the editable area;
in response to detecting a gesture operation on the editable area is detected, and detecting the number of touch points of the gesture operation in the editable area is greater than a predetermined threshold, determining whether the multiple touch points have moved relatively within the editable area; in response, determining that the gesture operation is a fourth gesture operation; and determining the area range based on the touch points of the fourth gesture operation in the editable area.

8. The method of claim 7, the method further comprising:
in response to detecting the touch point in the editable area has been selected, excluding the area range where the touch point is located from the area range determined by the gesture operation;
in response to detecting the touch point in the editable area has not been selected, adding the area range where the touch point is located to the area range determined by the gesture operation.

9. The method of claim 1, wherein the monitoring region includes a functional area; the region management page is configured to display at least one functional area set for the target space; the method further comprising:
in response to detecting a first trigger operation for setting the functional area is detected in the region management page, displaying a region setting page;
in the region setting page, in response to a setting operation on the functional area, displaying the set functional area in the region management page after the setting is completed.

10. The method of claim 9, wherein the first trigger operation includes a first selection operation for selecting the functional area previously displayed in the region management page; The displaying a region setting page in response to the first trigger operation for setting the functional area in the region management page comprises:
in response to the first selection operation triggered in the region management page, determining the functional area selected in the region management page;
displaying a region editing page corresponding to the selected functional area; the region editing page displays the area information of the selected functional area, and the region editing page is a region setting page for editing the selected functional area.

11. The method of claim 10, wherein displaying a region setting page corresponding to the selected functional area comprises:
in separate display areas of the region management page, respectively displaying each functional area and the region editing page corresponding to the selected functional area.

12. The method of claim 1, wherein the region management page includes a configuration interface, and the target space includes a preset space, the method further comprising:
displaying the configuration interface for the monitoring region, the configuration interface at least including a region display window and a configuration component, the configuration component is configured to trigger the determination of interference source objects in the preset space;
in response to a trigger operation on the configuration component, displaying at least one interference area corresponding to the interference source objects in the preset space in the region display window.

13. The method of claim 1, wherein displaying at least one interference area corresponding to the interference source objects in the preset space in the region display window in response to a trigger operation on the configuration component comprises:
acquiring point cloud information within the preset space in response to the trigger operation on the configuration component in the configuration interface;
determining the number of point clouds in each divided area within the preset space based on the point cloud information, wherein one interference area in the region display window corresponds to at least one divided area in the preset space;
determining the divided areas with a number of point clouds greater than a preset threshold as the interference areas corresponding to the interference source objects in the preset space based on the number of point clouds in each divided area.

14. The method of claim 13, wherein determining the number of point clouds in each divided area within the preset space based on the point cloud information within the preset space comprises:
performing a point cloud scan on the preset space to obtain at least one data point in the preset space;
for each data point, determining the target divided area where each data point is located, and determining the number of target point clouds that have been matched in the target divided area;
based on the iteration count of the point cloud scan, and returning to iteratively perform the step of performing a point cloud scan on the preset space to obtain at least one data point in the preset space, until the iteration count of the point cloud scan equals the preset number of scan frames, to obtain the number of point clouds corresponding to each divided area.

15. The method of claim 13, wherein the preset space includes a configured interference area, the method further comprising:
in response to detecting the monitoring point cloud has no associated historical track, creating a new track based on the monitoring point cloud; in response to detecting the creation position of the new track does not belong to the preset range of the interference area, determining the new track as a target track and determining the target position of the target object based on the target track; in response to detecting the creation position of the new track belongs to the preset range of the interference area, determining the new track as an interference source track;
in response to detecting the monitoring point cloud has an associated historical track, determining the starting point of the historical track; in response to detecting the starting point of the historical track does not belong to the preset range of the interference area, updating the historical track based on the monitoring point cloud and determining the historical track as a target track; determining the target position of the target object based on the target track.

16. A device control method, performed by an electronic device, the method comprising:
acquiring the position of the target in each monitoring region, the monitoring region being generated based on an editing operation triggered in a region management page; the region management page is configured to configure at least one monitoring region within the target space of the sensing device based on the current position of the target;
determining the status of each monitoring region based on the position of the target in each monitoring region;
in response to detecting the status of the monitoring region satisfies the trigger condition in the corresponding automation configuration schemes, controlling the controlled device to perform a corresponding action based on the device control data associated with the trigger condition in the automation configuration.

17. The method of claim 16, wherein determining the status of each monitoring region based on the position of the target in each monitoring region comprises:
for each monitoring region, determining the positional relationship between the target and the monitoring region at different times based on the position of the target in the monitoring region;
determining a status of each monitoring region based on a positional relationship between the target and the monitoring region over time.

18. The method of claim 17, wherein determining the status of the monitoring region based on the positional relationship between the target and the monitoring region at different times comprises:
in response to detecting the sensing device has directional monitoring capability, determining a direction in which the target enters the monitoring region based on the positional relationship over time, and determining the status based on the direction and the positional relationship;
determining the status of the monitoring region based on the determined direction and positional relationship.

19. The method of claim 17, wherein determining the status of the monitoring region based on the positional relationship between the target and the monitoring region at different times comprises:
based on the positional relationship between the target and the monitoring region at different times, in response to detecting the positional relationship indicates that the target is currently located in the buffer area, determining whether the target was approaching the non-monitoring region in the previous moment; the buffer area is located between the monitoring region and the non-monitoring region;
in response to a determination that the target was not approaching the non-monitoring region at the previous moment, determining that the status of the monitoring region is that the target is approaching the monitoring region.

20. An electronic device, comprising a memory and a processor, the memory storing computer-readable instructions, wherein the processor performs steps of the method as described in any of claim 1 when executing the computer-readable instructions.
